(19) United States
(12) Patent Application Publication
(10) Pub. No.: US 2009/0226819 A1
(43) Pub. Date: Sep. 10, 2009

(54) ELECTROLYTIC SOLUTION AND SECONDARY BATTERY

(75) Inventors: Masayuki Ihara, Fukushima (JP); Hiroyuki Yamaguchi, Fukushima (JP); Tadahiko Kubota, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/401,288

(22) Filed: Mar. 10, 2009

(30) Foreign Application Priority Data
Mar. 10, 2008 (JP) 2008-059499
Mar. 10, 2008 (JP) 2008-059500

(51) Int. Cl. H01M 6/16; H01M 6/14

(52) U.S. Cl. 429/331; 429/326; 429/328; 429/339

(57) ABSTRACT

A secondary battery is provided and includes a cathode, an anode and an electrolytic solution, in which the anode includes an anode active material layer including a plurality of anode active material particles, the plurality of anode active material particles including silicon as a constituent element. The anode active material layer includes at least one of an oxide-containing film and a metal material as a constituent element. The oxide-containing film with which surfaces of the anode active material particles are covered. The metal material includes a metal element which is not alloyed with an electrode reactant, and being arranged in a gap in the anode active material layer. The electrolytic solution includes a solvent including at least one kind selected from the group consisting of specific isocyanate compounds.

### CROSS REFERENCES TO RELATED APPLICATIONS

The present application claims priority to Japanese Patent Application JP 2008-059499 filed in the Japanese Patent Office on Mar. 10, 2008, and Japanese Patent Application JP 2008-059500 filed in the Japanese Patent Office on Mar. 10, 2008, the entire contents of which are being incorporated herein by reference.

### BACKGROUND

The present disclosure relates to an electrolytic solution including a solvent and a secondary battery including the electrolytic solution as well as a cathode and an anode.

In recent years, portable electronic devices such as camera-integrated VTRs (videotape recorders), cellular phones, or notebook computers are widely used, and size and weight reduction in the portable electronic devices and an increase in longevity of the portable electronic devices have been strongly demanded. Accordingly, as power sources for the portable electronic devices, the development of batteries, specifically lightweight secondary batteries capable of obtaining a high energy density have been promoted.

Among them, a secondary battery (a so-called lithium-ion secondary battery) using insertion and extraction of lithium for charge-discharge reaction or a secondary battery (a so-called lithium metal secondary battery) using deposition and dissolution of lithium holds great promise, because the secondary battery is capable of obtaining a larger energy density, compared to a lead-acid battery or a nickel-cadmium battery.

To improve cycle characteristics, storage characteristics and the like, a technique using a compound including an isocyanate group (—NCO) (an isocyanate compound) as a composition of an electrolytic solution used in the secondary battery has been proposed. As the isocyanate compound, a compound in which one or two or more isocyanate groups are introduced into a benzene ring as described in, for example, Japanese Unexamined Patent Application Publication No. 2002-008719, a low-molecular-weight compound (with a molecular weight of 500 or less) as described in, for example, Japanese Unexamined Patent Application Publication No. 2005-259641, a compound represented by X—NCO (where X is hydrogen, aliphatic hydrocarbon or the like) or Z-Y—NCO (where Z is hydrogen, aliphatic hydrocarbon or the like, Y is —S(═O)₂—, aliphatic hydrocarbon or the like) as described in, for example, Japanese Unexamined Patent Application Publication No. 2006-164759, a compound represented by OCN—R—NCO (where R is a aliphatic carbon chain or the like) as described in, for example, Japanese Unexamined Patent Application Publication No. 2007-242411, or the like is used.

In recent years, portable electronic devices have higher performance and more functions, and the portable electronic devices tend to need more power consumption. Accordingly, secondary batteries tend to be frequently charged and discharged, thereby cycle characteristics easily decline. Therefore, further improvement in cycle characteristics of the secondary batteries is desired. In this case, to obtain superior cycle characteristics, it is important to secure initial charge-discharge characteristics. Moreover, the portable electronic devices have been widely used in various fields, and there is a possibility that the secondary batteries are exposed to a high-temperature atmosphere during the transport, use or carrying of the secondary batteries, so the storage characteristics of the secondary batteries also easily decline. Therefore, further improvement in the storage characteristics of the secondary batteries is desired.

It is desirable to provide a secondary battery capable of improving cycle characteristics while securing initial charge-discharge characteristics.

Moreover, it is desirable to provide an electrolytic solution and a secondary battery capable of improving cycle characteristics and storage characteristics.

### SUMMARY

According to an embodiment, there is provided a secondary battery including a cathode, an anode and an electrolytic solution, in which the anode includes an anode active material layer including a plurality of anode active material particles, the plurality of anode active material particles including silicon as a constituent element, the anode active material layer includes at least one of an oxide-containing film and a metal material as a constituent element, the oxide-containing film with which surfaces of the anode active material particles are covered, the metal material including a metal element which is not alloyed with an electrode reactant, and being arranged in a gap in the anode active material layer, and the electrolytic solution includes a solvent including at least one kind selected from the group consisting of isocyanate compounds represented by Chemical Formula 1 and Chemical Formula 2.

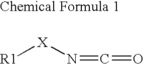

where R1 is a univalent organic group, X is —C(═O)—, —O—C(═O)—, —S(═O)—, —O—S(═O)—, —S(═O)₂— or —O—S(═O)₂—, and X is bonded to a carbon atom in R1,

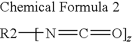

where R2 is a z-valent organic group, z is an integer of 2 or more, and a nitrogen atom in an isocyanate group is bonded to a carbon atom in R2.

The above-described “organic group” is a generic name for a group including a carbon chain or a carbon ring as a basic skeleton, and may include one kind or two or more kinds of other elements such as hydrogen except for carbon. Examples of the “univalent organic group” include an alkyl group, an aryl group, a halide thereof, and a derivative thereof and examples of “divalent organic group” include an alkylene group, an arylene group, a halide thereof, and a derivative thereof. The “halide” is a group in which at least a part of hydrogen in the above-described alkyl group or the like is substituted with a halogen. The “derivative” is a group formed by introducing one or two or more substituent groups into the above-described alkyl group.

According to an embodiment, there is provided an electrolytic solution including a solvent including an isocyanate compound represented by Chemical Formula 3.

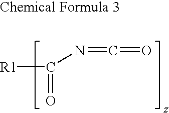

where R1 is a z-valent organic group, and z is an integer of 2 or more, and a carbon atom in a carbonyl group is bonded to a carbon atom in R1.

According to an embodiment, there is provided another secondary battery including a cathode, an anode and an electrolytic solution, in which the electrolytic solution includes a solvent including an isocyanate compound represented by Chemical Formula 4.

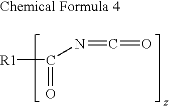

where R1 is a z-valent organic group, and z is an integer of 2 or more, and a carbon atom in a carbonyl group is bonded to a carbon atom in R1.

The above-described “organic group” is a generic name for a group including a carbon chain or a carbon ring as a basic skeleton, and may include one kind or two or more kinds of other elements such as hydrogen except for carbon. Examples of the “divalent organic group” include a straight-chain alkylene group and the like.

In the secondary battery according to the embodiment, the anode active material layer of the anode includes a plurality of anode active material particles including silicon, and includes at least one of the oxide-containing film with which surfaces of the anode active material particles are covered and the metal material which is not alloyed with an electrode reactant and is arranged in a gap in the anode active material layer. Moreover, the solvent of the electrolytic solution includes at least one kind selected from the isocyanate compounds represented by Chemical Formula 1 and Chemical Formula 2. In this case, compared to the case where the anode active material layer does not include the oxide-containing film and the metal material, swelling and shrinkage of the anode active material layer during charge and discharge are prevented, and decomposition reaction of the electrolytic solution is prevented. Moreover, compared to the case where the electrolytic solution does not include the isocyanate compounds represented by Chemical Formula 1 and Chemical Formula 2, or the case where the electrolytic solution includes any other isocyanate compound, the chemical stability of the electrolytic solution is improved, so decomposition reaction of the electrolytic solution during charge and discharge is prevented. Therefore, while initial charge-discharge characteristics are secured, cycle characteristics may be improved.

In the electrolytic solution according to the embodiment, the solvent includes the isocyanate compound represented by Chemical Formula 3, so compared to the case where the isocyanate compound represented by Chemical Formula 3 is not included, or the case where any other isocyanate compound is included, chemical stability is improved. Thereby, in another secondary battery including the electrolytic solution according to the embodiment, decomposition reaction of the electrolytic solution is prevented, so cycle characteristics and storage characteristics may be improved.

Other and further objects, features and advantages will appear more fully from the following description.

Additional features and advantages are described herein, and will be apparent from the following Detailed Description and the figures.

### BRIEF DESCRIPTION OF THE FIGURES

FIG. 1 is a sectional view of the configuration of a secondary battery according to a first embodiment.

FIG. 2 is an enlarged sectional view of a part of a spirally wound electrode body illustrated in FIG. 1.

FIG. 3 is an enlarged sectional view of the configuration of an anode illustrated in FIG. 2.

FIG. 4 is a sectional view of the configuration of an anode of a reference example.

FIG. 5 is a schematic view of a sectional configuration of the anode illustrated in FIG. 2, respectively.

FIG. 6 is a schematic view of another sectional configuration of the anode illustrated in FIG. 2, respectively.

FIG. 7 is a sectional view of the configuration of a secondary battery according to a second embodiment.

FIG. 8 is a sectional view of a spirally wound electrode body taken along a line VIII-VIII of FIG. 7.

FIG. 9 is a plot of results of analysis on a SnCoC-containing material by XPS.

### DETAILED DESCRIPTION

Preferred embodiments will be described in detail below referring to the accompanying drawings.

### First Embodiment

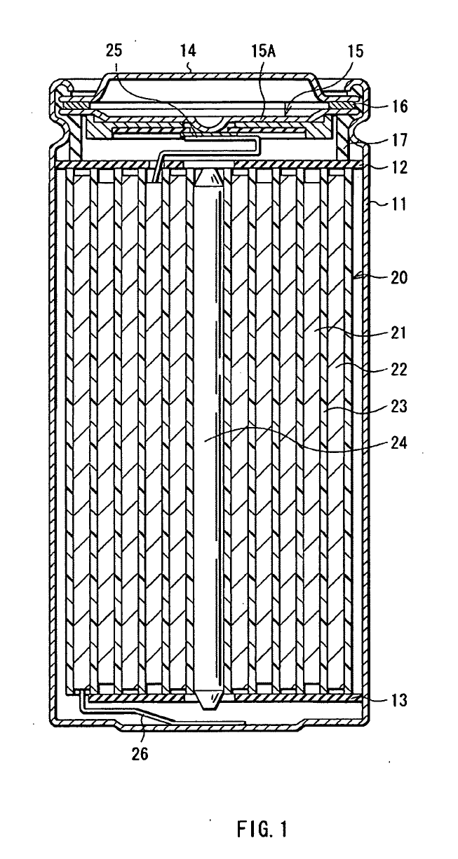

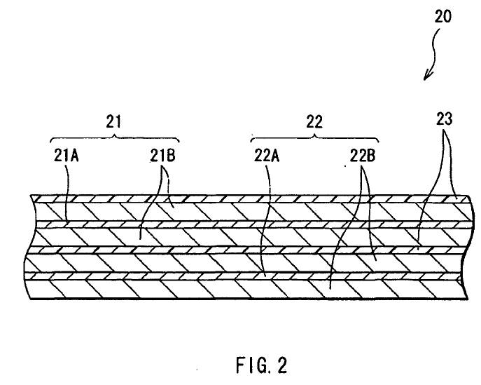

FIGS. 1 and 2 illustrate sectional views of a secondary battery according to a first embodiment. FIG. 2 illustrates an enlarged view of a part of a spirally wound electrode body 20 illustrated in FIG. 1. The secondary battery described herein is a lithium-ion secondary battery in which the capacity of an anode 22 is represented on the basis of insertion and extraction of lithium as an electrode reactant.

The secondary battery mainly includes the spirally wound electrode body 20 in which a cathode 21 and the anode 22 are laminated and spirally wound with a separator 23 in between, and a pair of insulating plates 12 and 13 in a substantially hollow cylindrical-shaped battery can 11. The battery configuration using the cylindrical-shaped battery can 11 is called a cylindrical type.

The battery can 11 has a hollow configuration in which an end of the battery can 11 is closed and the other end thereof is opened, and the battery can 11 is made of a metal material such as iron, aluminum or an alloy thereof. In the case where the battery can 11 is made of iron, the battery can 11 may be plated with, for example, nickel or the like. The pair of insulating plates 12 and 13 are arranged so that the spirally wound electrode body 20 is sandwiched therebetween at the top and the bottom of the spirally wound electrode body 20, and the pair of insulating plates 12 and 13 extend in a direction perpendicular to a peripheral winding surface.

In the open end of the battery can 11, a battery cover 14, and a safety valve mechanism 15 and a positive temperature coefficient device (PTC device) 16 arranged inside the battery cover 14 are mounted by caulking by a gasket 17. Thereby, the interior of the battery can 11 is sealed. The battery cover 14 is made of, for example, the same metal material as that of the battery can 11. The safety valve mechanism 15 is electrically connected to the battery cover 14 through the PTC device 16. In the safety valve mechanism 15, when an internal pressure in the secondary battery increases to a certain extent or higher due to an internal short circuit or external application of heat, a disk plate 15A is flipped so as to disconnect the electrical connection between the battery cover 14 and the spirally wound electrode body 20. When a temperature rises, the PTC device 16 limits a current by an increased resistance to prevent abnormal heat generation caused by a large current. The gasket 17 is made of, for example, an insulating material, and its surface is coated with asphalt.

A center pin 24 may be inserted into the center of the spirally wound electrode body 20. In the spirally wound electrode body 20, a cathode lead 25 made of a metal material such as aluminum is connected to the cathode 21, and an anode lead 26 made of a metal material such as nickel is connected to the anode 22. The cathode lead 25 is electrically connected to the battery cover 14 by welding or the like to the safety valve mechanism 15, and the anode lead 26 is electrically connected to the battery can 11 by welding or the like.

The cathode 21 is formed by arranging a cathode active material layer 21B on both surfaces of a cathode current collector 21A having a pair of surfaces. The cathode active material layer 21B may be arranged on only one surface of the cathode current collector 21A.

The cathode current collector 21A is made of, for example, a metal material such as aluminum, nickel or stainless.

The cathode active material layer 21B includes one kind or two or more kinds of cathode materials capable of inserting and extracting lithium ions as a cathode active material.

As the cathode material capable of inserting and extracting lithium ions, for example, a lithium-containing compound is preferable, because a high energy density is obtained. Examples of the lithium-containing compound include a complex oxide including lithium and a transition metal element, a phosphate compound including lithium and a transition metal element, and the like. Among them, a complex oxide or a phosphate compound including at least one kind selected from the group consisting of cobalt, nickel, manganese and iron as the transition metal element is preferable, because a higher voltage is obtained. The chemical formulas of the complex oxide and the phosphate compound are represented by, for example, LiₓM1O₂ and Li_{y}M2PO₄, respectively. In the chemical formulas, M1 and M2 each represent one or more kinds of transition metal elements. The values of x and y depend on a charge-discharge state of the secondary battery, and are generally within a range of 0.05≦x≦1.10 and 0.05≦y≦1.10, respectively.

Examples of the complex oxide including lithium and a transition metal element include lithium-cobalt complex oxide (LiₓCoO₂), lithium-nickel complex oxide (LiₓNiO₂), lithium-nickel-cobalt complex oxide (LiₓNi_{1-z}Co_{z}O₂ (z<1)), lithium-nickel-cobalt-manganese complex oxide (LiₓNi_{(1-v-w)}CoᵥMn_{w}O₂ (v+w<1)), lithium-manganese complex oxide (LiMn₂O₄) having a spinel structure and the like. Among them, a complex oxide including cobalt is preferable. It is because a high capacity is obtained, and superior cycle characteristics are obtained. Examples of the phosphate compound including lithium and a transition metal element include a lithium-iron phosphate compound (LiFePO₄), a lithium-iron-manganese phosphate compound (LiFe₁₋ᵤMnᵤPO₄ (u<1)) and the like.

In addition to the above-described cathode materials, examples of the cathode material capable of inserting and extracting lithium ions include an oxide such as titanium oxide, vanadium oxide or manganese dioxide, a bisulfide such as titanium bisulfide or molybdenum sulfide, a chalcogenide such as niobium selenide, sulfur, and a conductive polymer such as polyaniline or polythiophene.

The cathode material capable of inserting and extracting lithium ions may be any material other than the above-described cathode materials. A mixture of two or more kinds arbitrarily selected from the above-described cathode materials may be used.

The cathode active material layer 21B may include any other material such as a cathode binder or a cathode conductor in addition to the above-described cathode active materials.

Examples of the cathode binder include synthetic rubber such as styrene butadiene-based rubber, fluorine-based rubber or ethylene propylene diene and a polymer material such as polyvinylidene fluoride. Only one kind or a mixture of a plurality of kinds selected from them may be used.

Examples of the cathode conductor include carbon materials such as graphite, carbon black, acetylene black and ketjen black. Only one kind or a mixture of a plurality of kinds selected from them may be used. As long as the cathode conductor is a material having electrical conductivity, any metal material or any conductive polymer may be used.

The anode 22 is formed by arranging an anode active material layer 22B on both surfaces of an anode current collector 22A having a pair of surfaces. The anode active material layer 22B may be arranged on only one surface of the anode current collector 22A.

The anode current collector 22A is made of, for example, a metal material such as copper, nickel or stainless. The surface of the anode current collector 1 is preferably roughened, because adhesion between the anode current collector 22A and the anode active material layer 22B is improved by a so-called anchor effect. In this case, at least a region facing the anode active material layer 22B of the anode current collector 22A may be roughened. As a roughening method, for example, a method of forming fine particles by electrolytic treatment or the like is used. The electrolytic treatment is a method of forming fine particles on the surface of the anode current collector 22A in an electrolytic bath by an electrolytic method to form a roughened surface. Copper foil formed by the electrolytic treatment is generally called “electrolytic copper foil”.

The anode active material layer 22B includes at least one kind or two or more kinds of anode materials capable of inserting and extracting lithium ions as anode active materials. At this time, a chargeable capacity in the anode material capable of inserting and extracting lithium ions is preferably larger than the discharge capacity of the cathode 21.

As the anode material capable of inserting and extracting lithium ions, a material capable of inserting and extracting lithium ions and including at least one kind selected from the group consisting of metal elements and metalloid elements is used, because a high energy density is obtained. Such an anode material may be any one of the simple substances, alloys and compounds of metal elements and metalloid elements, or may include a phase including one kind or two or more kinds selected from them at least in part. “Alloy” means an alloy including two or more kinds of metal elements as well as an alloy including one or more kinds of metal elements and one or more kinds of metalloid elements. Moreover, the “alloy” may include a non-metal element. As the texture of the alloy, a solid solution, a eutectic (eutectic mixture), an intermetallic compound or the coexistence of two or more kinds selected from them is cited.

Examples of the above-described metal elements and the above-described metalloid element include metal elements and metalloid elements capable of forming an alloy with lithium. Specific examples include magnesium, boron (B), aluminum, gallium (Ga), indium (In), silicon, germanium (Ge), tin, lead (Pb), bismuth (Bi), cadmium (Cd), silver (Ag), zinc, hafnium (Hf), zirconium (Zr), yttrium (Y), palladium (Pd), platinum (Pt) and the like. Among them, at least one kind selected from the group consisting of silicon and tin is preferable, and silicon is more preferable, because silicon has a high capability of inserting and extracting lithium ions, so a high energy density is obtained.

Examples of a material including at least one kind selected from the group consisting of silicon and tin as a constituent element include the simple substance, alloys and compounds of silicon, the simple substance, alloys and compounds of tin, and a material including a phase of one kind or two or more kinds selected from them at least in part.

Examples of alloys of silicon include alloys including at least one kind selected from the group consisting of tin, nickel, copper, iron, cobalt, manganese, zinc, indium, silver, titanium, germanium, bismuth, antimony (Sb) and chromium as a second constituent element in addition to silicon. Examples of compounds of silicon include compounds including oxygen or carbon (C), and the compounds of silicon may include the above-described second constituent element in addition to silicon. Examples of the alloys and compounds of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), LiSiO and the like.

Examples of alloys of tin include alloys including at least one kind selected from the group consisting of silicon, nickel, copper, iron, cobalt, manganese, zinc, indium, silver, titanium, germanium, bismuth, antimony and chromium as a second constituent element in addition to tin. Examples of compounds of tin include compounds including oxygen or carbon, and the compounds of tin may include the above-described second constituent element in addition to tin. Examples of the alloys and compounds of tin include SnSiO₃, LiSnO, Mg₂Sn and the like.

In particular, as the anode material including at least one kind selected from the group consisting of silicon and tin, for example, an anode material including tin as a first constituent element, and a second constituent element and a third constituent element is preferable. The second constituent element includes at least one kind selected from the group consisting of cobalt, iron, magnesium, titanium, vanadium (V), chromium, manganese, nickel, copper, zinc, gallium, zirconium, niobium (Nb), molybdenum, silver, indium, cerium (Ce), hafnium, tantalum (Ta), tungsten (W), bismuth and silicon. The third constituent element includes at least one kind selected from the group consisting of boron, carbon, aluminum and phosphorus (P). When the second constituent element and the third constituent element are included, cycle characteristics are improved.

Among them, a SnCoC-containing material in which tin, cobalt and carbon are included as constituent elements, and the carbon content is within a range from 9.9 wt % to 29.7 wt % both inclusive, and the ratio of cobalt to the total of tin and cobalt (Co/(Sn+Co)) is within a range from 30 wt % to 70 wt % both inclusive is preferable, because a high energy density is obtained in such a composition range.

The SnCoC-containing material may include any other constituent element, if necessary. As the constituent element, for example, silicon, iron, nickel, chromium, indium, niobium, germanium, titanium, molybdenum, aluminum, phosphorus, gallium, bismuth or the like is preferable, and two or more kinds selected from them may be included, because a higher effect is obtained.

The SnCoC-containing material includes a phase including tin, cobalt and carbon, and the phase preferably has a low crystalline structure or an amorphous structure. The phase is a reactive phase capable of reacting with lithium, and superior cycle characteristics are obtained by the phase. The half-width of a diffraction peak of the phase obtained by X-ray diffraction is preferably 1.0° or more at a diffraction angle of 2θ in the case where a CuKα ray is used as a specific X ray and the sweep rate is 1°/min, because lithium is inserted or extracted more smoothly, and the reactivity with an electrolyte is reduced.

Whether the diffraction peak obtained by X-ray diffraction corresponds to a reactive phase capable of reacting with lithium or not may be easily determined by comparing between X-ray diffraction charts before and after electrochemical reaction with lithium. For example, when the position of the diffraction peak before the electrochemical reaction with lithium is different from the position of the diffraction peak after the electrochemical reaction, the diffraction peak corresponds to a reactive phase capable of reacting with lithium. In this case, the diffraction peak of a low crystalline reactive phase or an amorphous reactive phase is detected within a range of, for example, 2θ=20° to 50°. The low crystalline reactive phase or the amorphous reactive phase includes, for example, each of the above-described elements, and it is considered that the reactive phase is changed to be low crystalline or amorphous mainly by carbon.

The SnCoC-containing material may have a phase including the simple substance of each constituent element or a part of the constituent element in addition to the low crystalline phase or the amorphous phase.

In particular, in the SnCoC-containing material, at least a part of carbon as a constituent element is preferably bonded to a metal element or a metalloid element as another constituent element, because cohesion or crystallization of tin or the like is prevented.

As a measuring method for checking the bonding state of an element, for example, X-ray photoelectron spectroscopy (XPS) is used. The XPS is a method of checking element composition in a region a few nm away from a surface of a specimen, and the bonding state of an element by irradiating the surface of the specimen with a soft X ray (in a commercially available apparatus, an Al—Kα ray or an Mg—Kα ray is used) and measuring the kinetic energy of a photoelectron emitted from the surface of the specimen.

The binding energy of an inner orbital electron of an element is changed in relation to a charge density on the element in a first order approximation. For example, when the charge density of a carbon element is reduced due to an interaction with an element near the carbon element, outer electrons such as 2p electrons are reduced, so is electrons of the carbon element are strongly bound by a shell. In other words, when the charge density of the element is reduced, the binding energy is increased. In the XPS, when the binding energy increases, the peak is shifted to a higher energy region.

In the XPS, the peak of the is orbit (C1s) of carbon in the case of graphite is observed at 284.5 eV in an apparatus in which energy calibration is performed so that the peak of the 4f orbit (Au4f) of a gold atom is observed at 84.0 eV. Moreover, surface contamination carbon is observed at 284.8 eV. On the other hand, in the case where the charge density of the carbon element increases, for example, in the case where carbon is bonded to a more positive element than carbon, the peak of C1s is observed in a region lower than 284.5 eV. In other words, in the case where at least a part of carbon included in the SnCoC-containing material is bonded to a metal element or a metalloid element which is another constituent element, the peak of the composite wave of C1s obtained in the SnCoC-containing material is observed in a region lower than 284.5 eV.

In the XPS measurement, in the case where the surface of the SnCoC-containing material is covered with surface contamination carbon, it is preferable to lightly sputter the surface with an argon ion gun attached to an XPS apparatus. Moreover, in the case where the SnCoC-containing material to be measured exists in the anode 22, after the secondary battery is disassembled to take out the anode 22, the anode 22 may be cleaned with a volatile solvent such as dimethyl carbonate so that a low volatile solvent and an electrolyte salt on the surface of the anode 22 is removed. Such sampling is preferably performed in an inert atmosphere.

Moreover, in the XPS measurement, for example, the peak of C1s is used to correct the energy axis of a spectrum. In general, surface contamination carbon exists on a material surface, so the peak of C1s of the surface contamination carbon is fixed at 284.8 eV, and the peak is used as an energy reference. In the XPS measurement, the waveform of the peak of C1s is obtained as a form including the peak of the surface contamination carbon and the peak of carbon in the SnCoC-containing material, so the peak of the surface contamination carbon and the peak of the carbon in the SnCoC-containing material are separated by analyzing the waveform through the use of, for example, commercially available software. In the analysis of the waveform, the position of a main peak existing on a lowest binding energy side is used as an energy reference (284.8 eV).

The SnCoC-containing material is formed, for example, by melting a mixture of the materials of all constituent elements in an electric furnace, a high-frequency induction furnace, an arc furnace or the like, and then solidifying the mixture. Alternatively, the SnCoC-containing material may be formed by various atomization methods such as gas atomization or water atomization, various roll methods, or methods using mechanochemical reaction such as a mechanical alloying method or a mechanical milling method. Among them, the method using mechanochemical reaction is preferable, because the SnCoC-containing material has a low crystalline structure or an amorphous structure. In the method using mechanochemical reaction, a manufacturing apparatus such as a planetary ball mill or an attiritor may be used.

As the materials of the SnCoC-containing material, a mixture of the simple substances of the constituent elements may be used. However, an alloy of a part of the constituent elements except for carbon is preferably used, because when carbon is added to such an alloy to synthesize the SnCoC-containing material by a mechanical alloying method, the SnCoC-containing material has a low crystalline structure or an amorphous structure, and a reaction time is reduced. The form of the material may be powder or a lump.

In addition the SnCoC-containing material, a SnCoFeC-containing material including tin, cobalt, iron and carbon as constituent elements is preferable. The composition of the SnCoFeC-containing material may be arbitrarily set. For example, as a composition in the case where the iron content is set to be small, it is preferable that the carbon content is within a range of 9.9 wt % to 29.7 wt % both inclusive, the iron content is within a range of 0.3 wt % to 5.9 wt % both inclusive, and the ratio of cobalt to the total of tin and cobalt (Co/(Sn+Co)) is within a range of 30 wt % to 70 wt % both inclusive. Moreover, as a composition in the case where the iron content is set to be large, it is preferable that the carbon content is within a range of 11.9 wt % to 29.7 wt % both inclusive, the ratio of the total of cobalt and iron to the total of tin, cobalt and iron ((Co+Fe)/(Sn+Co+Fe)) is within a range of 26.4 wt % to 48.5 wt % both inclusive, and the ratio of cobalt to the total of cobalt and iron (Co/(Co+Fe)) is within a range of 9.9 wt % to 79.5 wt % both inclusive. It is because in such a composition range, a high energy density is obtained. The crystallinity of the SnCoFeC-containing material, a method of measuring the bonding state of elements in the SnCoFeC-containing material, and a method of forming the SnCoFeC-containing material and the like are the same as those in the above-described SnCoC-containing material.

The anode active material layer 22B using the simple substance, an alloy or a compound of silicon, the simple substance, an alloy or a compound of tin, or a material including a phase of one kind or two or more kinds selected from them at least in part as an anode material capable of inserting and extracting lithium ions is formed by, for example, a vapor-phase method, a liquid-phase method, a spraying method, a coating method, a firing method, or a combination of two or more methods selected from them. In this case, the anode current collector 22A and the anode active material layer 22B are preferably alloyed in at least a part of an interface therebetween. More specifically, in the interface between them, a constituent element of the anode current collector 22A may be diffused into the anode active material layer 22B, or a constituent element of the anode active material layer 22B may be diffused into the anode current collector 22A, or they may be diffused into each other. It is because fracture due to swelling and shrinkage of the anode active material layer 22B during charge and discharge is prevented, and electronic conductivity between the anode current collector 22A and the anode active material layer 22B is improved.

As the vapor-phase method, for example, a physical deposition method or a chemical deposition method, more specifically, a vacuum deposition method, a sputtering method, an ion plating method, a laser ablation method, a thermal chemical vapor deposition (CVD) method, a plasma chemical vapor deposition method or the like is used. As the liquid-phase method, a known technique such as electrolytic plating or electroless plating may be used. The coating method is, for example, a method in which a particulate anode active material is mixed with a binder or the like to form a mixture, and the mixture is dispersed in a solvent, and then coating with the mixture is performed. The firing method is, for example, a method in which after coating by the coating method, the mixture is heated at a higher temperature than the melting point of the binder or the like. As the firing method, a known technique may be used, and, for example, an atmosphere firing method, a reaction firing method or a hot press firing method is used.

In addition to the above-described material, as the anode material capable of inserting and extracting lithium ions, for example, a carbon material is used. Examples of such a carbon material include graphitizable carbon, non-graphitizable carbon with a (002) plane interval of 0.37 nm or more, graphite with a (002) plane interval of 0.34 nm or more, and the like. More specifically, kinds of pyrolytic carbon, kinds of coke, glass-like carbon fibers, fired organic polymer compound bodies, activated carbon, kinds of carbon black and the like are used. Among them, kinds of coke include pitch coke, needle coke, petroleum coke and the like. The fired organic polymer compound bodies are polymers such as a phenolic resin and a furan resin which are carbonized by firing at an adequate temperature. These carbon materials are preferable, because a change in a crystal structure according to insertion and extraction of lithium is very small, so a high energy density is obtained, and superior cycle characteristics are obtained, and the carbon materials also function as electrical conductors. The carbon material may have the form of fibers, balls, particles, or flakes.

In addition, as the anode material capable of inserting and extracting lithium ions, for example, a metal oxide or a polymer compound capable of inserting and extracting lithium ions is used. Examples of the metal oxide include iron oxide, ruthenium oxide, molybdenum oxide and the like, and examples of the polymer compound include polyacetylene, polyaniline, polypyrrole and the like.

Any anode material capable of inserting and extracting lithium ions other than the above-described anode materials may be used. A mixture of two or more kinds arbitrarily selected from the above-described anode materials may be used.

The above-described anode active material includes a plurality of particles. In other words, the anode active material layer 22B includes a plurality of particulate anode active materials (hereinafter simply referred to as “anode active material particles”), and the anode active material particles is formed by the above-described vapor-phase method or the like. The anode active material particles may be formed by any method other than the vapor-phase method.

In the case where the anode active material particles are formed by a deposition method such as the vapor-phase method, the anode active material particles may have a single-layer configuration formed by a single deposition step, or a multilayer configuration formed by repeating the deposition step a plurality of times. In the case where the anode active material particles are formed by an evaporation method or the like associated high heat during deposition, the anode active material particles preferably have a multilayer configuration, because when a step of depositing the anode material is performed a plurality of times separately (the anode material is thinly formed and sequentially deposited), compared to the case where the deposition step is performed only once, a duration in which the anode current collector 22A is exposed to high heat is reduced, and the anode current collector 22A is less susceptible to thermal damage.

The anode active material particles are grown, for example, from the anode current collector 22A in a thickness direction of the anode active material layer 22B, and the anode active material particles at the bottom of the anode active material layer 22B are preferably coupled to the anode current collector 22A, because swelling and shrinkage of the anode active material layer 22B during charge and discharge is prevented. In this case, the anode active material particles are formed by the vapor-phase method or the like, and as described above, the anode active material particles are preferably alloyed in at least a part of the interface with the anode current collector 22A. More specifically, in the interface between them, a constituent element of the anode current collector 22A may be diffused into the anode active material particles, a constituent element of the anode active material particles may be diffused into the anode current collector 22A, or they may be diffused into each other.

In particular, the anode active material layer 22B includes at least one of an oxide-containing film with which surfaces of the anode active material particles are coated and a metal material which is not alloyed with lithium and is arranged in gaps in the anode active material layer 22B in addition to a plurality of anode active material particles.

The oxide-containing film is applied to the surfaces of the anode active material particles, that is, the surfaces of anode active material particles which are supposed to come in contact with an electrolytic solution in the case where the oxide-containing film is not arranged. The reason why the anode active material layer 22B includes the oxide-containing film is because the oxide-containing film functions as a protective film against the electrolytic solution, and even if charge and discharge are repeated, decomposition reaction of the electrolytic solution is prevented, so the cycle characteristics are improved. All or only a part of the surfaces of the anode active material particles may be coated with the oxide-containing film. However, all of the surfaces of the anode active material particles are preferably coated with the oxide-containing film, because decomposition reaction of the electrolytic solution is effectively prevented.

The oxide-containing film includes at least one kind of oxide selected from the group consisting of oxides of silicon, germanium and tin, and among them, an oxide of silicon is preferably included, because the whole surfaces of the anode active material particles are easily coated with the oxide-containing film, and a superior protection function is obtained. The oxide-containing film may include any oxide other than the above-described oxide.

The oxide-containing film is formed by, for example, a vapor-phase method or a liquid-phase method, and the oxide-containing film is preferably formed by the liquid-phase method, because the oxide-containing film is easily applied to the surfaces of the anode active material particles in a wide range. As the liquid-phase method, for example, a liquid-phase deposition method, a sol-gel method, a coating method, a dip coating method or the like is used, and among them, the liquid-phase deposition method, the sol-gel method or the dip coating method is preferable, and the liquid-phase deposition method is more preferable, because a higher effect is obtained. The oxide-containing film may be formed by a single forming method or a combination of two or more forming methods selected from the above-described forming methods.

When the oxide-containing film is formed by the liquid-phase deposition method, the oxide-containing film may be deposited while easily controlling the oxide. The liquid-phase deposition method is, for example, a method in which a dissolved species which easily coordinates fluorine (F) as an anion trapping agent is added to and mixed with a fluoride complex solution of silicon, tin or germanium, and then the anode current collector 22A on which the anode active material layer 22B is formed is immersed in the fluoride complex solution, and then a fluorine anion generated from a fluoride complex is trapped by the dissolved species, thereby an oxide is deposited on the surface of the anode active material layer 22B to form the oxide-containing film. Instead of the fluoride complex, for example, a compound of silicon, tin or germanium which generates other anions such as sulfate ions may be used.

In the case where the oxide-containing film is formed by the sol-gel method, a processing liquid including a fluorine anion or a compound of fluorine and one kind selected from the group consisting of Group 13 elements, Group 14 elements and Group 15 elements in the long form of the periodic table of the elements (more specifically, fluorine ions, tetrafluoroborate ions, hexafluorophosphate ions or the like) as a reaction accelerator is preferably used, because in the oxide-containing film formed through the use of the processing liquid, the content of an alkoxy group is low, so in the case where the oxide-containing film is used in the anode 22, a gas generation amount is reduced.

The thickness of the oxide-containing film is not specifically limited. However, the thickness of the oxide-containing film is preferably within a range of 0.1 nm to 500 nm both inclusive, because the oxide-containing film is easily applied to the surfaces of the anode active material particles in a wide range. More specifically, when the thickness of the oxide-containing film is smaller than 0.1 nm, there is a possibility that it is difficult to coat the surfaces of the anode active material particles in a wide range with the oxide-containing film, and when the thickness is larger than 500 nm, the formation amount of the oxide-containing film is too large, thereby the energy density may decline. The thickness of the oxide-containing film is more preferably within a range of 1 nm to 200 nm both inclusive, and more preferably within a range of 10 nm to 150 nm both inclusive, and more preferably within a range of 20 nm to 100 nm both inclusive, because a higher effect is obtained.

The metal material which is not alloyed with lithium (hereinafter simply referred to as “metal material”) is arranged in gaps in the anode active material layer 22B, that is, gaps between the anode active material particles which will be described later or gaps in the anode active material particles. The reason why the anode active material layer 22B includes the metal material is because a plurality of anode active material particles are bound through the metal material, and when the metal material exists in the above-described gaps, swelling and shrinkage of the anode active material layer 22B is prevented, thereby the cycle characteristics are improved.

The metal material includes a metal element which is not alloyed with lithium as a constituent element. As such a metal element, at least one kind selected from the group consisting of iron, cobalt, nickel, zinc and copper is included, and among them, cobalt is preferably included, because the metal material easily enters into the above-described gaps, and a superior binding function is obtained. The metal material may include any metal element other than the above-described metal element. However, the “metal material” herein means a wide concept including not only a simple substance but also an alloy or a metal compound.

The metal material is formed by, for example, a vapor-phase method or a liquid-phase method, and among them, the metal material is preferably formed by the liquid-phase method, because the metal material easily enters into the gaps in the anode active material layer 22B. As the liquid-phase method, an electrolytic plating method, an electroless plating method or the like is used, and among them, the electrolytic plating method is preferable, because the metal material enters into the above-described gaps more easily, and only a short forming time is necessary. The metal material may be formed by a single forming method or a combination of two or more kinds selected from the above-described forming methods.

As is clear from the description that the anode active material layer 22B includes “at least one of the oxide-containing film and the metal material”, the anode active material layer 22B may include only one of the oxide-containing film and the metal material, or may include both of them. However, to further improve the cycle characteristics, the anode active material layer 22B preferably includes both of them. Moreover, in the case where both of the oxide-containing film and the metal material are included, either of them may be formed first. However, to further improve the cycle characteristics, the oxide-containing film is preferably formed first.

If necessary, the anode active material layer 22B may include any other material such as an anode binder or an anode conductor in addition to the above-described anode active material, and the like. For example, details about the anode binder and the anode conductor are the same as those about the cathode binder and the cathode conductor, respectively.

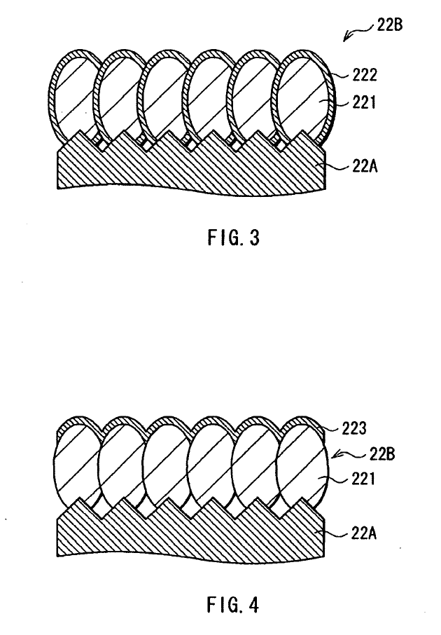

The configuration of the anode 22 will be described in detail referring to FIGS. 3 to 6A and 6B.

First, the case where the anode active material layer 22B includes a plurality of anode active material particles and the oxide-containing film will be described below. FIG. 3 illustrates a schematic sectional view of the anode 22 according to the embodiment, and FIG. 4 illustrates a schematic sectional view of an anode of a reference example. In FIGS. 3 and 4, the case where the anode active material particles have a single-layer configuration is illustrated.

In the anode according to the embodiment, as illustrated in FIG. 3, when the anode material is deposited on the anode current collector 22A by, for example, a vapor-phase method such as an evaporation method, a plurality of anode active material particles 221 are formed on the anode current collector 22A. In this case, the surface of the anode current collector 22A is roughened, and a plurality of projections (for example, fine particles formed by electrolytic treatment) are present, the anode active material particles 221 are grown from each of the above-described projections in a thickness direction, so the plurality of anode active material particles 221 are aligned on the anode current collector 22A, and the bottom portions of the plurality of anode active material particles 221 are coupled to the surface of the anode current collector 22A. After that, when an oxide-containing film 222 is formed on surfaces of the anode active material particles 221 by, for example, a liquid-phase method such as a liquid-phase deposition method, the oxide-containing film 222 is applied to substantially the whole surfaces of the anode active material particle 221, and in particular, the oxide-containing film 222 is applied to the anode active material particles 221 in a wide range from the top to the bottom. A wide-range coating state by the oxide-containing film 222 is a characteristic obtained in the case where the oxide-containing film 222 is formed by the liquid-phase method. In other words, when the oxide-containing film 222 is formed by the liquid-phase method, the coating function covers not only the tops of the anode active material particles 221 but also the bottoms of the anode active material particles 221, so the oxide-containing film 222 is also applied to the bottoms of the anode active material particles.

On the other hand, in the anode of the reference example, as illustrated in FIG. 4, after the plurality of anode active material particles 221 is formed by, for example, the vapor-phase method, the oxide-containing film 223 is formed by the same vapor-phase method, thereby the oxide-containing film 223 is applied to only the tops of the anode active material particles 221. The narrow-range coating state by the oxide-containing film 223 is a characteristic obtained in the case where the oxide-containing film 223 is formed by the vapor-phase method. In other words, when the oxide-containing film 223 is formed by the vapor-phase method, the coating function covers only the tops of the anode active material particles 221 and does not cover the bottoms of the anode active material particles 221, so the bottoms of the anode active material particles 221 are not coated with the oxide-containing film 223.

In addition, in FIG. 3, the case where the anode active material layer 22B is formed by the vapor-phase method is described. However, also in the case where the anode active material layer 22B is formed by any other forming method such as the coating method or a sintering method, the oxide-containing film is formed so that substantially the whole surfaces of the plurality of anode active material particles are coated with the oxide-containing film.

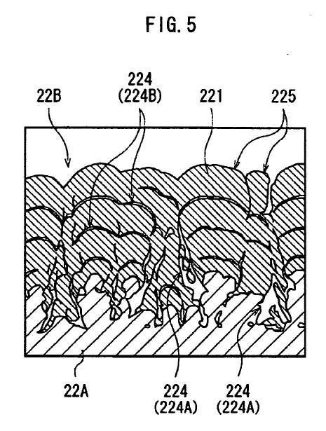

Next, the case where the anode active material layer 22B includes a plurality of anode active material particles as well as the metal material which is not alloyed with lithium will be described below. FIG. 5 illustrates an enlarged sectional view of the anode 22, and is a schematic view of an SEM image of same. FIG. 5 illustrates the case where the plurality of anode active material particles 221 each have a multilayer configuration.

In the case where the anode active material particles 221 each have a multilayer configuration, a plurality of gaps 224 are formed in the anode active material layer 22B due to the array configuration, the multilayer configuration and the surface configuration of the plurality of anode active material particles 221. The gaps 224 include two kinds of gaps 224A and 224B classified by a cause of formation. The gaps 224A are formed between adjacent anode active material particles 221, and the gaps 224B are formed between layers of the multilayer configuration in each of the anode active material particles 221.

Voids 225 may be formed on exposed surfaces (the outermost surface) of the anode active material particles 221. As small stubble-shaped projections (not illustrated) are formed on the surfaces of the anode active material particles 221, the voids 225 are formed between the projections accordingly. The voids 225 may be formed all over the exposed surfaces of the anode active material particles 221, or on a part of the exposed surfaces of the anode active material particles 221. The above-described stubble-shaped projections are formed on the surfaces of the anode active material particles 221 in each formation of the anode active material particles 221, so the voids 225 may be formed not only the exposed surfaces of the anode active material particles 221 but also between layers of the multilayer configuration of each anode active material particle 221.

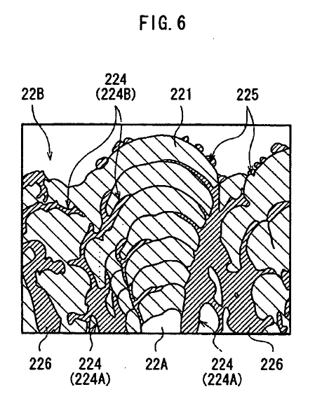

FIG. 6 illustrates another sectional view of the anode 22, and corresponds to FIG. 5. The anode active material layer 22B includes a metal material 226 which is not alloyed with lithium in the gaps 224A and 224B. In this case, the metal material 226 may be included in only one of the gaps 224A and 224B. However, the metal material 226 is preferably included in both of the gaps 224A and 224B, because a higher effect is obtained.

The metal material 226 enters into the gaps 224A between the adjacent anode active material particles 221. More specifically, in the case where the anode active material particles 221 are formed by the vapor-phase method or the like, as described above, the anode active material particles 221 are grown from each of the projections existing on the surface of the anode current collector 22A, so the gaps 224A are formed between the adjacent anode active material particles 221. The gaps 224A may cause a decline in a binding property of the anode active material layer 22B, so to improve the binding property, the above-described gaps 224A are filled with the metal material 226. In this case, only a part of gaps 224A may be filled with the metal material 226. However, a more filling amount is more preferable, because the binding property of the anode active material layer 22B is further improved. The filling amount of the metal material 226 is preferably 20% or over, more preferably 40% or over and more preferably 80% or over.

Moreover, the metal material 226 enters into the gaps 224B in the anode active material particles 221. More specifically, in the case where the anode active material particles 221 each have a multilayer configuration, gaps 224B are formed between layers of the multilayer configuration. The gaps 224B causes a decline in the binding property of the anode active material layer 22B as in the case of the above-described gaps 224A, so to improve the binding property, the above-described gaps 224B are filled with the metal material 226. In this case, a part of the gaps 224B may be filled with the metal material 226. However, a more filling amount is more preferable, because the binding property of the anode active material layer 22B is further improved.

To prevent the small stubble-shaped projections (not illustrated) formed on the exposed surfaces of the anode active material particles 221 in an outermost layer from exerting an adverse effect on the performance of the secondary battery, the metal material 226 may be included in the voids 225. More specifically, in the case where the anode active material particles 221 are formed by the vapor-phase method or the like, small stubble-shaped projections are formed on the surfaces of the anode active material particles 221, so the voids 225 are formed between the projections. The voids 225 cause an increase in the surface areas of the anode active material particles 221, and an increase in the amount of an irreversible coating formed on the surfaces, so the voids 225 may cause a decline in the extent of electrode reaction (charge-discharge reaction). Therefore, to prevent a decline in the extent of electrode reaction, the above-described voids 225 are filled with the metal material 226. In this case, only a part of the voids 225 may be filled with the metal material 225. However, a more filling amount is more preferable, because a decline in the extent of electrode reaction is further prevented. In FIG. 6, dotting the metal material 226 on the surfaces of the anode active material particles 226 in the outermost layer means that the above-described small projections are present in positions where the metal material 226 is dotted. The metal material 226 is not necessarily dotted on the surfaces of the anode active material particles 221, and the whole surfaces may be coated with the metal material 226.

In particular, the metal material 226 entering into the gaps 224B also performs a function of filling the voids 225 in each layer. More specifically, in the case where the anode material is deposited a plurality of times, the above-described small projections are formed on the surfaces of the anode active material particles 221 during each deposition. Therefore, the metal material 226 enters into not only the gaps 224B in each layer but also the voids 225 in each layer.

In FIGS. 5 and 6, the case where the anode active material particles 221 each have a multilayer configuration, and both of the gaps 224A and 224B are present in the anode active material layer 22B is described, so the anode active material layer 22B includes the metal material 226 in the gaps 224A and 224B. On the other hand, in the case where the anode active material particles 221 each have a single-layer configuration, and only the gaps 224A are present in the anode active material layer 22B, the anode active material layer 22B includes the metal material 226 only in the gaps 224A. The voids 225 are present in both of the cases, so the metal material 226 is included in the voids 225.

The separator 23 isolates between the cathode 21 and the anode 22 so that lithium ions pass therethrough while preventing a short circuit of a current due to contact between the cathode 21 and the anode 22. The separator 23 is made of, for example, a porous film of a synthetic resin such as polytetrafluoroethylene, polypropylene or polyethylene, a porous film of ceramic, or the like, and the separator 23 may have a configuration in which two or more kinds of the porous films are laminated.

The separator 23 is impregnated with an electrolytic solution as a liquid electrolyte. The electrolytic solution includes a solvent and an electrolyte salt dissolved in the solvent.

The solvent includes at least one kind selected from the group consisting of isocyanate compounds represented by Chemical Formula 5 and Chemical Formula 6, because the chemical stability of the electrolytic solution is improved. The isocyanate compound represented by Chemical Formula 5 is a compound including one isocyanate group (—NCO) and one electron-withdrawing group (—X—). The isocyanate compound represented by Chemical Formula 6 is a compound including two or more isocyanate groups.

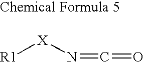

where R1 is a univalent organic group, X is —C(═O)—, —O—C(═O)—, —S(═O)—, —O—S(═O)—, —S(═O)₂— or —O—S(═O)₂—, and X is bonded to a carbon atom in R1.

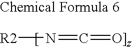

where R2 is a z-valent organic group, z is an integer of 2 or more, and a nitrogen atom in an isocyanate group (—NCO) is bonded to a carbon atom in R2.

The “organic group” describing R1 in Chemical Formula 5 and R2 in Chemical Formula 6 is a generic name for a group including a carbon chain or a carbon ring as a basic skeleton. As long as the “organic group” includes the carbon chain or the carbon ring as a basic skeleton, the organic group may have any configuration as a whole. In this case, the “organic group” may include any other element as a constituent element except for one or two or more carbon atoms. Examples of the “other element” include hydrogen, halogens and the like. The carbon chain may have a straight-chain form or a branched-chain form including one or two or more side chains.

Among them, R1 is preferably an alkyl group having 1 to 10 carbon atoms, an aryl group, a halogenated alkyl group having 1 to 10 carbon atoms, a halogenated aryl group, or a derivative thereof, because superior chemical stability is obtained in the electrolytic solution. The number of carbon atoms in the above-described alkyl group or the above-described halogenated alkyl group is 1 to 10 both inclusive, because in the case where the isocyanate compound represented by Chemical Formula 5 is mixed with another solvent or the like to be used in the electrolytic solution, superior compatibility is obtained, and as the isocyanate compound represented by Chemical Formula 5 preferentially reacts (is decomposed) during charge and discharge, decomposition reaction of the other solvent or the like is prevented. In this case, to obtain a higher effect, the number of carbon atoms is preferably 5 or less, and more preferably 4 or less.

Moreover, R2 is preferably an alkylene group having 1 to 10 carbon atoms or an arylene group, because superior chemical stability is obtained in the electrolytic solution. The number of carbon atoms in the above-described alkylene group is 1 to 10 both inclusive because of the same reason as that in the case of R1. In this case, to obtain a higher effect, the number of carbon atoms is preferably 8 or less.

As long as z in Chemical Formula 6 is 2 or more, z is not specifically limited. However, z is preferably 2 or 3, because the chemical stability of the isocyanate compound represented by Chemical Formula 6 is improved, thereby the chemical stability of the electrolytic solution is further improved.

In addition, the above-described “halogenated alkyl group” or “halogenated aryl group” is a group in which at least a part of hydrogen in an alkyl group or an aryl group is substituted with a halogen. The kind of halogen is not specifically limited. However, among halogens, fluorine is preferable, because compared to other halogens, the chemical stability of the electrolytic solution is improved.

Moreover, the “derivative” is formed by introducing one or two or more substituent groups into any of the above-described groups such as the alkyl group, and the kind of the substituent group is arbitrarily selected. Examples of the derivative include a derivative formed by introducing an alkyl group such as a methyl group into the aryl group, and the like.

Among the groups represented by X in Chemical Formula 5, in a group having an asymmetrical configuration (—O—C(═O)—, —O—S(═O)—, —O—S(═O)₂—), an oxo group (—O—) may be bonded to any one of R1 and the isocyanate group (—NCO). In other words, in the case of —O—C(□O)— as an example, the configuration of the isocyanate compound represented by Chemical Formula 5 may be R1-O—C(□O)—NCO or R1-C(□O)—O—NCO. The same holds true for —O—S(═O)— or —O—S(═O)₂—. However, the oxo group is more preferably bonded to R1, because R1 is easily available, and high chemical stability is obtained in the electrolytic solution.

The content of the isocyanate compound represented in each of Chemical Formula 5 and Chemical Formula 6 in the solvent may be arbitrarily set. However, the content of the isocyanate compound is preferably within a range of 0.01 wt % to 10 wt % both inclusive, because high chemical stability is obtained in the electrolytic solution, thereby superior cycle characteristics are obtained, and a high battery capacity is obtained. More specifically, when the content is smaller than 0.01 wt %, the chemical stability of the electrolytic solution may not be obtained sufficiently and stably, and when the content is larger than 10 wt %, the battery capacity may decline.

In the case where only one of the isocyanate compound represented by Chemical Formula 5 and the isocyanate compound represented by Chemical Formula 6 is used, the isocyanate compound represented by Chemical Formula 5 is preferable, because chemical stability of the electrolytic solution is further improved.

Specific examples of the isocyanate compound represented by Chemical Formula 5 include compounds represented by Chemical Formulas 7 to 15, because when the compounds represented by Chemical Formulas 7 to Chemical Formula 15 are used, high chemical stability is obtained in the electrolytic solution, and superior solubility is obtained. The kind of X is —C(═O)— in Chemical Formulas 7 and 8, —O—C(═O)— in Chemical Formula 9, —S(═O)— in Chemical Formulas 10 and 11, —O—S(═O)— in Chemical Formula 12, —S(□O)₂— in Chemical Formulas 13 and 14, and —O—S(═O)₂— in Chemical Formula 15. In Chemical Formulas 7 to 15, only the case where in X having an asymmetrical configuration (—O—C(═O)—, —O—S(═O)—, —O—S(═O)₂—), the oxo group is bonded to R1 such as a methyl group is illustrated. However, as described above, the oxo group may be bonded to the isocyanate group.

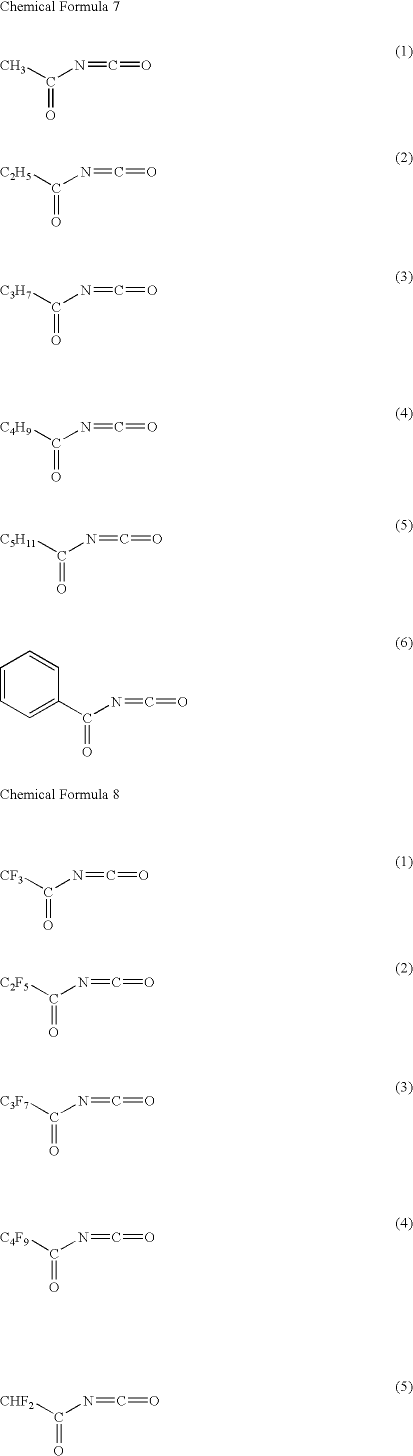

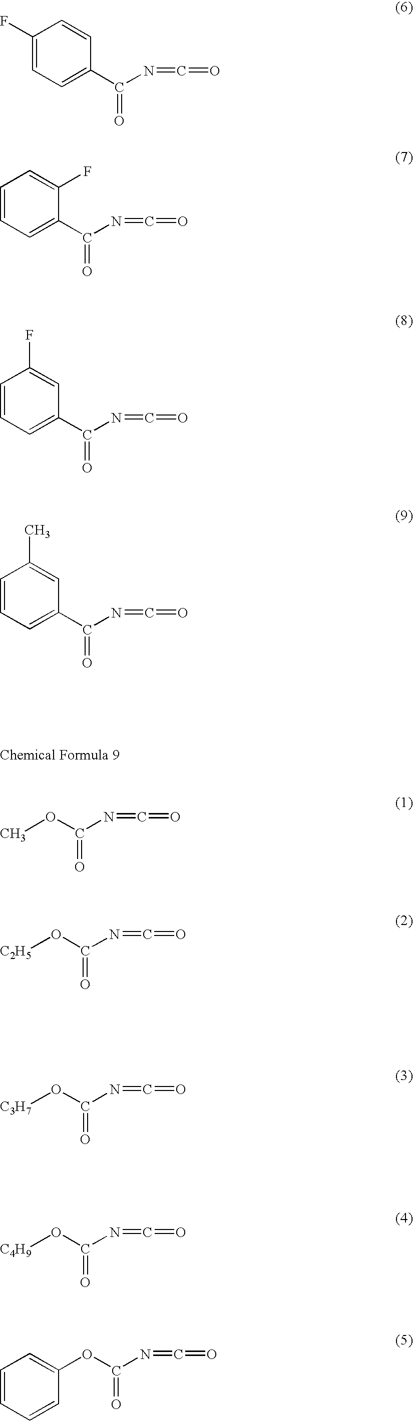

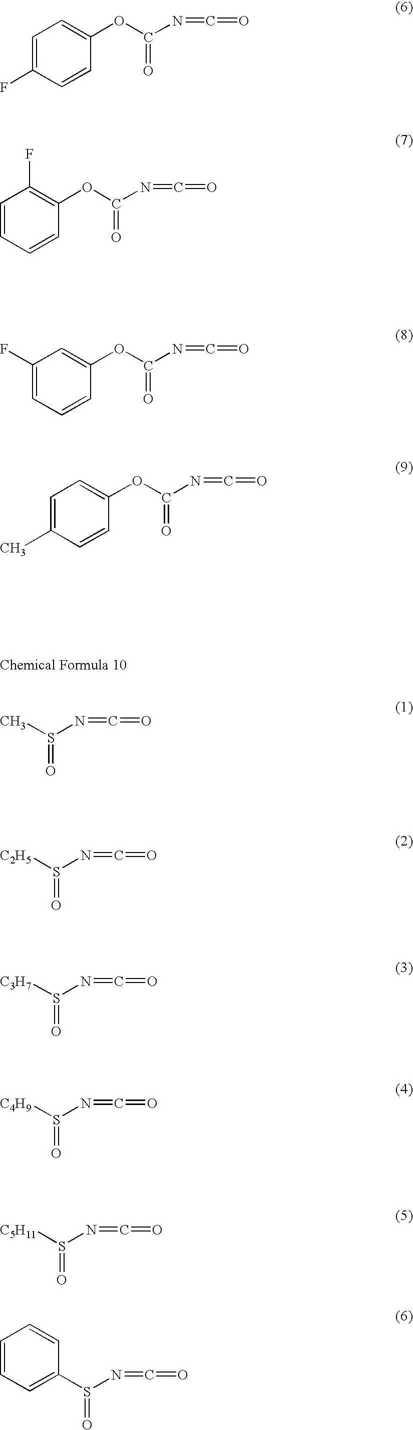

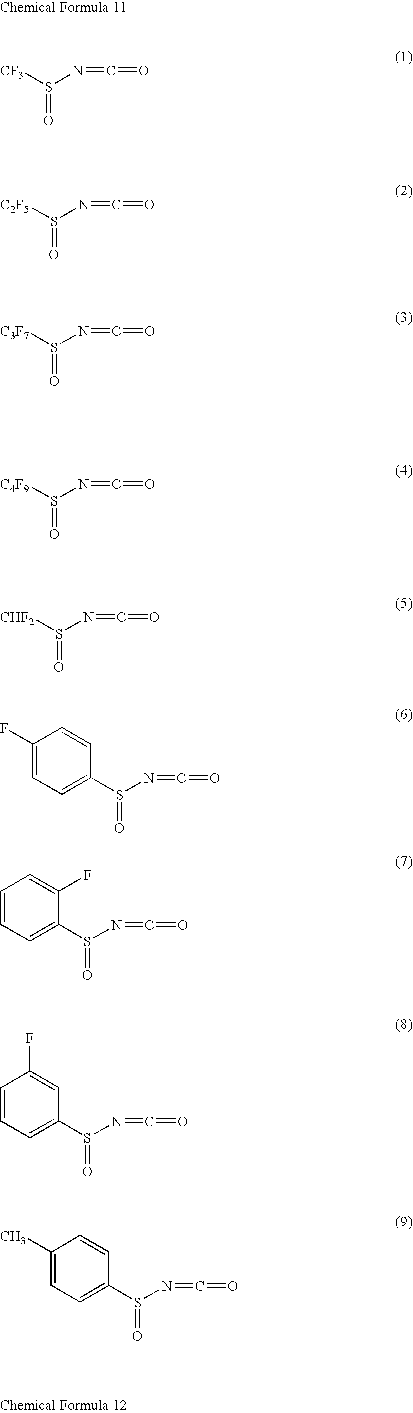

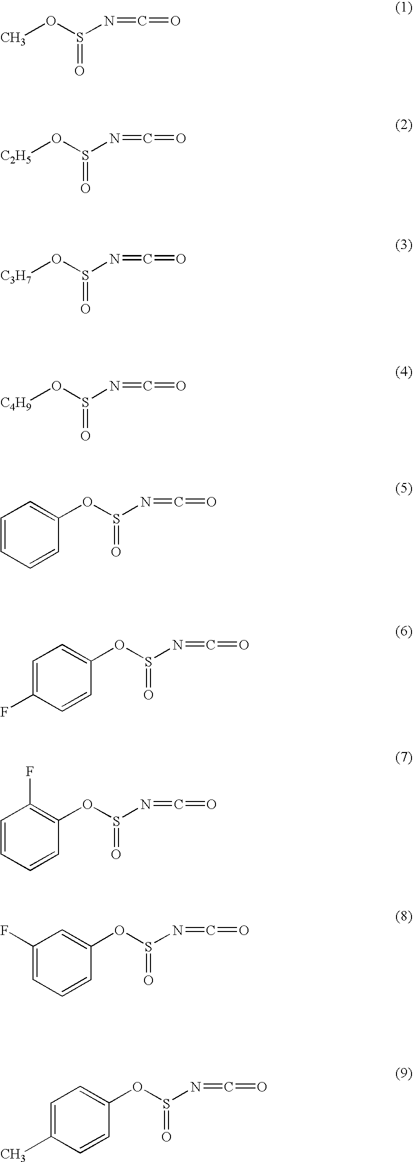

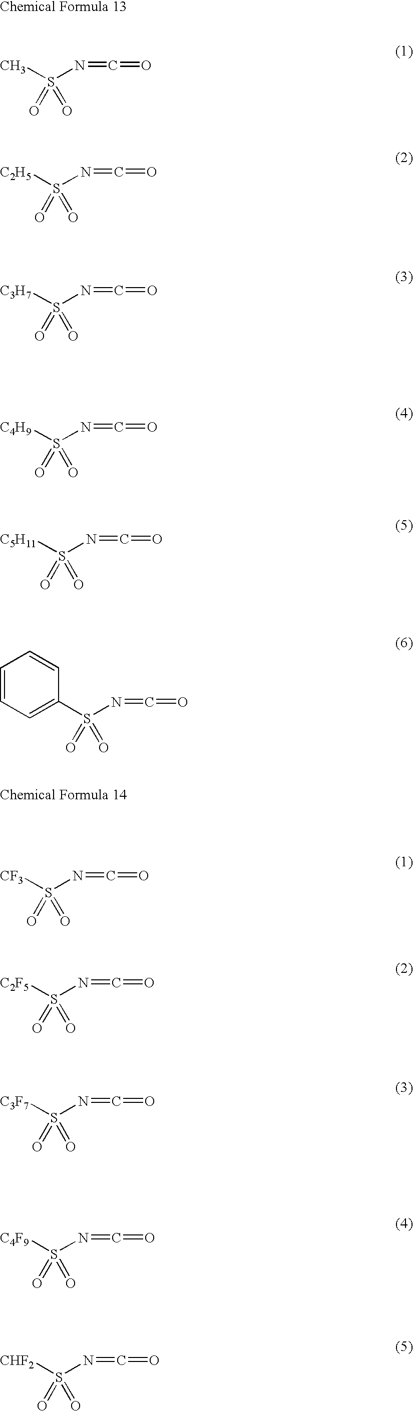

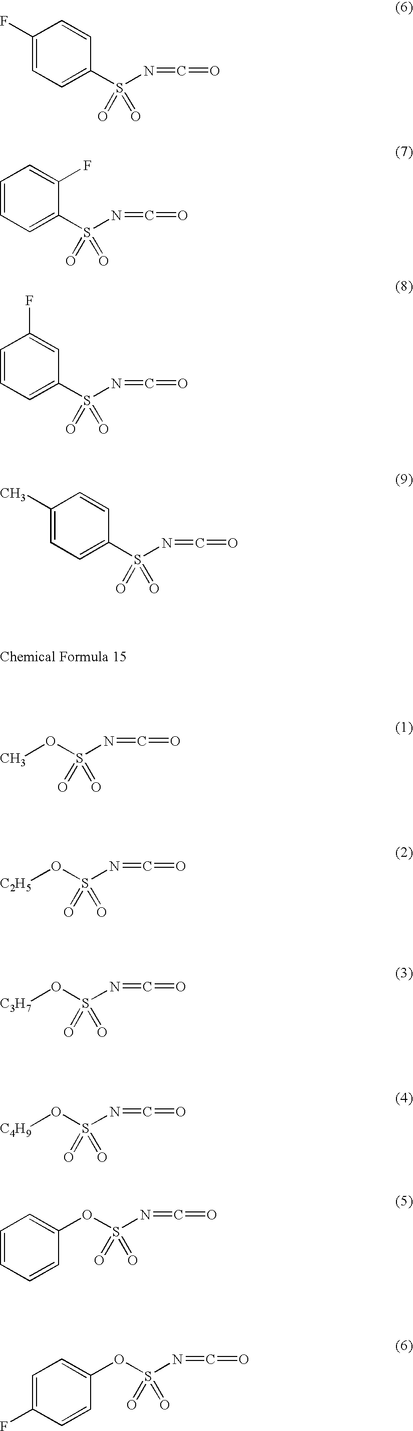

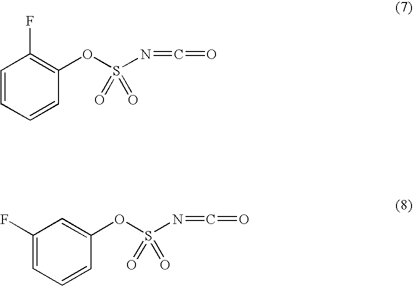

Specific examples of the isocyanate compound represented by Chemical Formula 6 include compounds represented by Chemical Formulas 16 and 17, because when the compounds represented by Chemical Formulas 16 and 17 are used, high chemical stability is obtained in the electrolytic solution, and superior solubility is obtained.

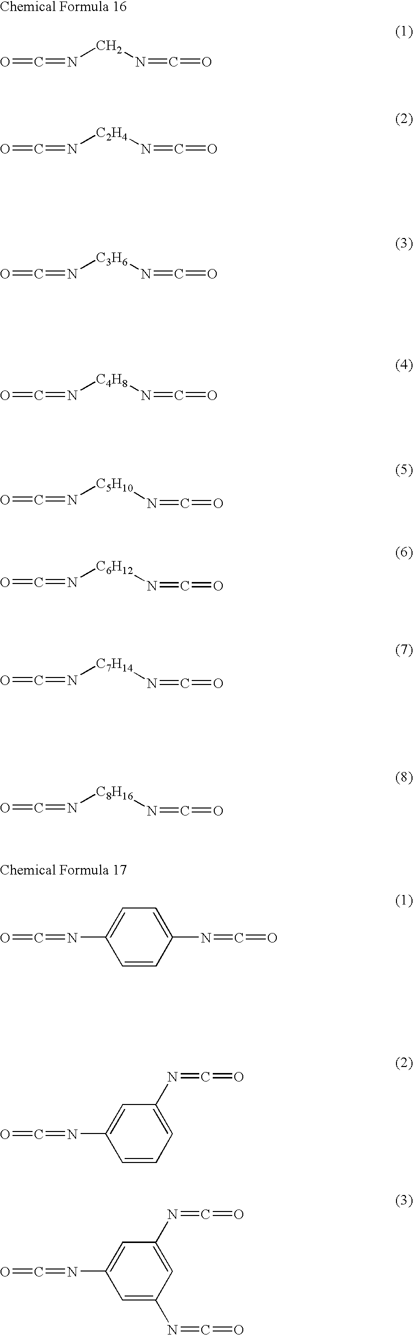

Only one kind or a mixture of a plurality of kinds selected from the compounds described as the isocyanate compounds represented by Chemical Formulas and 6 may be used. As long as the isocyanate compound represented by Chemical Formula 5 or Chemical Formula 6 has a configuration illustrated in Chemical Formula 5 or Chemical Formula 6, the isocyanate compound is not limited to the compounds represented by Chemical Formulas 7 to 17.

The solvent preferably includes one kind or two or more kinds of nonaqueous solvents such as other organic solvents in addition to the isocyanate compounds represented by Chemical Formulas 5 and 6. Examples of the nonaqueous solvents include ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, dimethyl sulfoxide and the like. Among them, at least one kind selected from the group consisting of ethylene carbonate, propylene carbonate, dimethyl carbonate, diethyl carbonate and ethyl methyl carbonate is preferable, and in particular a combination of a high-viscosity (high-permittivity) solvent (for example, relative permittivity ε≧30) such as ethylene carbonate or propylene carbonate and a low-viscosity solvent (for example, viscosity≦1 mPa·s) such as dimethyl carbonate, ethyl methyl carbonate or diethyl carbonate is more preferable, because the dissociation property of the electrolyte salt and ion mobility are improved.

Moreover, the solvent preferably includes at least one kind selected from the group consisting of a chain carbonate represented by Chemical Formula 18 which includes a halogen as a constituent element and a cyclic carbonate represented by Chemical Formula 19 which includes a halogen as a constituent element, because a stable protective film is formed on a surface of the anode 22, thereby decomposition reaction of the electrolyte is prevented.

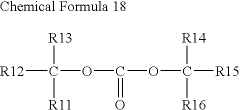

where R11, R12, R13, R14, R15 and R16 each represent a hydrogen group, a halogen group, an alkyl group or a halogenated alkyl group, and at least one of them is a halogen group or a halogenated alkyl group.

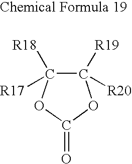

where R17, R18, R19 and R20 each represent a hydrogen group, a halogen group, an alkyl group or a halogenated alkyl group, and at least one of them is a halogen group or a halogenated alkyl group.

R11 to R16 in Chemical Formula 18 may be the same as or different from one another. The same holds true for R17 to R20 in Chemical Formula 19. The kind of halogen in the “halogenated alkyl group” describing R11 to R16 or R17 to R20 is not specifically limited. However, for example, at least one kind selected from the group consisting of fluorine, chlorine and bromine is used, and among them, fluorine is preferable, because a high effect is obtained. Any other halogen may be used.

The number of halogens is more preferably 2 than 1, and may be 3 or more, because an ability to form a protective film is improved, thereby a firmer and more stable protective film is formed, so decomposition reaction of the electrolytic solution is further prevented.

Examples of the chain carbonate represented by Chemical Formula 18 which includes a halogen include fluoromethyl methyl carbonate, bis(fluoromethyl) carbonate, difluoromethyl methyl carbonate and the like. Only one kind or a mixture of a plurality of kinds selected from them may be used. Among them, bis(fluoromethyl) carbonate is preferable, because a high effect is obtained

Examples of the cyclic carbonate represented by Chemical Formula 19 which includes a halogen include compounds represented by Chemical Formulas 20 and 21. More specifically, the compounds represented by Chemical Formula 20 include 4-fluoro-1,3-dioxolane-2-one in Chemical Formula 20(1), 4-chloro-1,3-dioxolane-2-one in Chemical Formula 20(2), 4,5-difluoro-1,3-dioxolane-2-one in Chemical Formula 20(3), tetrafluoro-1,3-dioxolane-2-one in Chemical Formula 20(4), 4-chloro-5-fluoro-1,3-dioxolane-2-one in Chemical Formula 20(5), 4,5-dichloro-1,3-dioxolane-2-one in Chemical Formula 20(6), tetrachloro-1,3-dioxolane-2-one in Chemical Formula 20(7), 4,5-bistrifluoromethyl-1,3-dioxolane-2-one in Chemical Formula 20(8), 4-trifluoromethyl-1,3-dioxolane-2-one in Chemical Formula 20(9), 4,5-difluoro-4,5-dimethyl-1,3-dioxolane-2-one in Chemical Formula 20(10), 4,4-difluoro-5-methyl-1,3-dioxolane-2-one in Chemical Formula 20(11), 4-ethyl-5,5-difluoro-1,3-dioxolane-2-one in Chemical Formula 20(12) and the like. Further, the compounds represented by Chemical Formula 21 include 4-fluoro-5-trifluoromethyl-1,3-dioxolane-2-one in Chemical Formula 21(1), 4-methyl-5-trifluoromethyl-1,3-dioxolane-2-one in Chemical Formula 21(2), 4-fluoro-4,5-dimethyl-1,3-dioxolane-2-one in Chemical Formula 21(3), 5-(1,1-difluoroethyl)-4,4-difluoro-1,3-dioxolane-2-one in Chemical Formula 21(4), 4,5-dichloro-4,5-dimethyl-1,3-dioxolane-2-one in Chemical Formula 21(5), 4-ethyl-5-fluoro-1,3-dioxolane-2-one in Chemical Formula 21(6), 4-ethyl-4,5-difluoro-1,3-dioxolane-2-one in Chemical Formula 21(7), 4-ethyl-4,5,5-trifluoro-1,3-dioxolane-2-one in Chemical Formula 21(8), 4-fluoro-4-methyl-1,3-dioxolane-2-one in Chemical Formula 21(9) and the like. Only one kind or a mixture of a plurality of kinds selected from them may be used.

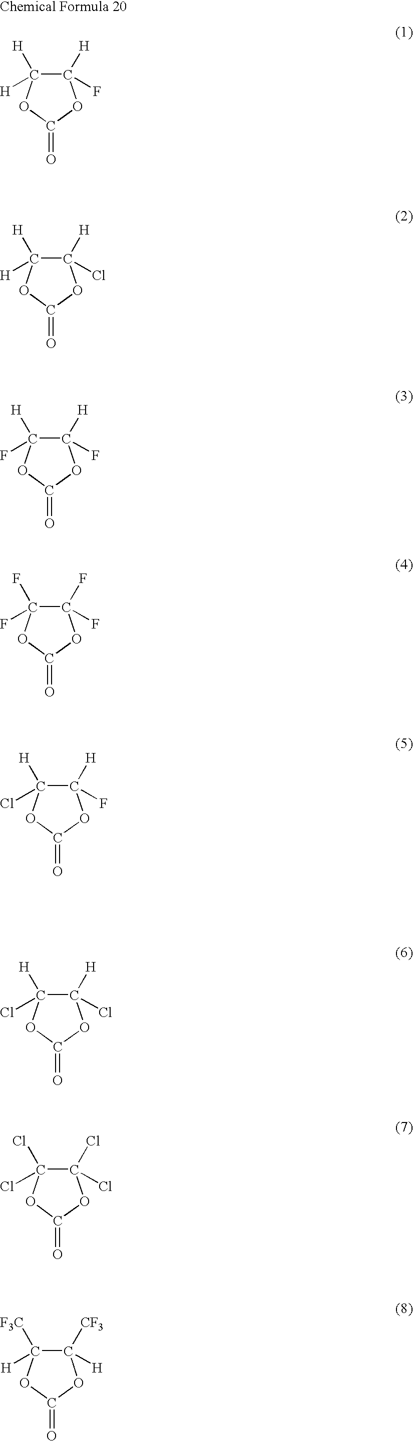

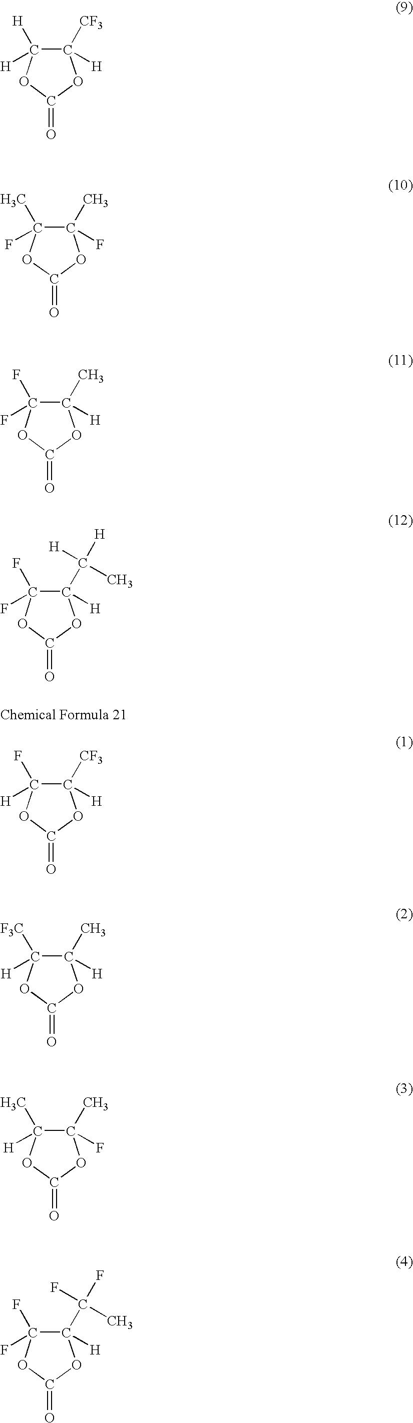

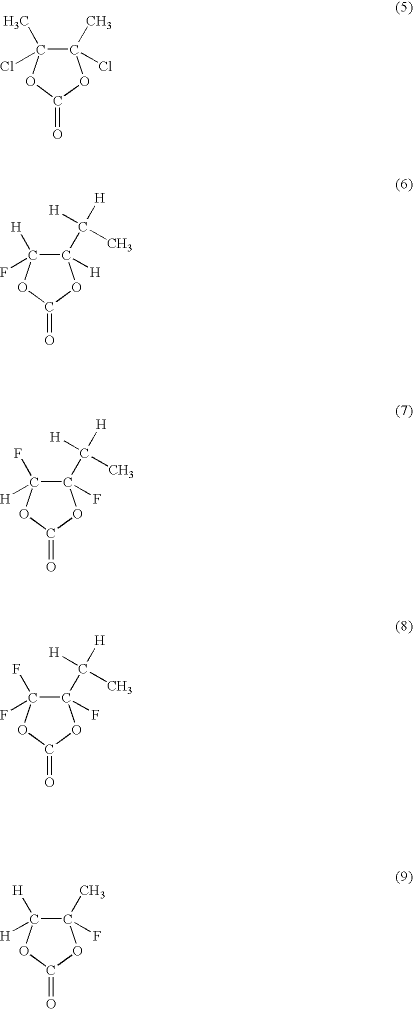

Among them, 4-fluoro-1,3-dioxolane-2-one or 4,5-difluoro-1,3-dioxolane-2-one is preferable, and 4,5-difluoro-1,3-dioxolane-2-one is more preferable. In particular, as 4,5-difluoro-1,3-dioxolane-2-one, a trans-isomer is more preferable than a cis-isomer, because it is easily available, and a high effect is obtained.

Moreover, the solvent preferably includes cyclic carbonates represented by Chemical Formulas 22 to 24 which have an unsaturated bond, because chemical stability of the electrolyte is further improved. Only one kind or a mixture of a plurality of kinds selected from them may be included.

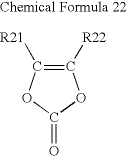

where R21 and R22 each are a hydrogen group or an alkyl group.

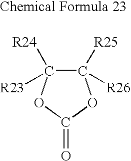

where R23, R24, R25 and R26 each are a hydrogen group, an alkyl group, a vinyl group or an allyl group, and at least one of them is a vinyl group or an allyl group.

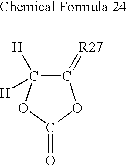

where R27 is an alkylene group.

The cyclic carbonate represented by Chemical Formula 22 which has an unsaturated carbon bond is a vinylene carbonate-based compound. Examples of the vinylene carbonate-based compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, 4-trifluoromethyl-1,3-dioxol-2-one and the like, and among them, vinylene carbonate is preferable, because vinylene carbonate is easily available, and a high effect is obtained.

The cyclic carbonate represented by Chemical Formula 23 which has an unsaturated carbon bond is a vinyl ethylene carbonate-based compound. Examples of the vinyl ethylene carbonate-based compound include vinyl ethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, 4,5-divinyl-1,3-dioxolane-2-one and the like, and among them, vinyl ethylene carbonate is preferable, because vinyl ethylene carbonate is easily available, and a high effect is obtained. All of R23 to R26 may be vinyl groups or allyl groups, or R23 to R26 may be a combination of vinyl groups and allyl groups.

The cyclic carbonate represented by Chemical Formula 24 which has an unsaturated carbon bond is a methylene ethylene carbonate-based compound. Examples of the methylene ethylene carbonate-based compound include 4-methylene-1,3-dioxolane-2-one, 4,4-dimethyl-5-methylene-1,3-dioxolane-2-one, 4,4-diethyl-5-methylene-1,3-dioxolane-2-one and the like. The methylene ethylene carbonate-based compound may be a compound including two methylene groups in addition to a compound including one methylene group (the compound represented by Chemical Formula 24).

As the cyclic carbonate having an unsaturated carbon bond, in addition to the cyclic carbonates represented by Chemical Formulas 22 to 24, catechol carbonate including a benzene ring, or the like may be used.

The electrolyte salt includes, for example, one kind or two or more kinds of light metal salts such as lithium salt. Examples of the lithium salt include lithium hexafluorophosphate, lithium tetrafluoroborate, lithium perchlorate, lithium hexafluoroarsenate and the like, because high battery capacity, cycle characteristics and storage characteristics are obtained. Among them, lithium hexafluorophosphate is preferable, because internal resistance is reduced, thereby a higher effect is obtained.

The electrolyte salt preferably includes at least one kind selected from the group consisting of compounds represented by Chemical Formulas 25 to 27, because in the case where they are used together with the above-described lithium hexafluorophosphate or the like, a higher effect is obtained. In addition, R31 and R33 in Chemical Formula 25 may be the same as or different from each other. The same holds true for R41 to R43 in Chemical Formula 26 and R51 and R52 in Chemical Formula 27.

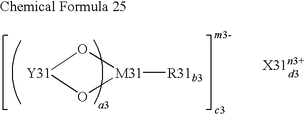

where X31 represents a Group 1 element or a Group 2 element in the long form of the periodic table of the elements, or aluminum, M31 represents a transition metal element, or a Group 13 element, a Group 14 element or a Group 15 element in the long form of the periodic table of the elements, R31 represents a halogen group, Y31 represents —(O═)C—R32-C(═O)—, —(O═)C—C(R33)₂— or —(O═)C—C(═O)—, in which R32 represents an alkylene group, a halogenated alkylene group, an arylene group or a halogenated arylene group, R33 represents an alkyl group, a halogenated alkyl group, an aryl group or a halogenated aryl group, a3 is an integer of 1 to 4 both inclusive, and b3 is 0, 2 or 4, and c3, d3, m3 and n3 each are an integer of 1 to 3 both inclusive.

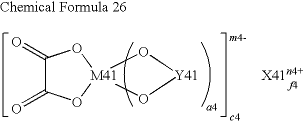

where X41 represents a Group 1 element or a Group 2 element in the long form of the periodic table of the elements, M41 represents a transition metal element, or a Group 13 element, a Group 14 element or a Group 15 element in the long form of the periodic table of the elements, Y41 represents —(O═)C—(C(R41)₂)_{b4}—C(═O)—, —(R43)₂C—(C(R42)₂)_{c4}—C(═O)—, —(R43)₂C—(C(R42)₂)_{c4}—C(R43)₂—, —(R43)₂C—(C(R42)₂)_{c4}—S(═O)₂—, —(O═)₂S—(C(R42)₂)_{d4}—S(═O)₂— or —(O═)C—(C(R42)₂)_{d4}—S(═O)₂—, in which R41 and R43 each represents a hydrogen group, an alkyl group, a halogen group or a halogenated alkyl group, and at least one of them is a halogen group or a halogenated alkyl group, R42 represents a hydrogen group, an alkyl group, a halogen group or a halogenated alkyl group, and a4, e4 and n4 each are 1 or 2, b4 and d4 each are an integer of 1 to 4 both inclusive, c4 is 0 or an integer of 1 to 4 both inclusive, and f4 and m4 each are an integer of 1 to 3 both inclusive.

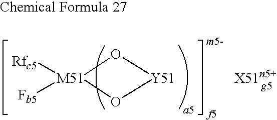

where X51 represents a Group 1 element or a Group 2 element in the long form of the periodic table of the elements, M51 represents a transition metal element, or a Group 13 element, a Group 14 element or a Group 15 element in the long form of the periodic table of the elements, Rf represents a fluorinated alkyl group having 1 to 10 carbon atoms or a fluorinated aryl group having 1 to 10 carbon atoms, Y51 represents —(O═)C—(C(R51)₂)_{d5}—C(═O)—, —(R52)₂C—(C(R51)₂)_{d5}—C(═O)—, —(R52)₂C—(C(R51)₂)_{d5}—C(R52)₂—, —(R52)₂C—(C(R51)₂)_{d5}—S(═O)₂—, —(O═)₂S—(C(R51)₂)ₑ₅—S(═O)₂— or —(O═)C—(C(R51)₂)ₑ₅—S(═O)₂—, in which R51 represents a hydrogen group, an alkyl group, a halogen group or a halogenated alkyl group, R52 represents a hydrogen group, an alkyl group, a halogen group or a halogenated alkyl group, and at least one of them is a halogen group or a halogenated alkyl group, and a5, f5 and n5 each are 1 or 2, b5, c5 and e5 each are an integer of 1 to 4 both inclusive, d5 is 0 or an integer of 1 to 4 both inclusive, and g5 and m5 each are an integer of 1 to 3 both inclusive.

In addition, the long form of the periodic table of the elements is represented by the revision of the nomenclature of inorganic chemistry recommended by IUPAC (The International Union of Pure and Applied Chemistry). More specifically, the Group 1 elements include hydrogen, lithium, sodium, potassium, rubidium, cesium and francium. Group 2 elements include beryllium, magnesium, calcium, strontium, barium and radium. Group 13 elements include boron, aluminum, gallium, indium and thallium. Group 14 elements include carbon, silicon, germanium, tin and lead. Group 15 elements include nitrogen, phosphorus, arsenic, antimony and bismuth.

Examples of the compound represented by Chemical Formula 25 include compounds represented by Chemical Formulas 28(1) to 28(6) and the like. Examples of the compound represented by Chemical Formula 26 include compounds represented by Chemical Formulas 29(1) to 29(8) and the like. Examples of the compound represented by Chemical Formula 27 include a compound represented by Chemical Formula 30 and the like. As long as the compound has a composition represented by any of Chemical Formulas 25 to 27, the compound is not limited to the compounds represented by Chemical Formulas 28 to 30.

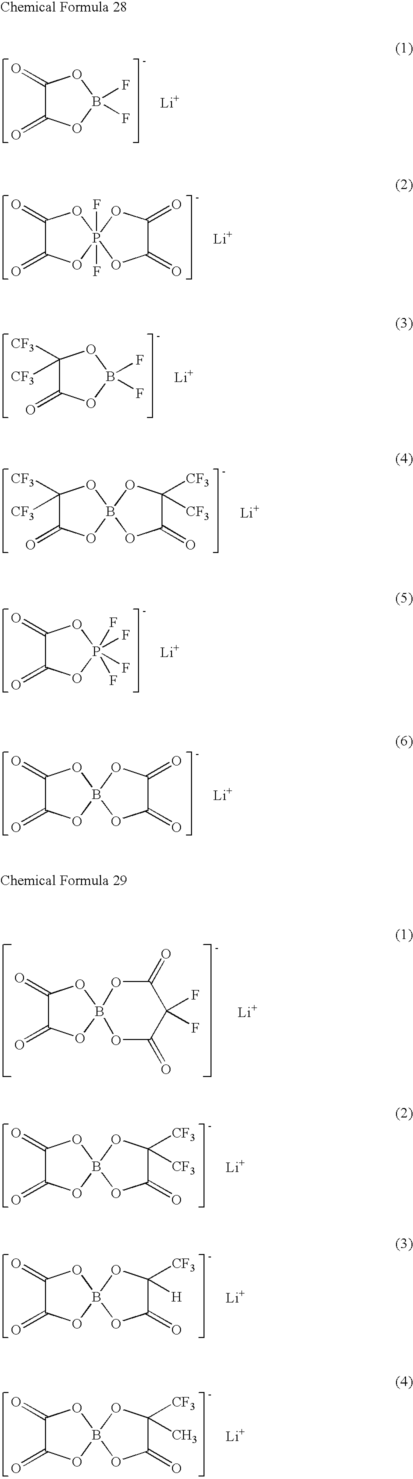

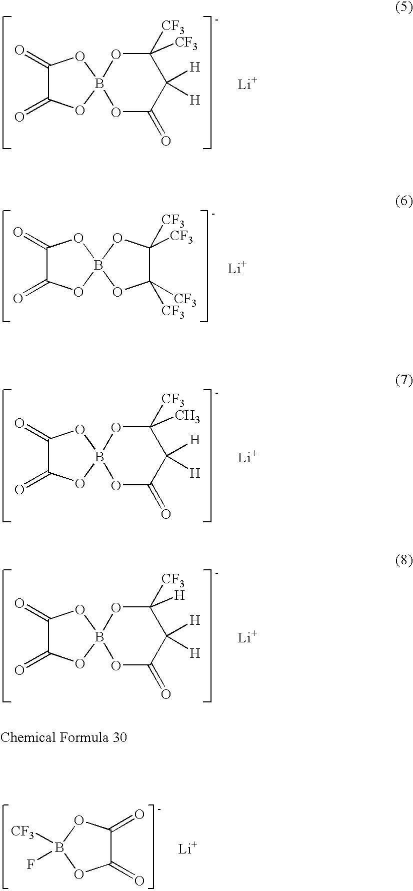

Moreover, the electrolyte salt preferably includes at least one kind selected from the group consisting of compounds represented by Chemical Formulas 31 to 33, because in the case where they are used with the above-described lithium hexafluorophosphate or the like, a higher effect is obtained. In addition, m and n in Chemical Formula 31 may be the same as or different from each other. The same holds true for p,q and r in Chemical Formula 33.

Chemical Formula 31

LiN(CₘF₂ₘ₊₁SO₂)(CₙF₂ₙ₊₁ SO₂)

where m and n each are an integer of 1 or more.

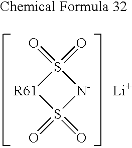

where R61 represents a straight-chain or branched perfluoroalkylene group having 2 to 4 carbon atoms.

Chemical Formula 33

LiC(CₚF₂ₚ₊₁SO₂)(C_{q}F_{2q+1}SO₂)(CᵣF₂ᵣ₊₁SO₂)

where p, q and r each are an integer of 1 or more.

Examples of the chain compound represented by Chemical Formula 31 include lithium bis(trifluoromethanesulfonyl)imide (LiN(CF₃SO₂)₂), lithium bis(pentafluoroethanesulfonyl)imide (LiN(C₂F₅SO₂)₂), lithium (trifluoromethanesulfonyl)(pentafluoroethanesulfonyl)imide (LiN(CF₃SO₂)(C₂F₅SO₂)), lithium (trifluoromethanesulfonyl)(heptafluoropropanesulfonyl)imide (LiN(CF₃SO₂)(C₃F₇SO₂)), lithium (trifluoromethanesulfonyl)(nonafluorobutanesulfonyl)imide (LiN(CF₃SO₂)(C₄F₉SO₂)) and the like. Only one kind or a mixture of a plurality of kinds selected from them may be used.

Examples of the cyclic compound represented by Chemical Formula 32 include compounds represented by Chemical Formula 34. More specifically, lithium 1,2-perfluoroethanedisulfonylimide in Chemical Formula 34(1), lithium 1,3-perfluoropropanedisulfonylimide in Chemical Formula 34(2), lithium 1,3-perfluorobutanedisulfonylimide in Chemical Formula 34(3), lithium 1,4-perfluorobutanedisulfonylimide in Chemical Formula 34(4) and the like are used. Only one kind or a mixture of a plurality of kinds selected from them may be used. Among them, lithium 1,2-perfluoroethanedisulfonylimide is preferable, because a high effect is obtained.

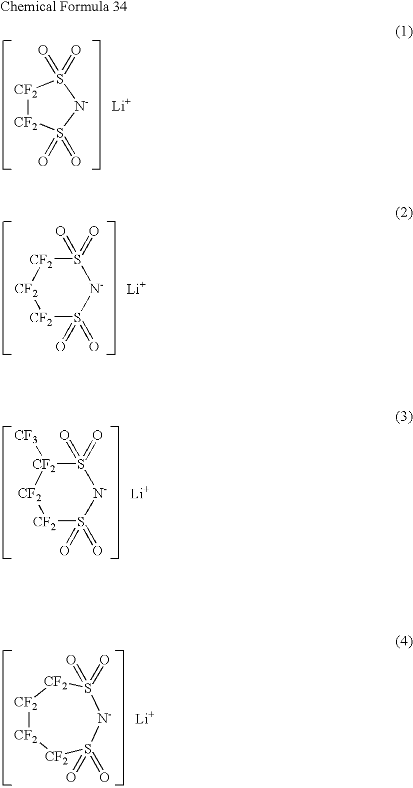

As the chain compound represented by Chemical Formula 34, for example, lithium tris(trifluoromethanesulfonyl)methide (LiC(CF₃SO₂)₃) or the like is used.

The content of the electrolyte salt is preferably within a range from 0.3 mol/kg to 3.0 mol/kg both inclusive relative to the solvent. It is because when the content of the electrolyte salt is out of the range, ionic conductivity may be extremely reduced.

The electrolytic solution may include various additives in addition to the solvent and the electrolyte salt, because the chemical stability of the electrolytic solution is further improved.

Examples of the additives include sultones (cyclic sulfonates). Examples of the sultones include propane sultone, propene sultone and the like, and among them, propene sultone is preferable. Only one kind or a mixture of a plurality of kinds selected from them may be used. The content of the sultone in the electrolytic solution is, for example, within a range from 0.5 wt % to 5 wt % both inclusive.

Moreover, examples of the additives include acid anhydrides. Examples of the acid anhydrides include a carboxylic anhydride such as succinic anhydride, glutaric anhydride, maleic anhydride, a disulfonic anhydride such as ethanedisulfonic anhydride or propanedisulfonic anhydride, an anhydride of a carboxylic acid and a sulfonic acid such as sulfobenzoic anhydride, sulfopropionic anhydride or sulfobutyric anhydride, and the like, and among them, succinic anhydride or sulfobenzoic anhydride is preferable. Only one kind or a mixture of a plurality of kinds selected from them may be used. The content of the acid anhydride in the electrolytic solution is, for example, within a range from 0.5 wt % to 5 wt % both inclusive.

The secondary battery is manufactured by the following steps, for example.

At first, the cathode 21 is formed. After the cathode active material, the cathode binder and the cathode conductor are mixed to form a cathode mixture, the cathode mixture is dispersed in an organic solvent to form paste-form cathode mixture slurry. Next, the cathode mixture slurry is uniformly applied to both surfaces of the cathode current collector 21A through the use of a doctor blade, a bar coater or the like, and the cathode mixture slurry is dried. Finally, the cathode mixture slurry is compression molded by a roller press or the like while applying heat, if necessary, thereby the cathode active material layer 21B is formed. In this case, compression molding may be repeated a plurality of times.

Next, the anode 22 is formed. First, the anode current collector 22A made of electrolytic copper foil or the like is prepared, and then the anode material is deposited on both surfaces of the anode current collector 22A by the vapor-phase method such as an evaporation method to form a plurality of anode active material particles including silicon as a constituent element. After that, an oxide-containing film is formed by a liquid-phase method such as the liquid-phase deposition method, or a metal material is formed by the liquid-phase method such as the electrolytic plating method, or both of them are formed, thereby the anode active material layer 22B is formed.

Next, a solvent is prepared by mixing at least one kind selected from the isocyanate compounds represented by Chemical Formulas 5 and 6, and any other organic solvent or the like, and then the electrolyte salt is dissolved in the solvent to prepare the electrolytic solution.

The secondary battery is assembled by the following steps. First, the cathode lead 25 is attached to the cathode current collector 21A by welding or the like, and the anode lead 26 is attached to the anode current collector 22A by welding or the like. Next, the cathode 21 and the anode 22 are laminated and wound with the separator 23 in between to form the spirally wound electrode body 20, and then the center pin 24 is inserted into the center of the spirally wound electrode body 20. Next, the spirally wound electrode body 20 sandwiched between the pair of insulating plates 12 and 13 is contained in the battery can 11, and an end of the cathode lead 25 is welded to the safety valve mechanism 15, and an end of the anode lead 26 is welded to the battery can 11. Then, the above-described electrolytic solution is injected into the battery can 11, and the separator 23 is impregnated with the electrolytic solution. Finally, the battery cover 14, the safety valve mechanism 15 and the PTC device 16 are fixed in an open end of the battery can 11 by caulking by the gasket 17. Thereby, the secondary battery illustrated in FIGS. 1 and 2 is completed.

When the secondary battery is charged, lithium ions are extracted from the cathode 21, and the lithium ions are inserted into the anode 22 through the electrolytic solution with which the separator 23 is impregnated. On the other hand, when the secondary battery is discharged, for example, lithium ions are extracted from the anode 22, and the lithium ions are inserted into the cathode 21 through the electrolytic solution with which the separator 23 is impregnated.

According to the cylindrical type secondary battery, the anode active material layer 22B of the anode 22 includes a plurality of anode active material particles including silicon, and at least one of the oxide-containing film with which the surfaces of the anode active material particles are coated and the metal material which is not alloyed with lithium and is arranged in gaps in the anode active material layer 22B is included. The solvent of the electrolytic solution includes at least one kind selected from the isocyanate compounds represented by Chemical Formulas 5 and 6. In this case, compared to the case where the anode active material layer does not include the oxide-containing film and the metal material, swelling and shrinkage of the anode active material layer 22B during charge and discharge is prevented, and decomposition reaction of the electrolytic solution is prevented. Moreover, compared to the case where the solvent of the electrolytic solution does not include the isocyanate compounds represented by Chemical Formulas 5 and 6, or the case where the solvent of the electrolytic solution include another isocyanate compound represented by Chemical Formula 35, the chemical stability of the electrolytic solution is improved, thereby decomposition of the electrolytic solution during charge and discharge is prevented. The isocyanate compound represented by Chemical Formula 35 is a monoisocyanate compound as in the case of the isocyanate compound represented by Chemical Formula 5. However, the isocyanate compound represented by Chemical Formula 35 does not include an electron-withdrawing group (X). Therefore, while the initial charge-discharge characteristics are secured, the cycle characteristics are improved.

Chemical Formula 35

CH₃—N═C═O

In particular, in the case where the anode 22 includes silicon which has an advantage in obtaining a higher capacity as an anode active material, the cycle characteristics are remarkably improved, so compared to the case where any other anode material such as the carbon material is included, a high effect is obtained.

In this case, when the content of the isocyanate compounds represented by Chemical Formulas 5 and 6 in the solvent is within a range from 0.01 wt % to 10 wt % both inclusive, superior cycle characteristics are obtained, and a high battery capacity is obtained.

Further, when the solvent of the electrolytic solution includes at least one kind selected from the group consisting of the chain carbonate represented by Chemical Formula 18 which includes a halogen and the cyclic carbonate represented by Chemical Formula 19 which includes a halogen, or at least one kind selected from the cyclic carbonates represented by Chemical Formulas 22 to 24 which have an unsaturated carbon bond, a higher effect is obtained. In particular, in the case where the solvent of the electrolytic solution includes at least one kind selected from the group consisting of the chain carbonate represented by Chemical Formula 18 which includes a halogen and the cyclic carbonate represented by Chemical Formula 19 which includes a halogen, the more the number of halogens is, the higher the effect is obtained.

The electrolyte salt of the electrolytic solution includes at least one kind selected from the group consisting of lithium hexafluorophosphate, lithium tetrafluoroborate, lithium perchlorate and lithium hexafluoroarsenate, or at least one kind selected from the group consisting of the compounds represented by Chemical Formulas 25 to 27, or at least one kind selected from the group consisting of the compounds represented by Chemical Formulas 31 to 33, a higher effect is obtained.

Further, when the electrolytic solution includes a sultone or an acid anhydride as an additive, a higher effect is obtained.

Next, another secondary battery according to the first embodiment will be described below.

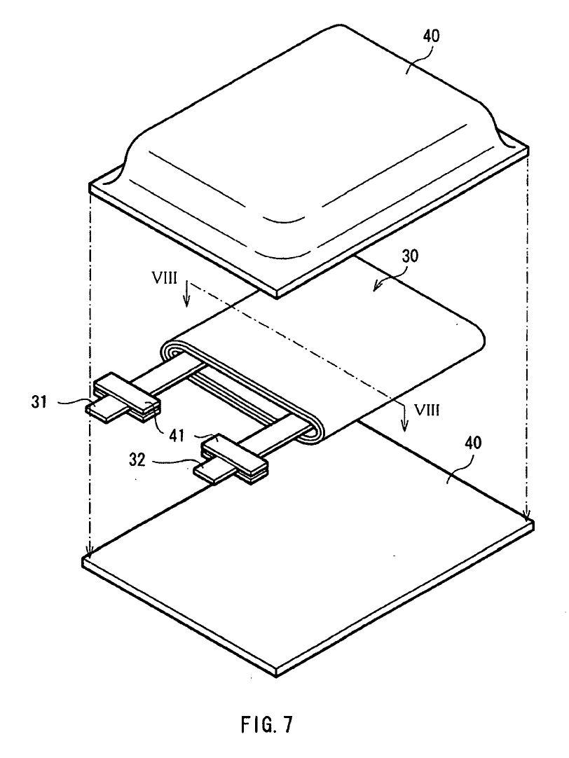

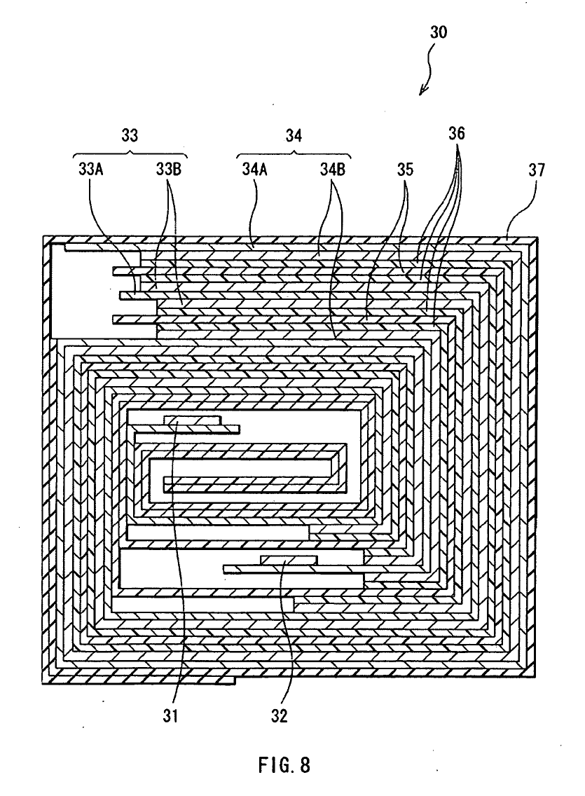

FIG. 7 illustrates an exploded perspective view of another secondary battery, and FIG. 8 illustrates an enlarged sectional view of a spirally wound electrode body 30 taken along a line VIII-VIII of FIG. 7.

The second secondary battery is, for example, a lithium-ion secondary battery as in the case of the above-described cylindrical type secondary battery. In the secondary battery, mainly the spirally wound electrode body 30 to which a cathode lead 31 and an anode lead 32 are attached is contained in film-shaped package members 40. The battery configuration using the film-shaped package members 40 is called a laminate film type.

The cathode lead 31 and the anode lead 32 are drawn, for example, from the interiors of the package members 40 to outside in the same direction. The cathode lead 31 is made of, for example, a metal material such as aluminum, and the anode lead 32 are made of, for example, a metal material such as copper, nickel or stainless. The metal materials of which the cathode lead 31 and the anode lead 32 are made each have a sheet shape or a mesh shape.

The package members 40 are made of, for example, an aluminum laminate film including a nylon film, aluminum foil and a polyethylene film which are bonded in this order. The package members 40 have a configuration in which edge portions of two rectangular aluminum laminate films are adhered to each other by fusion bonding or an adhesive so that the polyethylene film of each of the rectangular aluminum laminate films faces the spirally wound electrode body 30.

An adhesive film 41 is inserted between the package members 40 and the cathode lead 31 and the anode lead 32 for preventing the entry of outside air. The adhesive film 41 is made of, for example, a material having adhesion to the cathode lead 31 and the anode lead 32. Examples of such a material include polyolefin resins such as polyethylene, polypropylene, modified polyethylene and modified polypropylene.

In addition, the package members 40 may be made of a laminate film with any other configuration, a polymer film such as polypropylene or a metal film instead of the above-described three-layer aluminum laminate film.

The spirally wound electrode body 30 is formed by laminating and spirally winding the cathode 33 and the anode 34 with the separator 35 and an electrolyte layer 36 in between, and an outermost portion of the spirally wound electrode body 30 is protected with a protective tape 37.

The cathode 33 is formed by arranging a cathode active material layer 33B on both surfaces of a cathode current collector 33A. The anode 34 is formed by arranging an anode active material layer 34B on both surfaces of an anode current collector 34A, and the active material layer 34B is arranged so as to face the cathode active material layer 33B. The configurations of the cathode current collector 33A, the cathode active material layer 33B, the anode current collector 34A, the anode active material layer 34B and the separator 35 are the same as those of the cathode current collector 21A, the cathode active material layer 21B, the anode current collector 22A, the anode active material layer 22B and the separator 23, respectively, in the above-described secondary battery according to the first embodiment.

The electrolyte layer 36 includes an electrolytic solution, and a polymer compound holding the electrolytic solution, and is a so-called gel electrolyte. The gel electrolyte is preferable, because the gel electrolyte is capable of obtaining high ionic conductivity (for example, 1 mS/cm or over at room temperature), and liquid leakage from the battery is prevented.

The composition of the electrolytic solution is the same as that of the electrolytic solution in the above-described secondary battery according to the first embodiment.

Examples of the polymer compound include polyacrylonitrile, polyvinylidene fluoride, a copolymer of polyvinylidene fluoride and polyhexafluoropyrene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acids, polymethacrylic acids, styrene-butadiene rubber, nitrile-butadiene rubber, polystyrene, polycarbonate and the like. Only one kind or a mixture of a plurality of kinds selected from them may be used. Among them, polyacrylonitrile, polyvinylidene fluoride, polyhexafluoropropylene or polyethylene oxide is preferable, because they are electrochemically stable.

In the electrolyte layer 36 which is a gel electrolyte, the solvent of the electrolytic solution means a wide concept including not only a liquid solvent but also a solvent having ionic conductivity capable of dissociating the electrolyte salt. Therefore, in the case where a polymer compound having ionic conductivity is used, the polymer compound is included in the concept of the solvent.

Instead of the gel electrolyte layer 36 in which the polymer compound holds the electrolytic solution, the electrolytic solution may be used as it is, and the separator 35 may be impregnated with the electrolytic solution.

The secondary battery may be manufactured by the following three kinds of manufacturing methods, for example.

In a first manufacturing method, first, by the same steps as those in the above-described steps of forming the cathode 21 and the anode 22 in the secondary battery according to the first embodiment, the cathode active material layer 33B is formed on both surfaces of the cathode current collector 33A so as to form the cathode 33, and the anode active material layer 34B is formed on both surfaces of the anode current collector 34A so as to form the anode 34. Next, the gel electrolyte layer 36 is formed by preparing a precursor solution including the electrolytic solution, the polymer compound and the solvent, applying the precursor solution to the cathode 33 and the anode 34, and volatilizing the solvent. Next, the cathode lead 31 and the anode lead 32 are welded to the cathode current collector 33A and the anode current collector 34A, respectively. Then, after the cathode 33 on which the electrolyte layer 36 is formed and the anode 34 on which the electrolyte layer 36 is formed are laminated with the separator 35 in between to form a laminate, the laminate is spirally wound in a longitudinal direction, and the protective tape 37 is bonded to an outermost portion of the laminate so as to form the spirally wound electrode body 30. Finally, for example, the spirally wound electrode body 30 is sandwiched between two film-shaped package members 40, and edge portions of the package members 40 are adhered to each other by thermal fusion bonding or the like to seal the spirally wound electrode body 30 in the package members 40. In this case, the adhesive film 41 is inserted between the cathode lead 31 and the anode lead 32, and the package members 40. Thereby, the secondary battery illustrated in FIGS. 7 and 8 is completed.

In a second manufacturing method, first, after the cathode lead 31 and the anode lead 32 are attached to the cathode 33 and the anode 34, respectively, the cathode 33 and the anode 34 are laminated with the separator 35 in between to form a laminate, and the laminate is spirally wound, and the protective tape 37 is bonded to an outermost portion of the spirally wound laminate so as to form a spirally wound body as a precursor body of the spirally wound electrode body 30. Next, the spirally wound body is sandwiched between two film-shaped package members 40, and the edge portions of the package members 40 except for edge portions on one side are adhered by thermal fusion bonding or the like to form a pouched package, thereby the spirally wound body is contained in the package members 40. An electrolytic composition which includes the solvent, monomers as materials of a polymer compound and a polymerization initiator and, if necessary, any other material such as a polymerization inhibitor is prepared, and the composition is injected in the package members 40, and then an opened portion of the package members 40 are sealed by thermal fusion bonding or the like. Finally, the monomers are polymerized by applying heat to form the polymer compound, thereby the gel electrolyte layer 36 is formed. Thus, the secondary battery is completed.

In a third manufacturing method, as in the case of the second manufacturing method, the spirally wound body is formed, and the spirally wound body is contained in the package members 40, except that the separator 35 having both surfaces coated with a polymer compound is used. Examples of the polymer compound applied to the separator 35 include a polymer including vinylidene fluoride as a component, that is, a homopolymer, a copolymer, a multicomponent copolymer, and the like. More specifically, polyvinylidene fluoride, a binary copolymer including vinylidene fluoride and hexafluoropropylene as components, a ternary copolymer including vinylidene fluoride, hexafluoropropylene and chlorotrifluoroethylene as components is used. The polymer compound may include one kind or two or more kinds of other polymer compounds in addition to the above-described polymer including vinylidene fluoride as a component. Next, after the electrolytic solution is prepared, and injected into the package members 40, an opened portion of the package members 40 is sealed by thermal fusion bonding or the like. Finally, the package members 40 are heated while being weighted so that the separator 35 is brought into close contact with the cathode 33 and the anode 34 with the polymer compound in between. Thereby, the polymer compound is impregnated with the electrolytic solution, and the polymer compound is gelatinized so as to form the electrolyte layer 36, so the secondary battery is completed.

In the third manufacturing method, compared to the first manufacturing method, swelling of the secondary battery is prevented. Moreover, in the third manufacturing method, compared to the second manufacturing method, monomers as the materials of the polymer compound, the solvent and the like hardly remain in the electrolyte layer 36, and a step of forming the polymer compound is controlled well, so sufficient adhesion between the cathode 33 and anode 34, and the separator 35 and the electrolyte layer 36 is obtained.

In the laminate film type secondary battery, the anode 34 and the electrolytic solution have the same configuration and the same composition as those of the anode 22 and the electrolytic solution in the above-described cylindrical secondary battery, respectively, so the cycle characteristics are improved while securing initial charge-discharge characteristics. The effects of the laminate type secondary battery are the same as those in the cylindrical secondary battery.

### Second Embodiment

Next, a second embodiment will be described below.

An electrolytic solution according to the second embodiment is used in, for example, an electrochemical device such as a secondary battery, and includes a solvent and an electrolyte salt dissolved in the solvent.

The electrolytic solution has the same composition as that of the electrolytic solution described in the first embodiment, except that instead of the isocyanate compounds represented by Chemical Formulas 5 and 6, an isocyanate compound represented by Chemical Formula 36 is included, because the chemical stability of the electrolytic solution is improved. The isocyanate compound represented by Chemical Formula 36 includes a number z of sites where an isocyanate group and an electron-withdrawing group (a carbonyl group) are bonded, and has a configuration in which the number z of sites are bonded to R1.

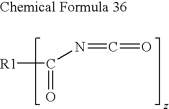

where R1 is a z-valent organic group, and z is an integer of 2 or more, and a carbon atom in a carbonyl group is bonded to a carbon atom in R1.

The “organic group” describing R1 in Chemical Formula 36 is a generic name for a group including a carbon chain or a carbon ring as a basic skeleton. As long as the “organic group” includes the carbon chain or the carbon ring as a basic skeleton, the organic group may have any configuration as a whole, and may include one kind or two or more kinds of other elements as constituent elements except for carbon. Examples of the “other elements” include hydrogen, oxygen, halogens and the like. The carbon chain may have a straight-chain form or a branched-chain form including one or two or more side chains.

The above-described “other elements” may be included in the “organic group” in any form. The “form” means the number of elements, or a combination of elements, and the form may be arbitrarily set. More specifically, examples of a form including hydrogen include a part of an alkylene group or an arylene group, and the like. Examples of a form including oxygen include an ether bond (—O—), and the like. Examples of a form including a halogen include a part of a halogenated alkylene group. The kind of the halogen is not specifically limited. However, among halogens, fluorine is preferable, because compared to other halogens, the chemical stability of the electrolytic solution is improved. The form including the above-described halogen is a form in which hydrogen in R1 is substituted with the halogen. In this case, only a part of hydrogen may be substituted with the halogen, or all hydrogen may be substituted with the halogen. The form including hydrogen, oxygen and a halogen may be any other form than the above-described form.

Carbon atoms in the number z of carbonyl groups are not bonded to atoms (for example, oxygen atoms) other than carbon atoms in R1, and are necessarily bonded to the carbon atoms.

R1 may be a derivative of a group configured of the above-described form. The “derivative” means a group formed by introducing one or two or more substituent groups into any of the above-described groups, and the kind of the substituent group is arbitrarily selected.

The isocyanate compound represented by Chemical Formula 36 is preferably a compound represented by Chemical Formula 37, because the number z (the number of sites where the isocyanate group and the carbonyl group are bonded) is reduced, so in the case where the isocyanate compound is mixed with any other solvent to be used in the electrolytic solution, superior compatibility is obtained, and as the isocyanate compound preferentially reacts (is decomposed) during electrode reaction, decomposition reaction of the other solvent or the like is prevented. The compound represented by Chemical Formula 37 is a compound in which R1 in Chemical Formula 36 is a divalent group, and z is z=2.

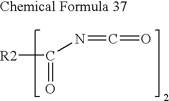

where R2 is a divalent organic group, and a carbon atom in a carbonyl group is bonded to a carbon atom in R2.

As long as R2 in Chemical Formula 37 is a divalent organic group, R2 may have any configuration as a whole as in the case of R1 in Chemical Formula 36. Examples of R2 as the divalent organic group include a straight-chain or branched alkylene group, an arylene group, a group in which an arylene group and an alkylene group are bonded, a group in which an alkylene group and an ether bond are bonded, a halogenated group thereof, and the like. The “divalent group including an arylene group and an alkylene group” may be a group in which one arylene group and one alkylene group are bonded, or a group in which two alkylene groups are bonded through one arylene group. The “group in which an alkylene group and an ether bond are bonded” means a group in which two alkylene groups are bonded through one ether bond. The “halogenated group thereof” means a group obtained by substituting a halogen for at least a part of hydrogen in the above-described alkylene group or the like. The above-described number or the bonding order of the alkylene groups, the arylene groups or the ether bonds may be arbitrarily set. R2 may be any group other than the above-described groups.

In the case where R2 is a branched alkylene group, the number of carbon atoms may be arbitrarily set. However, the number of carbon atoms is preferably within a range from 2 to 10 both inclusive, more preferably within a range from 2 to 6 both inclusive, and more preferably within a range from 2 to 4 both inclusive. Moreover, in the case where R2 is a group in which an arylene group and an alkylene group are bonded, a group in which two alkylene groups are bonded through one arylene group is preferable. The number of carbon atoms in this case may be arbitrarily set, but the number of carbon atoms is preferably 8, because in any of the cases, high chemical stability is obtained in the electrolytic solution, and superior compatibility is obtained.

In the case where R2 is a group in which an alkylene group and an ether bond are bonded, the number of carbon atoms may be arbitrarily set, but the number of carbon atoms is preferably within a range from 2 to 12 both inclusive, more preferably within a range from 4 to 12 both inclusive. In this case, in particular, R2 is preferably a group represented by —CH₂—CH₂—(O—CH₂—CH₂)ₙ—, and n is more preferably within a range from 1 to 3 both inclusive, because high chemical stability is obtained in the electrolytic solution, and superior compatibility is obtained.

Specific examples of R2 include straight-chain alkylene groups represented by Chemical Formulas 38(1) to 38(7), branched alkylene groups represented by Chemical Formulas 39(1) to 39(9), arylene groups represented by Chemical Formulas 40(1) to 40(3), groups in which an arylene group and an alkylene group are bonded represented by Chemical Formulas 41(1) to 41(3), and groups in which an alkylene group and an ether bond are bonded represented by Chemical Formulas 42(1) to 42(13), and the like. In addition, as groups obtained by halogenating the above-described groups, as illustrated in Chemical Formulas 43(1) to 43(9), groups obtained by halogenating groups in which an alkylene group and an ether bond are bonded are used. In addition to the groups in which an alkylene group and an ether bond are bonded, any other alkylene group or the like may be halogenated.

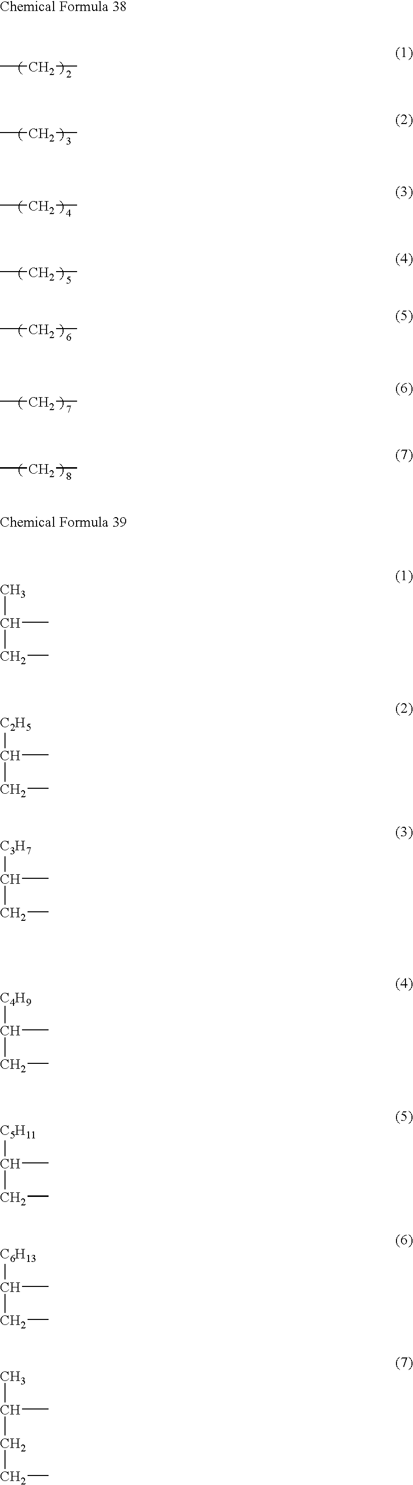

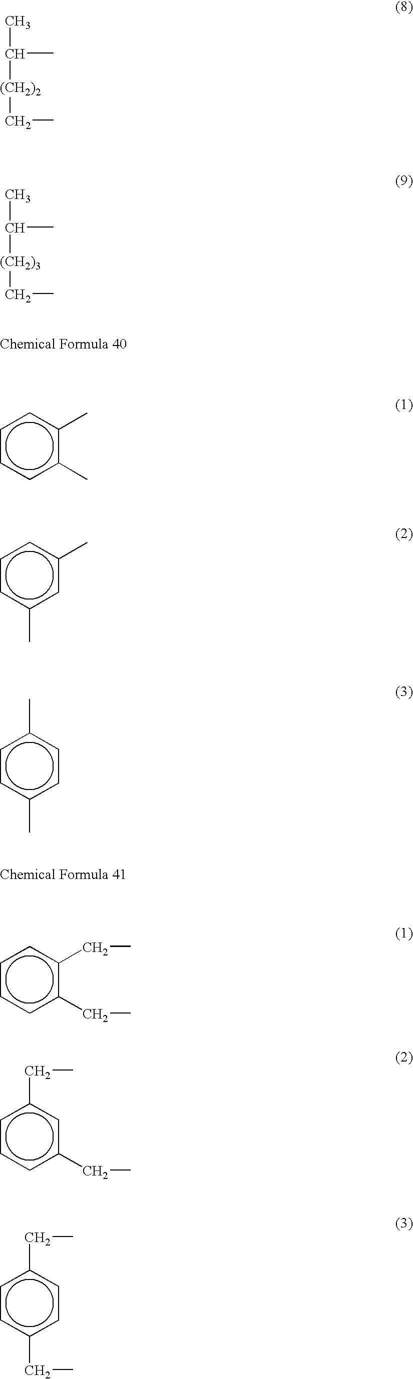

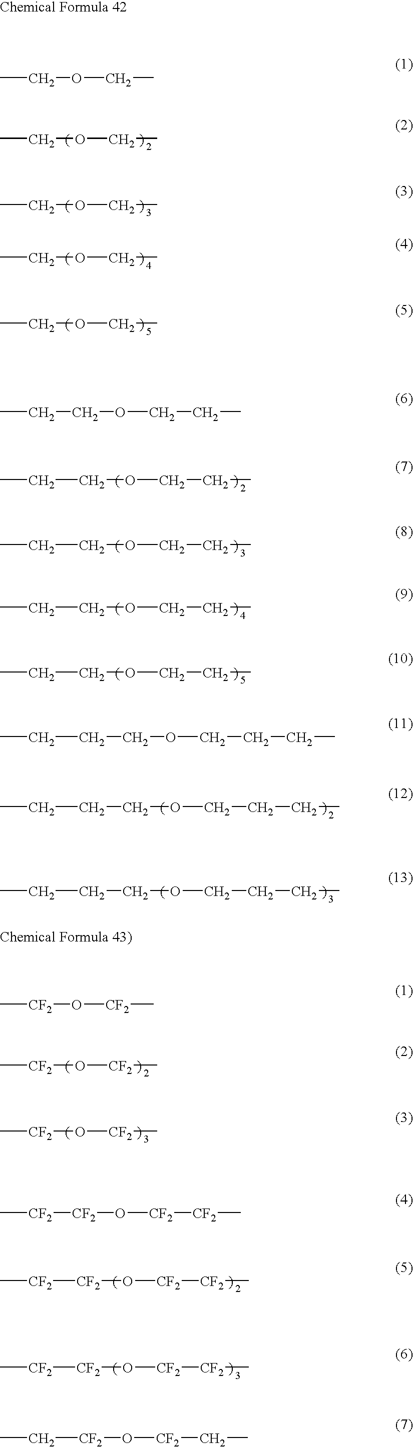

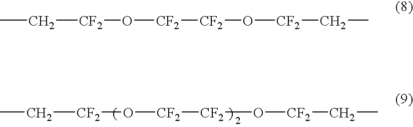

In particular, R2 is preferably a straight-chain alkylene group, because superior compatibility and reactivity are obtained. Among them, in the case where R2 is a straight-chain alkyl group, the number of carbon atoms is preferably 4 or less, and more preferably 3 or less, because superior compatibility and reactivity are stably obtained. Examples of such a preferable straight-chain alkyl group include an ethylene group having 2 carbon atoms (—C₂H₄—) and a propylene group having 3 carbon atoms (—C₃H₆—).

Specific examples of the compound represented by Chemical Formula 37 include compounds represented by Chemical Formulas 44(1) and 44(2), because they are easily available, and high chemical stability and superior solubility are obtained in the electrolytic solution.

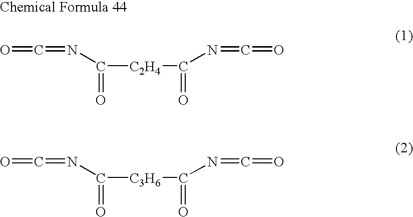

The content of the isocyanate compound represented by Chemical Formula 36 in the solvent is not specifically limited, but is preferably within a range of 0.01 wt % to 5 wt % both inclusive, because high chemical stability is obtained in the electrolytic solution. More specifically, when the content is smaller than 0.01 wt %, the chemical stability of the electrolytic solution may not be obtained sufficiently and stably, and when the content is larger than 5 wt %, major electrical performance of the electrochemical device (for example, the battery capacity or the like of the secondary battery) may decline.

Only one kind or a mixture of a plurality of kinds selected from the compounds described as the compound represented by Chemical Formula 36 may be used. As long as the compound has a configuration represented by Chemical Formula 36, the compound is not limited to the compounds represented by Chemical Formulas 37 and 44.

In the electrolytic solution, the solvent includes the isocyanate compound represented by Chemical Formula 36, so compared to the case where the solvent does not include the isocyanate compound, or the case where the solvent include another isocyanate compound represented by Chemical Formula 45, chemical stability is improved. The isocyanate compound represented by Chemical Formula 45 includes a plurality of isocyanate groups as in the case of the isocyanate compound represented by Chemical Formula 36, but the isocyanate compound represented by Chemical Formula 45 does not include a site where an isocyanate group and a carbonyl group are bonded. Therefore, decomposition reaction is prevented in the case where the electrolytic solution is used in the electrochemical device such as the secondary battery, so the electrolytic solution may contribute to an improvement in cycle characteristics and storage characteristics. In this case, when the isocyanate compound represented by Chemical Formula 36 is the compound represented by Chemical Formula 37, or when the content of the isocyanate compound represented by Chemical Formula 36 in the solvent is within a range of 0.01 wt % to 5 wt % both inclusive, a high effect is obtained.

Chemical Formula 45

O═C═N—C₂H₄—N═C═O

The electrolytic solution is applicable to the cylindrical type or the laminate film type secondary battery described in the first embodiment. In this case, as described above, the content of the isocyanate compound represented by Chemical Formula 36 is preferably within a range of 0.01 wt % to 5 wt % both inclusive, because irrespective of the kind of anode active material, decomposition reaction of the electrolytic solution is prevented, and a high battery capacity is obtained.

However, the content of the isocyanate compound represented by Chemical Formula 36 in the solvent may depend on the kind of the anode active material. For example, in the case where the anode active material is a carbon material, the above-described content preferably stays within a range of 0.01 wt % to 5 wt % both inclusive. On the other hand, in the case where the anode active material is silicon or the like (a material capable of inserting and extracting lithium ions, and including at least one kind selected from the group consisting of metal elements and metalloid elements), the above-described content is preferably within a range of 0.01 wt % to 10 wt % both inclusive.

In the secondary battery using the electrolytic solution, in the case where the capacity of the anode is represented on the basis of insertion and extraction of lithium ions, the above-described electrolytic solution is included, so the chemical stability of the electrolytic solution is improved. Thereby, decomposition reaction of the electrolytic solution is prevented, so cycle characteristics and storage characteristics are improved.

In particular, in the case where the anode includes silicon or the like (a material capable of inserting and extracting lithium ions and including at least one kind selected from the group consisting of metal elements and metalloid elements) which has an advantage in obtaining a higher capacity, the cycle characteristics and the storage characteristics are improved, so a higher effect than that in the case where another anode material such as a carbon material is used is obtained.

The electrolytic solution is applicable to the following other secondary battery in addition to the secondary batteries described in the first embodiment.

The other secondary battery described herein has the same configuration, functions and effects as those in the cylindrical type secondary battery described in the first embodiment, except that the anode 22 has a different configuration, and the secondary battery is manufactured by the same steps as those in the cylindrical type secondary battery described in the first embodiment.

As in the case of the first embodiment, the anode 22 is formed by arranging the anode active material layer 22B on both surfaces of the anode current collector 22A. As an anode active material, the anode active material layer 22B includes a material including silicon or tin as a constituent element. More specifically, examples of the anode active material include the simple substance, alloys and compounds of silicon, and the simple substance, alloys and compounds of tin, and the anode active material may include two or more kinds selected from them.

The anode active material layer 22B is formed by, for example, a vapor-phase method, a liquid-phase method, a spraying method, a firing method, or a combination of two or more methods selected from them, and the anode current collector 22A and the anode active material layer 22B are preferably alloyed in at least a part of an interface therebetween. More specifically, in the interface between them, a constituent element of the anode current collector 22A may be diffused into the anode active material layer 22B, or a constituent element of the anode active material layer 22B may be diffused into the anode current collector 22A, or they may be diffused into each other. It is because fracture due to swelling and shrinkage of the anode active material layer 22B during charge and discharge is prevented, and electronic conductivity between the anode current collector 22A and the anode active material layer 22B is improved.

As the vapor-phase method, for example, a physical deposition method or a chemical deposition method, more specifically, a vacuum deposition method, a sputtering method, an ion plating method, a laser ablation method, a thermal chemical vapor deposition (CVD) method, a plasma chemical vapor deposition method or the like is used. As the liquid-phase method, a known technique such as electrolytic plating or electroless plating may be used. The firing method is, for example, a method in which particulate anode active material is mixed with a binder or the like to form a mixture, and the mixture is dispersed in a solvent and is applied, and then the mixture is heated at a higher temperature than the melting point of the binder or the like. As the firing method, a known technique may be used, and, for example, an atmosphere firing method, a reaction firing method or a hot press firing method is used.

The other secondary battery may be a lithium metal secondary battery in which the capacity of the anode 22 is represented on the basis of deposition and dissolution of lithium metal. The secondary battery has the same configuration as that in the first embodiment, except that the anode active material layer 22B is made of lithium metal, and the secondary battery is manufactured by the same steps as those in the first embodiment.

The secondary battery uses lithium metal as the anode active material, thereby a high energy density is obtained. The anode active material layer 22B may exist at the time of assembling, or may not exist at the time of assembling, and may be made of lithium metal deposited during charge. Moreover, the anode active material layer 22B may be used also as a current collector, thereby the anode current collector 22A may be removed.

When the secondary battery is charged, lithium ions are extracted from the cathode 21, and the lithium ions are deposited on the surface of the anode current collector 22A as lithium metal through the electrolytic solution with which the separator 23 is impregnated. When the secondary battery is discharged, the lithium metal is dissolved from the anode active material layer 22B as lithium ions, and the lithium ions are inserted into the cathode 21 through the electrolytic solution with which the separator 23 is impregnated.

In the secondary battery, in the case where the capacity of the anode 22 is represented on the basis of deposition and dissolution of lithium metal, the above-described electrolytic solution is included, so the cycle characteristics and the storage characteristics are improved. Other effects relating to the secondary battery are the same as those in the first embodiment.

### EXAMPLES

Specific examples will be described in detail below.

### Example 1-1

A laminate film type secondary battery illustrated in FIGS. 7 and 8 was formed by the following steps. At that time, the secondary battery was a lithium-ion secondary battery in which the capacity of the anode 34 was represented on the basis of insertion and extraction of lithium.

First, the cathode 33 was formed. Lithium carbonate (Li₂CO₃) and cobalt carbonate (CoCO₃) were mixed at a molar ratio of 0.5:1 to form a mixture, and then the mixture was fired in air at 900° C. for 5 hours to obtain a lithium-cobalt complex oxide (LiCoO₂). Next, 91 parts by mass of the lithium-cobalt complex oxide as a cathode active material, 3 parts by mass of polyvinylidene fluoride as a cathode binder and 6 parts by mass of graphite as a cathode conductor were mixed to form a cathode mixture, and then the cathode mixture was dispersed in N-methyl-2-pyrrolidone to form paste-form cathode mixture slurry. Next, the cathode mixture slurry was uniformly applied to both surfaces of the cathode current collector 33A made of strip-shaped aluminum foil (with a thickness of 12 μm) by a bar coater, and was dried, and then the cathode mixture slurry was compression molded by a roller press to form the cathode active material layer 33B.

Next, the anode 34 was formed. After the anode current collector 34A (with a thickness of 22 μm) made of electrolytic copper foil with a roughened surface was prepared, silicon was deposited on both surfaces of the anode current collector 34A as the anode active material by the electron beam evaporation method to form a plurality of anode active material particles. In the case where the anode active material particles were formed, the anode active material particles had a 10-layer configuration by performing the deposition step 10 times. Moreover, the thickness (the total thickness) of the anode active material particles on one surface of the anode current collector 34A was 6 μm. Next, an oxide of silicon (SiO₂) was deposited on surfaces of the anode active material particles by the liquid-phase deposition method to form the oxide-containing film. To form the oxide-containing film, the anode current collector 34A on which the anode active material particles were formed was immersed for 3 hours in a solution formed by dissolving boron as an anion trapping agent in a hexafluorosilicic acid to deposit an oxide of silicon on the surfaces of the anode active material particles, and then the anode current collector 34A was cleaned, and dried under reduced pressure. Finally, a cobalt (Co)-plating film was grown by the electrolytic plating method on the anode current collector 34A on which the plurality of anode active material particles and the oxide-containing film were formed to form a metal material, thereby the anode active material layer 34B was formed. To form the metal material, cobalt was deposited on both surfaces of the anode current collector 34A by conduction while air is supplied to a plating bath. At that time, a cobalt plating solution available from Japan Pure Chemical Co., Ltd. was used as a plating solution, and the current density was 2 A/dm² to 5 A/dm², and the plating rate was 10 nm/s.

Next, the electrolytic solution was prepared. First, ethylene carbonate (EC), diethyl carbonate (DEC) and the compound represented by Chemical Formula 9(2) as the isocyanate compound represented by Chemical Formula 5 were mixed to prepare a solvent. At that time, the composition of the solvent (EC:DEC) was 30:70 at a weight ratio, and the content of the compound represented by Chemical Formula 9(2) was 0.01 wt %. The content (wt %) of the compound represented by Chemical Formula 9(2) was a ratio in the case where the whole solvent (EC+DEC+the compound represented by Chemical Formula 9(2)) was 100 wt %. After that, lithium hexafluorophosphate (LiPF₆) as the electrolyte salt was dissolved in the solvent. At that time, the content of lithium hexafluorophosphate in the solvent was 1 mol/kg.

Finally, the secondary battery was assembled using the electrolytic solution as well as the cathode 33 and the anode 34. First, the cathode lead 31 made of aluminum was welded to an end of the cathode current collector 33A, and the anode lead 32 made of nickel was welded to an end of the anode current collector 34A. Next, after the cathode 33, the separator 35 (with a thickness of 25 μm) made of a microporous polypropylene film and the anode 34 were laminated in this order to form a laminate, and then the laminate was spirally wound several times in a longitudinal direction, an outermost portion of the spirally wound laminate was fixed by the protective tape 37 made of an adhesive tape so as to form a spirally wound body as a precursor body of the spirally wound electrode body 30. Next, after the spirally wound body was sandwiched between the package members 40 made of a laminate film (with a total thickness of 100 μm) with a three-layer configuration formed by laminating a nylon film (with a thickness of 30 μm), aluminum foil (with a thickness of 40 μm) and a cast polypropylene film (with a thickness of 30 μm) in order from outside, the edge portions of the package members 40 except for edge portions on one side were adhered by thermal fusion bonding to form a pouched package, thereby the spirally wound body was contained in the package members 40. Next, the electrolytic solution was injected into the package members 40 from an opened portion of the package members 40, and the separator 35 was impregnated with the electrolytic solution, thereby the spirally wound electrode body 30 was formed. Finally, the opened portion of the package members 40 were sealed by thermal fusion bonding in a vacuum atmosphere, thereby the laminate film type secondary battery was completed. In the secondary battery, lithium metal was not deposited on the anode 34 in a fully-charged state by adjusting the thickness of the cathode active material layer 33B.

### Examples 1-2 to 1-6

Secondary batteries were formed by the same steps as those in Example 1-1, except that the content of the compound represented by Chemical Formula 9(2) was 1 wt % (Example 1-2), 3 wt % (Example 1-3), 5 wt % (Example 1-4), 10 wt % (Example 1-5) and 12 wt % (Example 1-6).

### Comparative Example 1-1

A secondary battery was formed by the same steps as those in Example 1-1, except that the oxide-containing film and the metal material were not formed, and the compound represented by Chemical Formula 9(2) was not used.

### Comparative Example 1-2

A secondary battery was formed by the same steps as those in Example 1-1, except that the compound represented by Chemical Formula 9(2) was not used.

### Comparative Example 1-3

A secondary battery was formed by the same steps as those in Example 1-1, except that the oxide-containing film and the metal material were not formed.

### Comparative Example 1-4

A secondary battery was formed by the same steps as those in Example 1-1, except that instead of the compound represented by Chemical Formula 9(2), the compound represented by Chemical Formula 35 was used.

The cycle characteristics and the initial charge-discharge characteristics of the secondary batteries of Examples 1-1 to 1-6 and Comparative Examples 1-1 to 1-4 were determined, results illustrated in Table 1 were obtained.

To determine the cycle characteristics, two cycles of charge and discharge were performed on each of the secondary batteries in an atmosphere at 23° C. to determine the discharge capacity in the second cycle, and then the cycle of charge and discharge was repeated until the total cycle number reached 100 cycles in the same atmosphere to determine the discharge capacity in the 100th cycle. Then, a discharge capacity retention ratio (%)=(discharge capacity in the 100th cycle/discharge capacity in the second cycle)×100 was determined by calculation. As the conditions of one cycle of charge and discharge, each of the secondary batteries was charged at a constant current of 0.2 C and a constant voltage until reaching an upper limit voltage of 4.2 V, and then each of the secondary batteries was discharged at a constant current of 0.2 C until reaching a cutoff voltage of 2.7 V. In addition “0.2 C” represents a current value at which the theoretical capacity of a battery is fully discharged for 5 hours.

To determine the initial charge-discharge characteristics, two cycles of charge and discharge were performed on each of the secondary batteries in an atmosphere at 23° C., and each of the secondary batteries was charged, and then the charge capacity of each of the secondary batteries was determined. Next, each of the secondary batteries was discharged in the same atmosphere, and then the discharge capacity of each of the secondary batteries was determined. Then, initial charge-discharge efficiency (%)=(discharge capacity/charge capacity)×100 was determined by calculation. The conditions of one cycle of charge and discharge were the same as those in the case where the cycle characteristics were determined.

The steps and conditions for determining the above-described cycle characteristics and the above-described initial charge-discharge characteristics in the following examples and the following comparative examples were the same as those described above.

TABLE 1
Anode active material: silicon (electron beam evaporation method)

| | | | ELECTROLYTIC SOLUTION | | | | DISCHARGE | INITIAL |
|---|---|---|---|---|---|---|---|---|
| | ANODE | | | SOLVENT | | | CAPACITY | CHARGE- |
| | OXIDE- | | | | ISOCYANATE | | RETENTION | DISCHARGE |
| | CONTAINING | METAL | ELECTROLYTE | | COMPOUND | | RATIO | EFFICIENCY |
| | FILM | MATERIAL | SALT | KIND | KIND | WT % | (%) | (%) |
| EXAMPLE 1-1 | SiO₂ | Co | LiPF₆ | EC + | CHEMICAL | 0.01 | 78 | 87.5 |
| EXAMPLE 1-2 | | | 1 mol/kg | DEC | FORMULA | 1 | 81 | 86.5 |
| EXAMPLE 1-3 | | | | | 9(2) | 3 | 84 | 86.4 |
| EXAMPLE 1-4 | | | | | | 5 | 87 | 85.5 |
| EXAMPLE 1-5 | | | | | | 10 | 87 | 84.5 |
| EXAMPLE 1-6 | | | | | | 12 | 83 | 83.8 |
| COMPARATIVE | — | — | LiPF₆ | EC + | — | — | 40 | 88.0 |
| EXAMPLE 1-1 | | | 1 mol/kg | DEC | | | | |
| COMPARATIVE | SiO₂ | Co | | | — | — | 75 | 88.5 |
| EXAMPLE 1-2 | | | | | | | | |
| COMPARATIVE | — | — | | | CHEMICAL | 3 | 58 | 77.0 |
| EXAMPLE 1-3 | | | | | FORMULA | | | |
| | | | | | 9(2) | | | |
| COMPARATIVE | — | — | | | CHEMICAL | 3 | 25 | 82.0 |
| EXAMPLE 1-4 | | | | | FORMULA 35 | | | |

As illustrated in Table 1, in Examples 1-1 to 1-6 in which the anode active material layer 34B of the anode 34 included the oxide-containing film (SiO₂) and the metal material (Co), and the solvent of the electrolytic solution included the compound represented by Chemical Formula 9(2), independent of the content of the compound represented by Chemical Formula 9(2), the initial charge-discharge efficiency was substantially equal to or higher than that in Comparative Examples 1-1 to 1-4, and the discharge capacity retention ratio was higher than that in Comparative Examples 1-1 to 1-4.

More specifically, in Comparative Example 1-2 in which the oxide-containing film and the metal material were included, but the compound represented by Chemical Formula 9(2) was not included, compared to Comparative Example 1-1 in which the oxide-containing film and the metal material as well as the compound represented by Chemical Formula 9(2) were not included, high initial charge-discharge efficiency of 80% or over was obtained, and the discharge capacity retention ratio was much higher. This result indicated that the oxide-containing film and the metal material contributed to an increase in the discharge capacity retention ratio without reducing the initial charge-discharge efficiency. However, the discharge capacity retention ratio obtained in Comparative Example 1-2 was not sufficient, so it was difficult to sufficiently increase the discharge capacity retention ratio by using only the oxide-containing film and the metal material.

In Comparative Example 1-3 in which the oxide-containing film and the metal material were not included, but the compound represented by Chemical Formula 9(2) was included, compared to Comparative Example 1-1, the discharge capacity retention ratio was slightly higher, but the initial charge-discharge efficiency was smaller than 80%. This result indicated that while the compound represented by Chemical Formula 9(2) increased the discharge capacity retention ratio, the compound represented by Chemical Formula 9(2) caused a decline in the initial charge-discharge efficiency.

Moreover, in Comparative Example 1-4 in which the oxide-containing film and the metal material were not included, but the compound represented by Chemical Formula 35 was included, compared to Comparative Example 1-1, high initial charge-discharge efficiency of 80% or over was obtained, but the discharge capacity retention ratio was smaller. This result indicated that even though the compound represented by Chemical Formula 35 was the same monoisocyanate compound as the compound represented by Chemical Formula 9(2), the compound represented by Chemical Formula 35 caused a decline in the discharge capacity retention ratio.

On the other hand, in Examples 1-1 to 1-6 in which the oxide-containing film and the metal material as well as the compound represented by Chemical Formula 9(2) were included, unlike Comparative Examples 1-1 to 1-4, initial charge-discharge efficiency of 80% or over was obtained, and a high discharge capacity retention ratio of approximately 80% or over was obtained. This result indicated that when the oxide-containing film, the metal material and the compound represented by Chemical Formula 9(2) were used together, while a decline in the initial charge-discharge efficiency was prevented, the discharge capacity retention ratio was remarkably increased.

In particular, in Examples 1-1 to 1-6, there was a tendency that with an increase in the content of the compound represented by Chemical Formula 9(2), the discharge capacity retention ratio was increased, then decreased, and the initial charge-discharge efficiency was decreased little by little. In this case, when the content of the compound represented by Chemical Formula 9(2) was 0.01 wt % or over, a high discharge capacity retention ratio to an extent which sufficiently differentiated from Comparative Examples 1-1 to 1-4 was obtained, and when the content was 10 wt % or less, a high discharge capacity retention ratio was obtained, and a decline in the battery capacity was prevented.

Therefore, it was confirmed that in the secondary battery according to the embodiments, when the anode active material layer 34B of the anode 34 included the oxide-containing film and the metal material, and the solvent of the electrolytic solution included the compound represented by Chemical Formula 9(2), while the initial charge-discharge characteristics were secured, the cycle characteristics were improved. In this case, it was confirmed that when the content of the compound represented by Chemical Formula 9(2) in the solvent was 0.01 wt % to 10 wt % both inclusive, a high battery capacity was obtained.

### Examples 2-1 to 2-8

Secondary batteries were formed by the same steps as those in Example 1-3, except that as the isocyanate compound represented by Chemical Formula 5, instead of the compound represented by Chemical Formula 9(2), the compound represented by Chemical Formula 7(1) (Example 2-1), the compound represented by Chemical Formula 7(2) (Example 2-2), the compound represented by Chemical Formula 7(6) (Example 2-3), the compound represented by Chemical Formula 9(1) (Example 2-4), the compound represented by Chemical Formula 13(2) (Example 2-5), the compound represented by Chemical Formula 13(6) (Example 2-6), the compound represented by Chemical Formula 14(6) (Example 2-7), or the compound represented by Chemical Formula 14(9) (Example 2-8) was used.

### Example 2-9

A secondary battery was formed by the same steps as those in Example 1-3, except that instead of the isocyanate compound represented by Chemical Formula 5, the compound represented by Chemical Formula 16(4) as the isocyanate compound represented by Chemical Formula 6 was used.

When the cycle characteristics and the initial charge-discharge characteristics of the secondary batteries of Examples 2-1 to 2-9 were determined, results illustrated in Table 2 were obtained.

TABLE 2
Anode active material: silicon (electron beam evaporation method)

| | | | ELECTROLYTIC SOLUTION | | | | | |
|---|---|---|---|---|---|---|---|---|
| | | | | SOLVENT | | | DISCHARGE | INITIAL |
| | ANODE | | | | ISOCYANATE | | CAPACITY | CHARGE- |
| | OXIDE- | | | | COMPOUND | | RETENTION | DISCHARGE |
| | CONTAINING | METAL | ELECTROLYTE | | | WT | RATIO | EFFICIENCY |
| | FILM | MATERIAL | SALT | KIND | KIND | % | (%) | (%) |
| EXAMPLE 1-3 | SiO₂ | Co | LiPF₆ | EC + | CHEMICAL | 3 | 84 | 86.4 |
| | | | 1 mol/kg | DEC | FORMULA 9(2) | | | |
| EXAMPLE 2-1 | | | | | CHEMICAL | | 84 | 87.0 |
| | | | | | FORMULA 7(1) | | | |
| EXAMPLE 2-2 | | | | | CHEMICAL | | 83 | 87.0 |
| | | | | | FORMULA 7(2) | | | |
| EXAMPLE 2-3 | | | | | CHEMICAL | | 82 | 83.0 |
| | | | | | FORMULA 7(6) | | | |
| EXAMPLE 2-4 | | | | | CHEMICAL | | 77 | 88.0 |
| | | | | | FORMULA 9(1) | | | |
| EXAMPLE 2-5 | | | | | CHEMICAL | | 83 | 86.2 |
| | | | | | FORMULA 13(2) | | | |
| EXAMPLE 2-6 | | | | | CHEMICAL | | 80 | 85.2 |
| | | | | | FORMULA 13(6) | | | |
| EXAMPLE 2-7 | | | | | CHEMICAL | | 82 | 88.0 |
| | | | | | FORMULA 14(6) | | | |
| EXAMPLE 2-8 | | | | | CHEMICAL | | 78 | 87.0 |
| | | | | | FORMULA 14(9) | | | |
| EXAMPLE 2-9 | | | | | CHEMICAL | | 78 | 84.0 |
| | | | | | FORMULA 16(4) | | | |
| COMPARATIVE | — | — | LiPF₆ | EC + | — | — | 40 | 88.0 |
| EXAMPLE 1-1 | | | 1 mol/kg | DEC | | | | |
| COMPARATIVE | SiO₂ | Co | | | — | — | 75 | 88.5 |
| EXAMPLE 1-2 | | | | | | | | |
| COMPARATIVE | — | — | | | CHEMICAL | 3 | 58 | 77.0 |
| EXAMPLE 1-3 | | | | | FORMULA 9(2) | | | |
| COMPARATIVE | — | — | | | CHEMICAL | 3 | 25 | 82.0 |
| EXAMPLE 1-4 | | | | | FORMULA 35 | | | |

As illustrated in Table 2, in Examples 2-1 to 2-9 in which the compound represented by Chemical Formula 7(1) or the like was used, as in the case of Example 1-3, compared to Comparative Examples 1-1 to 1-3, initial charge-discharge efficiency of 80% or over was obtained, and the discharge capacity retention ratio was higher.

Therefore, it was confirmed that in the secondary battery according to the embodiments, when the anode active material layer 34B of the anode 34 included the oxide-containing film and the metal material, and the solvent of the electrolytic solution included the compound represented by Chemical Formula 7(1) or the like, while the initial charge-discharge characteristics were secured, the cycle characteristics were improved.

### Examples 3-1 and 3-2

Secondary batteries were formed by the same steps as those in Example 1-3, except that as the solvent, instead of DEC, dimethyl carbonate (DMC: Example 3-1) or ethyl methyl carbonate (EMC: Example 3-2) was used.

### Example 3-3

A secondary battery was formed by the same steps as those in Example 1-3, except that as the solvent, propylene carbonate (PC) was added, and the composition of the solvent (EC:DEC:PC) was 10:70:20 at a weight ratio.

### Examples 3-4 to 3-7

Secondary batteries were formed by the same steps as those in Example 1-3, except that as the solvent, bis(fluoromethyl) carbonate (DFDMC: Example 3-4) as the chain carbonate represented by Chemical Formula 18 which included a halogen, 4-fluoro-1,3-dioxolane-2-one (FEC: Example 3-5) or trans-4,5-difluoro-1,3-dioxolane-2-one (t-DFEC: Example 3-6) as the cyclic carbonate represented by Chemical Formula 19 which included a halogen, or vinylene carbonate (VC: Example 3-7) as the cyclic carbonate represented by Chemical Formula 22 which had an unsaturated bond was added. At that time, the content of DFDMC or the like in the solvent was 5 wt %.

### Examples 3-8 and 3-9

Secondary batteries were formed by the same steps as those in Example 1-3, except that propene sultone (PRS: Example 3-8) as the sultone or sulfobenzoid anhydride (SBAH: Example 3-9) as the acid anhydride was added to the electrolytic solution as an additive. At that time, the amount of the additive such as PRS was 1 wt %. The amount (wt %) of the additive such as PRS was a ratio in the case where the total of the electrolytic solution (EC+DEC+the compound represented by Chemical Formula 9(2)+PRS or the like) except for the electrolyte salt was 100 wt %.

### Comparative Examples 2-1 to 2-4

Secondary batteries were formed by the same steps as those in Examples 3-5, 3-6, 3-7 and 3-9, except that the oxide-containing film and the metal material were not formed, and the compound represented by Chemical Formula 9(2) was not used.

### Comparative Examples 2-5 to 2-8

Secondary batteries were formed by the same steps as those in Examples 3-5, 3-6, 3-7 and 3-9, except that the compound represented by Chemical Formula 9(2) was not used.

When the cycle characteristics and the initial charge-discharge characteristics of the secondary batteries of Examples 3-1 to 3-9 and Comparative Example 2-1 to 2-8 were determined, results illustrated in Tables 3 and 4 were obtained.

TABLE 3
Anode active material: silicon (electron beam evaporation method)

| | | | ELECTROLYTIC SOLUTION | | | | | | |
|---|---|---|---|---|---|---|---|---|---|
| | | | | SOLVENT | | | | DISCHARGE | INITIAL |
| | ANODE | | | | ISOCYANATE | | | CAPACITY | CHARGE- |
| | OXIDE- | | | | COMPOUND | | | RETENTION | DISCHARGE |
| | CONTAINING | METAL | ELECTROLYTE | | | WT | | RATIO | EFFICIENCY |
| | FILM | MATERIAL | SALT | KIND | KIND | % | OTHERS | (%) | (%) |
| EXAMPLE | SiO₂ | Co | LiPF₆ | EC + DEC | CHEMICAL | 3 | — | 84 | 86.4 |
| 1-3 | | | 1 mol/kg | | FORMULA | | | | |
| EXAMPLE | | | | EC + DMC | 9(2) | | — | 86 | 86.2 |
| 3-1 | | | | | | | | | |
| EXAMPLE | | | | EC + EMC | | | — | 85 | 86.2 |
| 3-2 | | | | | | | | | |
| EXAMPLE | | | | EC + DEC + PC | | | — | 86 | 86.0 |
| 3-3 | | | | | | | | | |

| | | | | | |
|---|---|---|---|---|---|
| EXAMPLE | EC + | DFDMC | — | 87 | 86.2 |
| 3-4 | DEC | | | | |
| EXAMPLE | | FEC | — | 88 | 86.1 |
| 3-5 | | | | | |
| EXAMPLE | | t-DFEC | — | 94 | 86.0 |
| 3-6 | | | | | |
| EXAMPLE | | VC | — | 90 | 86.1 |
| 3-7 | | | | | |

| | | | | |
|---|---|---|---|---|
| EXAMPLE | EC + DEC | PRS | 85 | 86.0 |
| 3-8 | | | | |
| EXAMPLE | | SBAH | 86 | 86.0 |
| 3-9 | | | | |

TABLE 4
Anode active material: silicon (electron beam evaporation method)

| | | | ELECTROLYTIC SOLUTION | | | | | DISCHARGE | INITIAL |
|---|---|---|---|---|---|---|---|---|---|
| | ANODE | | | SOLVENT | | | | CAPACITY | CHARGE- |
| | OXIDE- | | | | ISOCYANATE | | | RETENTION | DISCHARGE |
| | CONTAINING | METAL | ELECTROLYTE | | COMPOUND | | | RATIO | EFFICIENCY |
| | FILM | MATERIAL | SALT | KIND | KIND | WT % | OTHERS | (%) | (%) |
| COMPARATIVE | — | — | LiPF₆ | EC + DEC | — | — | — | 40 | 88.0 |
| EXAMPLE 1-1 | | | 1 mol/kg | | | | | | |

| | | | | |
|---|---|---|---|---|
| COMPARATIVE | EC + | FEC | 66 | 87.8 |
| EXAMPLE 2-1 | DEC | | | |
| COMPARATIVE | | t- | 80 | 87.2 |
| EXAMPLE 2-2 | | DFEC | | |
| COMPARATIVE | | VC | 70 | 87.2 |
| EXAMPLE 2-3 | | | | |

| | | | | | | | | | |
|---|---|---|---|---|---|---|---|---|---|
| COMPARATIVE | | | | EC + DEC | — | — | SBAH | 45 | 87.5 |
| EXAMPLE 2-4 | | | | | | | | | |
| COMPARATIVE | SiO₂ | Co | LiPF₆ | EC + DEC | — | — | — | 75 | 88.5 |
| EXAMPLE 1-2 | | | 1 mol/kg | | | | | | |

| | | | | |
|---|---|---|---|---|
| COMPARATIVE | EC + | FEC | 84 | 88.3 |
| EXAMPLE 2-5 | DEC | | | |
| COMPARATIVE | | t- | 90 | 88.0 |
| EXAMPLE 2-6 | | DFEC | | |
| COMPARATIVE | | VC | 87 | 88.0 |
| EXAMPLE 2-7 | | | | |

| | | | | |
|---|---|---|---|---|
| COMPARATIVE | EC + DEC | SBAH | 80 | 88.0 |
| EXAMPLE 2-8 | | | | |

As illustrated in Tables 3 and 4, in Examples 3-1 to 3-9 in which the composition of the solvent was changed, as in the case of Example 1-3, compared to Comparative Examples 1-1, 1-2 and 2-1 to 2-8, initial charge-discharge efficiency of 80% or over was obtained, and the discharge capacity retention ratio was higher.

In particular, in Examples 3-1 to 3-3 in which DMC or the like was used instead of DEC, or PC was added, the discharge capacity retention ratio and the initial charge-discharge efficiency which were substantially equal to those in Example 1-3 were obtained.

Moreover, in Examples 3-4 to 3-7 in which DFDMC or the like was used, the discharge capacity retention ratio was higher than that in Example 1-3. In this case, it was obvious from a comparison between Examples 3-5 and 3-6 that there was a tendency that the more the number of halogens increased, the more the discharge capacity retention ratio was increased.

Further, in Examples 3-8 and 3-9 in which PRS or SBAH was used as the additive, the discharge capacity retention ratio was higher than that in Example 1-3.

In this case, only results in the case where the cyclic carbonate represented by Chemical Formula 22 which included an unsaturated carbon bond was used as the solvent were illustrated, and a result in the case where the cyclic carbonate represented by Chemical Formula 23 or 24 which included an unsaturated carbon bond was used was not illustrated. However, the cyclic carbonate represented by Chemical Formula 23 which includes an unsaturated carbon bond or the like serves the same function of increasing the discharge capacity retention ratio as that in the cyclic carbonate represented by Chemical Formula 22 which includes an unsaturated carbon bond; therefore, it is obvious that in the former case, the same result as that in the latter case is obtained.

Therefore, it was confirmed that in the secondary battery according to the embodiments, even if the composition of the solvent was changed, while the initial charge-discharge characteristics were secured, the cycle characteristics were improved. In this case, it was confirmed that when one of the chain carbonate represented by Chemical Formula 18 which included a halogen, the cyclic carbonate represented by Chemical Formula 19 which included a halogen, the cyclic carbonates represented by Chemical Formulas 22 to 24 which had an unsaturated carbon bond was used as the solvent, or when the sultone or the acid anhydride was used as the additive, the characteristics were further improved. Moreover, it was confirmed that when the chain carbonate represented by Chemical Formula 18 which included a halogen or the cyclic carbonate represented by Chemical Formula 19 which included a halogen was used, the more the number of halogens increased, the more the characteristics were improved.

### Examples 4-1 to 4-3

Secondary batteries were formed by the same steps as those in Example 1-3, except that as the electrolyte salt, lithium tetrafluoroborate (LiBF₄: Example 4-1), the compound represented by Chemical Formula 28(6) (Example 4-2) as the compound represented by Chemical Formula 25, or lithium bis(trifluoromethanesulfonyl)imide (LiTFSI: Example 4-3) as the compound represented by Chemical Formula 31 was added. At that time, the content of lithium hexafluorophosphate in the solvent was 0.9 mol/kg, and the content of lithium tetrafluoroborate or the like in the solvent was 0.1 mol/kg.

When the cycle characteristics and the initial charge-discharge characteristics of the secondary batteries of Examples 4-1 to 4-3 were determined, results illustrated in Table 5 were obtained.

TABLE 5
Anode active material: silicon (electron beam evaporation method)

| | | | ELECTROLYTIC SOLUTION | | | | DISCHARGE | INITIAL |
|---|---|---|---|---|---|---|---|---|
| | ANODE | | | SOLVENT | | | CAPACITY | CHARGE- |
| | OXIDE- | | | | ISOCYANATE | | RETENTION | DISCHARGE |
| | CONTAINING | METAL | | | COMPOUND | | RATIO | EFFICIENCY |
| | FILM | MATERIAL | ELECTROLYTE SALT | KIND | KIND | WT % | (%) | (%) |
| EXAMPLE 1-3 | SiO₂ | Co | LiPF₆ | EC + | CHEMICAL | 3 | 84 | 86.4 |
| | | | 1 mol/kg | DEC | FORMULA | | | |

| | | | | | |
|---|---|---|---|---|---|
| EXAMPLE 4-1 | LiPF₆ | LiBF₄ | 9(2) | 85 | 85.7 |
| | 0.9 mol/kg | 0.1 mol/kg | | | |
| EXAMPLE 4-2 | LiPF₆ | CHEMICAL | | 88 | 86.0 |
| | 0.9 mol/kg | FORMULA 28(6) | | | |
| | | 0.1 mol/kg | | | |
| EXAMPLE 4-3 | LiPF₆ | LiTFSI | | 85 | 86.2 |
| | 0.9 mol/kg | 0.1 mol/kg | | | |

As illustrated in Table 5, in Examples 4-1 to 4-3 in which lithium tetrafluoroborate or the like was added as the electrolyte salt, compared to Example 1-3, while initial charge-discharge efficiency of 80% or over was maintained, the discharge capacity retention ratio was higher.

Only results in the case where as the electrolyte salt, lithium tetrafluoroborate, or the compound represented by Chemical Formula 25 or Chemical Formula 31 was used were illustrated herein; and a result in the case where lithium perchlorate, lithium hexafluoroarsenate, or the compound represented by Chemical Formula 26, Chemical Formula 27, Chemical Formula 32 or Chemical Formula 33 was used was not illustrated. However, lithium perchlorate or the like serves the same function of increasing the discharge capacity retention ratio as that of lithium tetrafluoroborate or the like; therefore, it is obvious that in the former case, the same result as that in the latter case is obtained.

Therefore, it was confirmed that in the secondary battery according to the embodiments, even if the kind of the electrolyte salt was changed, while the initial charge-discharge characteristics were secured, the cycle characteristics were improved. In this case, it was confirmed that when lithium tetrafluoroborate, lithium perchlorate, lithium hexafluoroarsenate, or any of the compounds represented by Chemical Formulas 25 to 27, and Chemical Formula 31 to 33 was used as the electrolyte salt, the characteristics were further improved.

### Example 5-1

A secondary battery was formed by the same steps as those in Example 1-1, except that only the oxide-containing film was formed without forming the metal material.

### Examples 5-2 to 5-7

Secondary batteries were formed by the same steps as those in Example 5-1, except that the content of the compound represented by Chemical Formula 9(2) was 0.5 wt % (Example 5-2), 1 wt % (Example 5-3), 3 wt % (Example 5-4), 5 wt % (Example 5-5), 10 wt % (Example 5-6) or 12 wt % (Example 5-7).

### Comparative Example 3

A secondary battery was formed by the same steps as those in Example 5-1, except that the compound represented by Chemical Formula 9(2) was not used.

When the cycle characteristics and the initial charge-discharge characteristics of the secondary batteries of Examples 5-1 to 5-7 and Comparative Example 3 were determined, results illustrated in Table 6 were obtained.

TABLE 6
Anode active material: silicon (electron beam evaporation method)

| | | ELECTROLYTIC SOLUTION | | | | DISCHARGE | INITIAL |
|---|---|---|---|---|---|---|---|
| | ANODE | | SOLVENT | | | CAPACITY | CHARGE- |
| | OXIDE- | | | ISOCYANATE | | RETENTION | DISCHARGE |
| | CONTAINING | ELECTROLYTE | | COMPOUND | | RATIO | EFFICIENCY |
| | FILM | SALT | KIND | KIND | WT % | (%) | (%) |
| EXAMPLE 5-1 | SiO₂ | LiPF₆ | EC + | CHEMICAL | 0.01 | 75 | 87.0 |
| EXAMPLE 5-2 | | 1 mol/kg | DEC | FORMULA | 0.5 | 77 | 86.5 |
| EXAMPLE 5-3 | | | | 9(2) | 1 | 80 | 86.0 |
| EXAMPLE 5-4 | | | | | 3 | 82 | 85.8 |
| EXAMPLE 5-5 | | | | | 5 | 84 | 85.2 |
| EXAMPLE 5-6 | | | | | 10 | 84 | 84.8 |
| EXAMPLE 5-7 | | | | | 12 | 82 | 84.5 |
| COMPARATIVE | SiO₂ | LiPF₆ | EC + | — | — | 70 | 88.5 |
| EXAMPLE 3 | | 1 mol/kg | DEC | | | | |

As illustrated in Table 6, in the case where only the oxide-containing film was formed, the same results are those illustrated in Table 1 were obtained. More specifically, in Examples 5-1 to 5-7 in which the oxide-containing film was formed, compared to Comparative Example 3 in which the oxide-containing film was not formed, initial charge-discharge efficiency of 80% or over was obtained, and the discharge capacity retention ratio was higher. In this case, when the content of the compound represented by Chemical Formula 9(2) was within a range of 0.01 wt % to 10 wt % both inclusive, a high discharge capacity retention ratio was obtained, and a decline in battery capacity was prevented.

Only the results in the case where an oxide of silicon was used as the material of the oxide-containing film were illustrated herein, and a result in the case where an oxide of germanium or tin was used was not illustrated. However, when the oxide of germanium or the like is formed by the liquid-phase deposition method as in the case of the oxide of silicon, the oxide of germanium or the like serves the same function of increasing a discharge capacity retention ratio as that of the oxide of silicon, so it is obvious that in the case where the former is used, the same result as that in the case where the latter is used is obtained.

Therefore, it was confirmed that in the secondary battery according to the embodiments, even in the case where the anode active material layer 34B of the anode 34 included only the oxide-containing film, when the solvent of the electrolytic solution included the compound represented by Chemical Formula 9(2), while the initial charge-discharge characteristics were secured, the cycle characteristics were improved.

### Example 6-1

A secondary battery was formed by the same steps as those in Example 1-1, except that only the metal material was formed without forming the oxide-containing film.

### Examples 6-2 to 6-7

Secondary batteries were formed by the same steps as those in Example 6-1, except that the content of the compound represented by Chemical Formula 9(2) was 0.5 wt % (Example 6-2), 1 wt % (Example 6-3), 3 wt % (Example 6-4), 5 wt % (Example 6-5), 10 wt % (Example 6-6), or 12 wt % (Example 6-7).

### Comparative Example 4

A secondary battery was formed by the same steps as those in Example 6-1, except that the compound represented by Chemical Formula 9(2) was not used.

When the cycle characteristics and the initial charge-discharge characteristics of the secondary batteries of Examples 6-1 to 6-7 and Comparative Example 4 were determined, results illustrated in Table 7 were obtained.

TABLE 7
Anode active material: silicon (electron beam evaporation method)

| | | ELECTROLYTIC SOLUTION | | | | DISCHARGE | INITIAL |
|---|---|---|---|---|---|---|---|
| | | | SOLVENT | | | CAPACITY | CHARGE- |
| | ANODE | | | ISOCYANATE | | RETENTION | DISCHARGE |
| | METAL | ELECTROLYTE | | COMPOUND | | RATIO | EFFICIENCY |
| | MATERIAL | SALT | KIND | KIND | WT % | (%) | (%) |
| EXAMPLE 6-1 | Co | LiPF₆ | EC + | CHEMICAL | 0.01 | 70 | 87.0 |
| EXAMPLE 6-2 | | 1 mol/kg | DEC | FORMULA | 0.5 | 72 | 86.2 |
| EXAMPLE 6-3 | | | | 9(2) | 1 | 74 | 86.0 |
| EXAMPLE 6-4 | | | | | 3 | 80 | 85.0 |
| EXAMPLE 6-5 | | | | | 5 | 81 | 85.0 |
| EXAMPLE 6-6 | | | | | 10 | 81 | 84.7 |
| EXAMPLE 6-7 | | | | | 12 | 78 | 84.4 |
| COMPARATIVE | Co | LiPF₆ | EC + | — | — | 65 | 88.5 |
| EXAMPLE 4 | | 1 mol/kg | DEC | | | | |

As illustrated in Table 7, even in the case where only the metal material was formed, the same results as those illustrated in Table 1 were obtained. More specifically, in Examples 6-1 to 6-7 in which the metal material was formed, compared to Comparative Example 4 in which the metal material was not formed, initial charge-discharge efficiency of 80% or over was obtained, and the discharge capacity retention ratio was higher. In this case, when the content of the compound represented by Chemical Formula 9(2) was within a range of 0.01 wt % to 10 wt % both inclusive, a high discharge capacity retention ratio was obtained, and a decline in battery capacity was prevented.

Therefore, it was confirmed that in the secondary battery according to the embodiments, even in the case where the anode active material layer 34B of the anode 34 included only the metal material, when the solvent of the electrolytic solution included the compound represented by Chemical Formula 9(2), while the initial charge-discharge characteristics were secured, the cycle characteristics were improved.

### Example 7

A secondary battery was formed by the same steps as those in Example 6-5, except that instead of cobalt, a nickel (Ni)-plating film was grown to form the metal material. At that time, a nickel plating solution available from Japan Pure Chemical Co., Ltd. was used as a plating solution, and the current density was 2 A/dm² to 5 A/dm², and the plating rate was 10 nm/s.

### Comparative Example 5

A secondary battery was formed by the same steps as those in Example 7, except that the compound represented by Chemical Formula 9(2) was not used.

When the cycle characteristics and the initial charge-discharge characteristics of the secondary batteries of Example 7 and Comparative Example 5 were determined, results illustrated in Table 8 were obtained.

TABLE 8
Anode active material: silicon (electron beam evaporation method)

| | | ELECTROLYTIC SOLUTION | | | | DISCHARGE | INITIAL |
|---|---|---|---|---|---|---|---|
| | | | SOLVENT | | | CAPACITY | CHARGE- |
| | ANODE | | | ISOCYANATE | | RETENTION | DISCHARGE |
| | METAL | ELECTROLYTE | | COMPOUND | | RATIO | EFFICIENCY |
| | MATERIAL | SALT | KIND | KIND | WT % | (%) | (%) |
| EXAMPLE 7 | Ni | LiPF₆ | EC + | CHEMICAL | 5 | 78 | 83.0 |
| | | 1 mol/kg | DEC | FORMULA 9(2) | | | |
| COMPARATIVE | Ni | LiPF₆ | EC + | — | — | 65 | 87.5 |
| EXAMPLE 5 | | 1 mol/kg | DEC | | | | |

As illustrated in Table 8, even in the case where the material of the metal material was changed, the same results as those illustrated in Table 7 were obtained. More specifically, in Example 7 in which the metal material was formed, compared to Comparative Example 5 in which the metal material was not formed, initial charge-discharge efficiency of 80% or over was obtained, and the discharge capacity retention ratio was higher.

Only the results in the case where cobalt and nickel were used as the material of the metal material were illustrated herein, and results in the case where iron, zinc and copper were used were not illustrated. However, it is obvious that when iron or the like is formed as a plating film by the electrolytic plating method as in the case of cobalt or the like, iron or the like serves the same function of increasing the discharge capacity retention ratio as that of the cobalt or the like, so in the case where the former is used, the same result as that in the case where the latter is used is obtained.

Therefore, it was confirmed that in the secondary battery according to the embodiment, even in the case where the material of the metal material was changed, while the initial charge-discharge characteristics were secured, the cycle characteristics were improved.

As compared between Examples 1-3, 5-4 and 6-4 having the same content of the compound represented by Chemical Formula 9(2), the discharge capacity retention ratio was higher in the case where both of the oxide-containing film and the metal material were formed than that in the case where only the oxide-containing film or the metal material was formed. Moreover, the discharge capacity retention ratio was higher in the case where the oxide-containing film was formed than that in the case where the metal material was formed.

Therefore, it was confirmed that in the secondary battery according to the embodiments, the cycle characteristics were improved more in the case where both of the oxide-containing film and the metal material were formed than in the case where only one of them was formed, and when only one of them was formed, the cycle characteristics were improved more in the case where the oxide-containing film was formed than in the case where the metal material was formed.

It was confirmed from the above-described results in Tables 1 to 8 that in the secondary battery according to the embodiments, in the case where the anode active material layer of the anode included a plurality of anode active material particles including silicon, when the anode active material layer included at least one of the oxide-containing film and the metal material, and the solvent of the electrolytic solution included at least one kind selected from the isocyanate compounds represented by Chemical Formulas 5 and 6, independent of the composition of the solvent, the presence or absence of the additive, the kind of the electrolyte salt, the material of the metal material, or the like, while the initial charge-discharge characteristics was secured, the cycle characteristics were improved.

### Example 8-1

A laminate film type secondary battery illustrated in FIGS. 7 and 8 was formed by the following steps through the use of silicon as the material capable of inserting and extracting lithium ions and including at least one kind selected from the group consisting of metal elements and metalloid elements as the anode active material. At that time, the laminate film type secondary battery was a lithium-ion secondary battery in which the capacity of the anode 34 was represented on the basis of insertion and extraction of lithium.

First, the cathode 33 was formed. Lithium carbonate (Li₂CO₃) and cobalt carbonate (COCO₃) were mixed at a molar ratio of 0.5:1 to form a mixture, and then the mixture was fired in air at 900° C. for 5 hours to obtain a lithium-cobalt complex oxide (LiCoO₂). Next, 91 parts by mass of the lithium-cobalt complex oxide as a cathode active material, 3 parts by mass of polyvinylidene fluoride as a cathode binder and 6 parts by mass of graphite as a cathode conductor were mixed to form a cathode mixture, and then the cathode mixture was dispersed in N-methyl-2-pyrrolidone to form paste-form cathode mixture slurry. Next, the cathode mixture slurry was uniformly applied to both surfaces of the cathode current collector 33A made of strip-shaped aluminum foil (with a thickness of 12 μm) by a bar coater, and was dried, and then the cathode mixture slurry was compression molded by a roller press to form the cathode active material layer 33B.

Next, the anode current collector 34A (with a thickness of 15 μm) made of electrolytic copper foil with a roughened surface was prepared, and then silicon was deposited on both surfaces of the anode current collector 34A as the anode active material by the electron beam evaporation method to form the anode active material layer 34B, thereby the anode 34 was formed. In the case where the anode active material layer 34B was formed, the anode active material particles were formed by performing the deposition step 10 times, thereby the anode active material particles had a 10-layer configuration. At that time, the thickness (the total thickness) of the anode active material particles on one surface of the anode current collector 34A was 6 μm.

Next, the electrolytic solution was prepared. First, ethylene carbonate (EC) and diethyl carbonate (DEC) were mixed, and then the compound represented by Chemical Formula 44(1) as the isocyanate compound represented by Chemical Formula 36 was added to them to prepare a solvent. At that time, the composition of the solvent (EC:DEC) was 30:70 at a weight ratio, and the content of the compound represented by Chemical Formula 44(1) was 0.01 wt %. The content (wt %) of the compound represented by Chemical Formula 44(1) was a ratio in the case where the whole solvent (EC+DEC+the compound represented by Chemical Formula 44(1)) was 100 wt %. After that, lithium hexafluorophosphate (LiPF₆) as the electrolyte salt was dissolved in the solvent. At that time, the content of lithium hexafluorophosphate in the solvent was 1 mol/kg.

Finally, the secondary battery was assembled using the electrolytic solution together with the cathode 33 and the anode 34. First, the cathode lead 31 made of aluminum was welded to an end of the cathode current collector 33A, and the anode lead 32 made of nickel was welded to an end of the anode current collector 34A. Next, the cathode 33, the separator 35 (with a thickness of 25 μm) made of a microporous polypropylene film and the anode 34 were laminated in this order to form a laminate, and the laminate was spirally wound, and then an outermost portion of the spirally wound laminate was fixed by the protective tape 37 made of an adhesive tape so as to form a spirally wound body as a precursor body of the spirally wound electrode body 30. Next, the spirally wound body was sandwiched between the package members 40 made of a laminate film (with a total thickness of 100 μm) with a three-layer configuration formed by laminating a nylon film (with a thickness of 30 μm), aluminum foil (with a thickness of 40 μm) and a cast polypropylene film (with a thickness of 30 μm) in order from outside, and then the edge portions of the package members 40 except for edge portions on one side were adhered by thermal fusion bonding to form a pouched package, thereby the spirally wound body was contained in the package members 40. Next, the electrolytic solution was injected into the package members 40 from an opened portion of the package members 40, and the separator 35 was impregnated with the electrolytic solution, thereby the spirally wound electrode body 30 was formed. Finally, the opened portion of the package members 40 were sealed by thermal fusion bonding in a vacuum atmosphere, thereby the laminate film type secondary battery was completed. In the secondary battery, lithium metal was not deposited on the anode 34 in a fully-charged state by adjusting the thickness of the cathode active material layer 33B.

### Examples 8-2 to 8-7

Secondary batteries were formed by the same steps as those in Example 8-1, except that the content of the compound represented by Chemical Formula 44(1) was 1 wt % (Example 8-2), 2 wt % (Example 8-3), 3 wt % (Example 8-4), 5 wt % (Example 8-5), 10 wt % (Example 8-6) or 12 wt % (Example 8-7).

### Example 8-8

A secondary battery was formed by the same steps as those in Example 8-4, except that as the isocyanate compound represented by Chemical Formula 36, instead of the compound represented by Chemical Formula 44(1), the compound represented by Chemical Formula 44(2) was used.

### Comparative Example 6-1

A secondary battery was formed by the same steps as those in Example 8-1, except that the compound represented by Chemical Formula 44(1) was not included.

### Comparative Example 6-2

A secondary battery was formed by the same steps as those in Example 8-4, except that instead of the compound represented by Chemical Formula 44(1), the compound represented by Chemical Formula 45 was included.

When the cycle characteristics and the storage characteristics of the secondary batteries of Examples 8-1 to 8-8 and Comparative Examples 6-1 and 6-2 were determined, results illustrated in Table 9 were obtained.

To determine the cycle characteristics, two cycles of charge and discharge were performed on each of the secondary batteries in an atmosphere at 23° C. to determine the discharge capacity in the second cycle, and then the cycle of charge and discharge was repeated until the total cycle number reached 100 cycles in the same atmosphere to determine the discharge capacity in the 100th cycle. Finally, a room-temperature cycle discharge capacity retention ratio (%)=(discharge capacity in the 100th cycle/discharge capacity in the second cycle)×100 was determined by calculation. As the conditions of one cycle of charge and discharge, each of the secondary batteries was charged at a constant current of 0.2 C and a constant voltage until reaching an upper limit voltage of 4.2 V, and then each of the secondary batteries was discharged at a constant current of 0.2 C until reaching a cutoff voltage of 2.7 V. In addition “0.2 C” represents a current value at which the theoretical capacity of a battery is fully discharged for 5 hours.

To determine the storage characteristics, two cycles of charge and discharge were performed on each of the secondary batteries in an atmosphere at 23° C. to determine the discharge capacity before storage. Then, each of the secondary batteries which was charged again was stored for 10 days in a constant temperature bath at 80° C., and then each of the secondary batteries was discharged in an atmosphere at 23° C. to determine the discharge capacity after storage. Then, a high-temperature storage discharge capacity retention ratio (%)=(discharge capacity after storage/discharge capacity before storage)×100 was determined by calculation. The conditions of one cycle of charge and discharge were the same as those in the case where the cycle characteristics were determined.

The steps and conditions for determining the above-described cycle characteristics and the above-described storage characteristics in the following examples and the following comparative examples were the same as those described above.

TABLE 9
Anode active material: silicon

| | | | | | ROOM- | HIGH- |
|---|---|---|---|---|---|---|
| | | | | | TEMPERATURE | TEMPERATURE |
| | | | | | CYCLE | STORAGE |
| | | SOLVENT | | | DISCHARGE | DISCHARGE |
| | | | ISOCYANATE | | CAPACITY | CAPACITY |
| | ELECTROLYTE | | COMPOUND | | RETENTION | RETENTION |
| | SALT | KIND | KIND | WT % | RATIO (%) | RATIO (%) |
| EXAMPLE 8-1 | LiPF₆ | EC + | CHEMICAL | 0.01 | 45 | 84 |
| EXAMPLE 8-2 | 1 mol/kg | DEC | FORMULA | 1 | 62 | 85 |
| EXAMPLE 8-3 | | | 44(1) | 2 | 65 | 86 |
| EXAMPLE 8-4 | | | | 3 | 72 | 86 |
| EXAMPLE 8-5 | | | | 5 | 80 | 88 |
| EXAMPLE 8-6 | | | | 10 | 80 | 88 |
| EXAMPLE 8-7 | | | | 12 | 75 | 83 |
| EXAMPLE 8-8 | | | CHEMICAL | 3 | 70 | 84 |
| | | | FORMULA | | | |
| | | | 44(2) | | | |
| COMPARATIVE | LiPF₆ | EC + | — | — | 40 | 80 |
| EXAMPLE 6-1 | 1 mol/kg | DEC | | | | |
| COMPARATIVE | | | CHEMICAL | 3 | 42 | 82 |
| EXAMPLE 6-2 | | | FORMULA 45 | | | |

As illustrated in Table 9, in the case where silicon was used as the anode active material, in Examples 8-1 to 8-8 in which the solvent of the electrolytic solution included the compound represented by Chemical Formula 44(1) or 44(2), compared to Comparative Examples 6-1 and 6-2 in which the compounds represented by Chemical Formulas 44(1) and 44(2) were not included, a higher room-temperature cycle discharge capacity retention ratio and a higher high-temperature storage discharge capacity retention ratio was obtained.

More specifically, in Examples 8-1 to 8-7 in which the compound represented by Chemical Formula 44(1) was included, independent of the content, compared to Comparative Example 6-1, the room-temperature cycle discharge capacity retention ratio and the high-temperature storage discharge capacity retention ratio were higher. In this case, when the content of the compound represented by Chemical Formula 44(1) in the solvent was within a range of 0.01 wt % to 12 wt % both inclusive, a high room-temperature cycle discharge capacity retention ratio and a high high-temperature storage discharge capacity retention ratio were obtained. When the content of the compound represented by Chemical Formula 44(1) was smaller than 0.01 wt %, the room-temperature cycle discharge capacity retention ratio and the high-temperature storage discharge capacity retention ratio were not sufficiently high, and when the content was larger than 10 wt %, while a high room-temperature cycle discharge capacity retention ratio and a high high-temperature storage discharge capacity retention ratio were obtained, the battery capacity easily declined.

Moreover, in Example 8-8 in which the compound represented by Chemical Formula 44(2) was included, as in the case of Example 8-4 in which the compound represented by Chemical Formula 44(1) was included, compared to Comparative Example 6-1, the room-temperature cycle discharge capacity retention ratio and the high-temperature storage discharge capacity retention ratio were higher. In Examples 8-4 and 8-8, the room-temperature cycle discharge capacity retention ratio and the high-temperature storage discharge capacity retention ratio were substantially equal to each other.

Further, in Comparative Example 6-2 in which the compound represented by Chemical Formula 45 was included, compared to Comparative Example 6-1 in which the compound represented by Chemical Formula 45 was not included, the room-temperature cycle discharge capacity retention ratio and the high-temperature storage discharge capacity retention ratio were higher. However, the room-temperature cycle discharge capacity retention ratio and the high-temperature storage discharge capacity retention ratio obtained in Comparative Example 6-2 were lower than those in Example 8-4 in which the compound represented by Chemical Formula 44(1) was included. This result indicated that to improve the room-temperature cycle discharge capacity retention ratio and the high-temperature storage discharge capacity retention ratio, it was more advantageous in the case where a site where an isocyanate group and an electron-withdrawing group (a carbonyl group) are bonded was included than in the case where only the isocyanate group was included.

Therefore, it was confirmed that in the secondary battery according to the embodiments, in the case where the anode 34 included silicon as the anode active material, when the solvent of the electrolytic solution included the isocyanate compound represented by Chemical Formula 36, the cycle characteristics and the storage characteristics were improved. In this case, it was confirmed that when the content of the isocyanate compound represented by Chemical Formula 36 in the solvent was within a range of 0.01 wt % to 10 wt % both inclusive, a high battery capacity, superior cycle characteristics and superior storage characteristics were obtained.

### Examples 9-1 and 9-2

Secondary batteries were formed by the same steps as those in Example 8-4, except that as the solvent, instead of DEC, dimethyl carbonate (DMC: Example 9-1) or ethyl methyl carbonate (EMC: Example 9-2) were used.

### Example 9-3

A secondary battery was formed by the same steps as those in Example 8-4, except that as the solvent, propylene carbonate (PC) was added, and the composition of the solvent (EC:DEC:PC) was 10:70:20 at a weight ratio.

### Examples 9-4 to 9-7

Secondary batteries were formed by the same steps as those in Example 8-4, except that as the solvent, bis(fluoromethyl) carbonate (DFDMC: Example 9-4) as the chain carbonate represented by Chemical Formula 18 which included a halogen, 4-fluoro-1,3-dioxolane-2-one (FEC: Example 9-5) or trans-4,5-difluoro-1,3-dioxolane-2-one (t-DFEC: Example 9-6) as the cyclic carbonate represented by Chemical Formula 19 which included a halogen, or vinylene carbonate (VC: Example 9-7) as the cyclic carbonate represented by Chemical Formula 22 which had an unsaturated bond was added. At that time, the content of DFDMC or the like in the solvent was 5 wt %.

### Comparative Examples 7-1 to 7-3

Secondary batteries were formed by the same steps as those in Examples 9-5 to 9-7, except that the compound represented by Chemical Formula 44(1) was not included.

When the cycle characteristics and the storage characteristics of the secondary batteries of Examples 9-1 to 9-7 and Comparative Examples 7-1 to 7-3 were determined, results illustrated in Table 10 were obtained.

TABLE 10
Anode active material: silicon

| | | | | | ROOM- | HIGH- |
|---|---|---|---|---|---|---|
| | | | | | TEMPERATURE | TEMPERATURE |
| | | | | | CYCLE | STORAGE |
| | | SOLVENT | | | DISCHARGE | DISCHARGE |
| | | | ISOCYANATE | | CAPACITY | CAPACITY |
| | ELECTROLYTE | | COMPOUND | | RETENTION | RETENTION |
| | SALT | KIND | KIND | WT % | RATIO (%) | RATIO (%) |
| EXAMPLE 8-4 | LiPF₆ | EC + DEC | CHEMICAL | 3 | 72 | 86 |
| EXAMPLE 9-1 | 1 mol/kg | EC + DMC | FORMULA | | 74 | 85 |
| EXAMPLE 9-2 | | EC + EMC | 44(1) | | 73 | 86 |
| EXAMPLE 9-3 | | EC + DEC + PC | | 70 | 85 | |

| | | | | |
|---|---|---|---|---|
| EXAMPLE 9-4 | EC + | DFDMC | 83 | 89 |
| EXAMPLE 9-5 | DEC | FEC | 86 | 91 |
| EXAMPLE 9-6 | | t-DFEC | 90 | 92 |
| EXAMPLE 9-7 | | VC | 80 | 90 |

| | | | | | | |
|---|---|---|---|---|---|---|
| COMPARATIVE | LiPF₆ | EC + DEC | — | — | 40 | 80 |
| EXAMPLE 6-1 | 1 mol/kg | | | | | |

| | | | | |
|---|---|---|---|---|
| COMPARATIVE | EC + | FEC | 66 | 86 |
| EXAMPLE 7-1 | DEC | | | |
| COMPARATIVE | | t-DFEC | 80 | 88 |
| EXAMPLE 7-2 | | | | |
| COMPARATIVE | | VC | 70 | 84 |
| EXAMPLE 7-3 | | | | |

As illustrated in Table 10, even in Examples 9-1 to 9-7 in which the composition of the solvent was changed, as in the case of Example 8-4, compared to Comparative Example 6-1, a higher room-temperature cycle discharge capacity retention ratio and a higher high-temperature storage discharge capacity retention ratio were obtained. In the case where the solvent included FEC or the like, in Examples 9-5 to 9-7, compared to Comparative Examples 7-1 to 7-3, a higher room-temperature cycle discharge capacity retention ratio and a higher high-temperature storage discharge capacity retention ratio were obtained.

In particular, in Examples 9-1 to 9-3 in which DEC was replaced with DMC or the like, or PC was added, the room-temperature cycle discharge capacity retention ratio and the high-temperature storage discharge capacity retention ratio which were substantially equal to those in Example 8-4 were obtained.

In Examples 9-4 to 9-7 in which FEC or the like was used, the room-temperature cycle discharge capacity retention ratio and the high-temperature storage discharge capacity retention ratio were higher than those in Example 8-4. In this case, it was obvious from a comparison between Examples 9-5 and 9-6 that there was a tendency that the more the number of halogens increased, the more the room-temperature cycle discharge capacity retention ratio and the high-temperature storage discharge capacity retention ratio were increased.

In this case, only results in the case where the chain carbonate represented by Chemical Formula 18 which included a halogen, the cyclic carbonate represented by Chemical Formula 19 which included a halogen, and the cyclic carbonate represented by Chemical Formula 22 which had an unsaturated carbon bond were used as the solvent were illustrated, and a result in the case where the cyclic carbonate represented by Chemical Formula 23 or Chemical Formula 24 which had an unsaturated carbon bond was used was not illustrated. However, the cyclic carbonate represented by Chemical Formula 23 which has an unsaturated carbon bond, or the like serves the same function of increasing the room-temperature cycle discharge capacity retention ratio and the high-temperature storage discharge capacity retention ratio as that of the cyclic carbonate represented by Chemical Formula 22 which has an unsaturated carbon bond, so it is obvious that in the case where the former is used, the same result as that in the case where the latter is used is obtained.

Therefore, it was confirmed that in the secondary battery according to the embodiments in which the anode 34 included silicon as the anode active material, even if the composition of the solvent was changed, the cycle characteristics and the storage characteristics were improved. In this case, it was confirmed that when the chain carbonate represented by Chemical Formula 18 which included a halogen, the cyclic carbonate represented by Chemical Formula 19 which included a halogen, or any of the cyclic carbonates represented by Chemical Formulas 22 to 24 which had an unsaturated carbon bond was used as the solvent, the characteristics were further improved. Moreover, it was confirmed that in the case where the chain carbonate represented by Chemical Formula 18 which included a halogen or the cyclic carbonate represented by Chemical Formula 19 which included a halogen was used, the more the number of halogens increased, the more the characteristics were improved.

### Examples 10-1 to 10-3

Secondary batteries were formed by the same steps as those in Example 8-4, except that as the electrolyte salt, lithium tetrafluoroborate (LiBF₄: Example 10-1), the compound represented by Chemical Formula 28(6) (Example 10-2) as the compound represented by Chemical Formula 25, or lithium bis(trifluoromethanesulfonyl)imide (LiTFSI: Example 10-3) as the compound represented by Chemical Formula 31 was added. At that time, the content of lithium hexafluorophosphate in the solvent was 0.9 mol/kg, and the content of lithium tetrafluoroborate or the like in the solvent was 0.1 mol/kg.

When the cycle characteristics and the storage characteristics of the secondary batteries of Examples 10-1 to 10-3 were determined, results illustrated in Table 11 were obtained.

TABLE 11
Anode active material: silicon

| | | | | | | ROOM- | HIGH |
|---|---|---|---|---|---|---|---|
| | | | | | | TEMPERATURE | TEMPERATURE |
| | | | | | | CYCLE | STORAGE |
| | | | SOLVENT | | | DISCHARGE | DISCHARGE |
| | | | | ISOCYANATE | | CAPACITY | CAPACITY |
| | | | | COMPOUND | | RETENTION | RETENTION |
| | ELECTROLYTE SALT | | KIND | KIND | WT % | RATIO (%) | RATIO (%) |
| EXAMPLE 8-4 | LiPF₆ | | EC + | CHEMICAL | 3 | 72 | 86 |
| | 1 mol/kg | | DEC | FORMULA | | | |
| EXAMPLE 10-1 | LiPF₆ | LIBF₄ | | 44(1) | | 72 | 88 |
| | 0.9 mol/kg | 0.1 mol/kg | | | | | |
| EXAMPLE 10-2 | LiPF₆ | CHEMICAL | | | | 78 | 90 |
| | 0.9 mol/kg | FORMULA | | | | | |
| | | 28(6) | | | | | |
| | | 0.1 mol/kg | | | | | |
| EXAMPLE 10-3 | LiPF₆ | LiTFSI | | | | 74 | 90 |
| | 0.9 mol/kg | 0.1 mol/kg | | | | | |

As illustrated in Table 11, in Examples 10-1 to 10-3 in which the electrolyte salt included lithium tetrafluoroborate or the like, a room-temperature cycle discharge capacity retention ratio and a high-temperature storage discharge capacity retention ratio which were equal to or higher than those in Example 8-4 in which lithium tetrafluoroborate or the like was not included were obtained.

More specifically, in Example 10-1 in which lithium tetrafluoroborate was included, the room-temperature cycle discharge capacity retention ratio was equal to that in Example 8-4, and the high-temperature storage discharge capacity retention ratio was higher than that in Example 8-4. In Examples 10-2 and 10-3 in which the compound represented by Chemical Formula 28(6) or the like was included, both of the room-temperature cycle discharge capacity retention ratio and the high-temperature storage discharge capacity retention ratio were higher than those in Example 8-4.

In this case, only results in the case where as the electrolyte salt, lithium tetrafluoroborate, or the compounds represented by Chemical Formula 25 or Chemical Formula 31 was used were illustrated herein, and a result in the case where lithium perchlorate, lithium hexafluoroarsenate, or the compound represented by Chemical Formula 26, Chemical Formula 27, Chemical Formula 32 or Chemical Formula 33 was used was not illustrated. However, lithium perchlorate or the like serves the function of increasing the room-temperature cycle discharge capacity retention ratio and the high-temperature storage discharge capacity retention ratio as that of lithium tetrafluoroborate or the like, so it is obvious that in the case where the former is included, the same result as that in the case where the latter is included is obtained.

Therefore, it was confirmed that in the secondary battery according to the embodiments in which the anode 34 included silicon as the anode active material, even if the kind of the electrolyte salt was changed, the cycle characteristics and the storage characteristics were improved. In this case, it was confirmed that when lithium tetrafluoroborate, lithium perchlorate, lithium hexafluoroarsenate or any of the compounds represented by Chemical Formulas 25 to 27 and Chemical Formulas 31 to 33 was used as the electrolyte salt, the characteristics were further improved.

### Example 11-1

A secondary battery was formed by the same steps as those in Example 8-1, except that as the anode active material, instead of silicon, artificial graphite as a carbon material was used to form the anode active material layer 34B. In the case where the anode active material layer 34B was formed, a mixture of 90 parts by mass of artificial graphite as the anode active material and 10 parts by mass of polyvinylidene fluoride as the anode binder was dispersed in N-methyl-2-pyrrolidone to form paste-form anode mixture slurry, and the anode mixture slurry was uniformly applied to both surfaces of the anode current collector 34A made of strip-shaped electrolytic copper foil (with a thickness of 15 μm) by a bar coater, and was dried, and then the anode mixture slurry was compression molded by a roller press to form the anode active material layer 34B. At that time, the thickness of the anode active material layer 34B on one surface of the anode current collector 34A was 75 μm.

### Examples 11-2 to 11-6

Secondary batteries were formed by the same steps as those in Example 11-1, except that the content of the compound represented by Chemical Formula 44(1) was 0.5 wt % (Example 11-2), 1 wt % (Example 11-3), 2 wt % (Example 11-4), 5 wt % (Example 11-5) or 10 wt % (Example 11-6).

### Example 11-7

A secondary battery was formed by the same steps as those in Example 11-3, except that as the isocyanate compound represented by Chemical Formula 36, instead of the compound represented by Chemical Formula 44(1), the compound represented by Chemical Formula 44(2) was used.

### Comparative Example 8

A secondary battery was formed by the same steps as those in Example 11-1, except that the compound represented by Chemical Formula 44(1) was not included.

When the cycle characteristics and the storage characteristics of the secondary batteries of Examples 11-1 to 11-7 and Comparative Example 8 were determined, results illustrated in Table 12 were obtained.

TABLE 12
Anode active material: artificial graphite

| | | | | | ROOM- | HIGH- |
|---|---|---|---|---|---|---|
| | | | | | TEMPERATURE | TEMPERATURE |
| | | | | | CYCLE | STORAGE |
| | | SOLVENT | | | DISCHARGE | DISCHARGE |
| | | | ISOCYANATE | | CAPACITY | CAPACITY |
| | ELECTROLYTE | | COMPOUND | | RETENTION | RETENTION |
| | SALT | KIND | KIND | WT % | RATIO (%) | RATIO (%) |
| EXAMPLE 11-1 | LiPF₆ | EC + | CHEMICAL | 0.01 | 84 | 86 |
| EXAMPLE 11-2 | 1 mol/kg | DEC | FORMULA 44(1) | 0.5 | 86 | 88 |
| EXAMPLE 11-3 | | | | 1 | 88 | 88 |
| EXAMPLE 11-4 | | | | 2 | 92 | 90 |
| EXAMPLE 11-5 | | | | 5 | 88 | 90 |
| EXAMPLE 11-6 | | | | 10 | 83 | 85 |
| EXAMPLE 11-7 | | | CHEMICAL | 1 | 88 | 90 |
| | | | FORMULA 44(2) | | | |
| COMPARATIVE | LiPF₆ | EC + | — | — | 82 | 84 |
| EXAMPLE 8 | 1 mol/kg | DEC | | | | |

As illustrated in Table 12, even in the case where artificial graphite was used as the anode active material, substantially the same results as those illustrated in Table 9 were obtained. More specifically, in Examples 11-1 to 11-8 in which the solvent of the electrolytic solution included the compound represented by Chemical Formula 44(1) or 44(2), compared to Comparative Example 8 in which the compound represented by Chemical Formula 44(1) or 44(2) was not included, a higher room-temperature cycle discharge capacity retention ratio and a higher high-temperature storage discharge capacity retention ratio were obtained. In this case, when the content of the compound represented by Chemical Formula 44(1) in the solvent was within a range of 0.01 wt % to 10 wt % both inclusive, a high room-temperature cycle discharge capacity retention ratio and a high high-temperature storage discharge capacity retention ratio were obtained, and when the content was within a range of 0.01 wt % to 5 wt % both inclusive, a high battery capacity was also obtained.

Therefore, it was confirmed that in the secondary battery according to the embodiments, in the case where the anode 34 included artificial graphite as the anode active material, when the solvent of the electrolytic solution included the isocyanate compound represented by Chemical Formula 36, the cycle characteristics and the storage characteristics were improved. In this case, it was confirmed that the content of the isocyanate compound represented by Chemical Formula 36 in the solvent was within a range of 0.01 wt % to 5 wt % both inclusive, a high battery capacity, superior cycle characteristics and superior storage characteristics were obtained.

It was derived from the results illustrated in Tables 9 and 12 that when the content of the isocyanate compound represented by Chemical Formula 36 in the solvent was within a range of 0.01 wt % to 5 wt % both inclusive, independent of the kind of the anode active material (silicon or artificial graphite), a high battery capacity and superior cycle characteristics and superior storage characteristics were obtained.

### Examples 12-1 and 12-2

Secondary batteries were formed by the same steps as those in Example 11-3, except that as the solvent, instead of DEC, DMC (Example 12-1) or EMC (Example 12-2) was used.

### Example 12-3

A secondary battery was formed by the same steps as those in Example 11-3, except that as the solvent, PC was added, and the composition of the solvent (EC:DEC:PC) was 10:70:20 at a weight ratio.

### Examples 12-4 to 12-7

Secondary batteries were formed by the same steps as those in Example 11-3, except that as the solvent, DFDMC (Example 12-4), FEC (Example 12-5), t-DFEC (Example 12-6), or VC (Example 12-7) was added. At that time, the amount of DFDMC or the like in the solvent was 2 wt %.

### Comparative Examples 9-1 to 9-3

Secondary batteries were formed by the same steps as those in Examples 12-5 to 12-7, except that the compound represented by Chemical Formula 44(1) was not included.

When the cycle characteristics and the storage characteristics of the secondary batteries of Examples 12-1 to 12-7 and Comparative Example 9-1 to 9-3 were determined, results illustrated in Table 13 were obtained.

TABLE 13
Anode active material: artificial graphite

| | | | | | ROOM- | HIGH- |
|---|---|---|---|---|---|---|
| | | | | | TEMPERATURE | TEMPERATURE |
| | | | | | CYCLE | STORAGE |
| | | SOLVENT | | | DISCHARGE | DISCHARGE |
| | | | ISOCYANATE | | CAPACITY | CAPACITY |
| | ELECTROLYTE | | COMPOUND | | RETENTION | RETENTION |
| | SALT | KIND | KIND | WT % | RATIO (%) | RATIO (%) |
| EXAMPLE 11-3 | LiPF₆ | EC + DEC | CHEMICAL | 1 | 88 | 88 |
| EXAMPLE 12-1 | 1 mol/kg | EC + DMC | FORMULA | | 90 | 92 |
| EXAMPLE 12-2 | | EC + EMC | 44(1) | | 89 | 91 |
| EXAMPLE 12-3 | | EC + DEC + PC | | | 89 | 89 |

| | | | | |
|---|---|---|---|---|
| EXAMPLE 12-4 | EC + | DFDMC | 93 | 92 |
| EXAMPLE 12-5 | DEC | FEC | 95 | 94 |
| EXAMPLE 12-6 | | t-DFEC | 94 | 94 |
| EXAMPLE 12-7 | | VC | 94 | 93 |

| | | | | | | |
|---|---|---|---|---|---|---|
| COMPARATIVE | LiPF₆ | EC + DEC | — | — | 82 | 84 |
| EXAMPLE 8 | 1 mol/kg | | | | | |

| | | | | |
|---|---|---|---|---|
| COMPARATIVE | EC + | FEC | 92 | 90 |
| EXAMPLE 9-1 | DEC | | | |
| COMPARATIVE | | t-DFEC | 91 | 88 |
| EXAMPLE 9-2 | | | | |
| COMPARATIVE | | VC | 92 | 88 |
| EXAMPLE 9-3 | | | | |

As illustrated in Table 13, even in the case where artificial graphite was used as the anode active material, substantially the same results as those in Table 10 were obtained. More specifically, in Examples 12-1 to 12-7 in which the composition of the solvent was changed, as in the case of Example 11-3, compared to Comparative Examples 8 and 9-1 to 9-3, a higher room-temperature cycle discharge capacity retention ratio and a higher high-temperature storage discharge capacity retention ratio were obtained. In particular, in Examples 12-1 to 12-3 in which DMC or the like was used instead of DEC, or PC was added, the room-temperature cycle discharge capacity retention ratio and the high-temperature storage discharge capacity retention ratio were higher than those in Example 11-3. Moreover, in Examples 12-4 to 12-7 in which FEC or the like was used, the room-temperature cycle discharge capacity retention ratio and the high-temperature storage discharge capacity retention ratio were higher than those in Example 11-3.

Therefore, it was confirmed that in the secondary battery according to the embodiments in which the anode 34 included artificial graphite as the anode active material, even if the composition of the solvent was changed, the cycle characteristics and the storage characteristics were improved. In this case, it was confirmed that as the solvent, the chain carbonate represented by Chemical Formula 18 which included a halogen, the cyclic carbonate represented by Chemical Formula 19 which included a halogen, or any of the cyclic carbonates represented by Chemical Formulas 22 to 24 which had an unsaturated carbon bond was used, the characteristics were further improved.

### Examples 13-1 to 13-3

Secondary batteries were formed by the same steps as those in Example 11-3, except that as the electrolyte salt, LiBF₄ (Example 13-1), the compound represented by Chemical Formula 28(6) (Example 13-2) or LiTFSI (Example 13-3) was added. At that time, the content of lithium hexafluorophosphate in the solvent was 0.9 mol/kg, and the content of lithium tetrafluoroborate or the like in the solvent was 0.1 mol/kg.

When the cycle characteristics and the storage characteristics of the secondary batteries of Examples 13-1 to 13-3 were determined, results illustrated in Table 14 were obtained.

TABLE 14
Anode active material: artificial graphite

| | | | | | | ROOM- | HIGH- |
|---|---|---|---|---|---|---|---|
| | | | SOLVENT | | | TEMPERATURE | TEMPERATURE |
| | | | | ISOCYANATE | | CYCLE DISCHARGE | STORAGE DISCHARGE |
| | | | | COMPOUND | | CAPACITY RETENTION | CAPACITY RETENTION |
| | ELECTROLYTE SALT | | KIND | KIND | WT % | RATIO (%) | RATIO (%) |
| EXAMPLE 11-4 | LiPF₆ | | EC + | CHEMICAL | 1 | 88 | 88 |
| | 1 mol/kg | | DEC | FORMULA | | | |
| EXAMPLE 13-1 | LiPF₆ | LIBF₄ | | 44(1) | | 88 | 92 |
| | 0.9 mol/kg | 0.1 mol/kg | | | | | |
| EXAMPLE 13-2 | LiPF₆ | CHEMICAL | | | | 90 | 94 |
| | 0.9 mol/kg | FORMULA | | | | | |
| | | 28(6) | | | | | |
| | | 0.1 mol/kg | | | | | |
| EXAMPLE 13-3 | LiPF₆ | LiTFSI | | | | 89 | 92 |
| | 0.9 mol/kg | 0.1 mol/kg | | | | | |

As illustrated in Table 14, even in the case where artificial graphite was used as the anode active material, the same results as those illustrated in Table 11 were obtained. More specifically, in Examples 13-1 to 13-3 in which the electrolyte salt included lithium tetrafluoroborate or the like, the room-temperature cycle discharge capacity retention ratio and the high-temperature storage discharge capacity retention ratio which were equal to or higher than those in Example 11-3 in which lithium tetrafluoroborate or the like was not included were obtained.

Therefore, it was confirmed that in the secondary battery according to the embodiments in which the anode 34 included artificial graphite as the anode active material, even if the kind of the electrolyte salt was changed, the cycle characteristics and the storage characteristics were improved. In this case, it was confirmed that as the electrolyte salt, lithium tetrafluoroborate, lithium perchlorate, lithium hexafluoroarsenate, or any of the compounds represented by Chemical Formulas 25 to 27 and Chemical Formulas 31 to 33 was used, the characteristics were further improved.

### Example 14-1

A secondary battery was formed by the same steps as those in Example 8-4, except that as the anode active material, instead of silicon, the SnCoC-containing material as a material capable of inserting and extracting lithium ions and including at least one kind selected from the group consisting of metal elements and metalloid elements was used as in the case of silicon to form the anode active material layer 34B.

When the anode active material layer 34B was formed, first, the powder of cobalt and the powder of tin were alloyed to form the powder of an cobalt-tin alloy, and then the powder of carbon was added to the powder of the cobalt-tin alloy, and they were dry mixed to form a mixture. Next, 10 g of the above-described mixture was put into a reaction vessel of a planetary ball mill available from Ito Seisakusho together with approximately 400 g of corundums with a diameter of 9 mm. Next, an argon atmosphere was substituted in the reaction vessel, and the cycle of a 10-minute operation with a rotation speed of 250 rpm and a 10-minute interval was repeated until the total operation time of the planetary ball mill reached 20 hours. Next, the reaction vessel was cooled down to a room temperature, and the SnCoC-containing material was taken out from the reaction vessel, and then the mixture was shifted through a sieve having 280 meshes to remove coarse grains of the mixture.

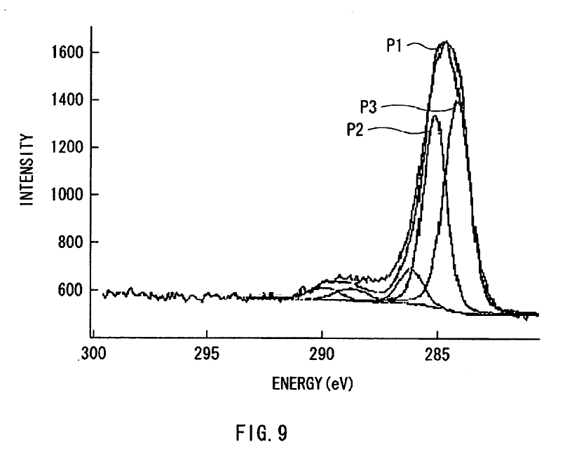

When the composition of the obtained SnCoC-containing material was analyzed, the tin content was 49.5 wt %, the cobalt content was 29.7 wt %, the carbon content was 19.8 wt % and the ratio of cobalt to the total of tin and cobalt (Co/(Sn+Co)) was 37.5 wt %. At that time, the contents of tin and cobalt were measured by inductively coupled plasma (ICP) emission spectrometry, and the carbon content was measured by a carbon/sulfur analyzer. When the SnCoC-containing material was analyzed by an X-ray diffraction method, a diffraction peak having a half-width in a range of the diffraction angle 2θ=20° to 50° was observed. Further, when the SnCoC-containing material was analyzed by the XPS measurement, the peak P1 as illustrated in FIG. 9 was obtained. When the peak P1 was analyzed, a peak P2 of surface contamination carbon, and a peak P3 of C1s in the SnCoC-containing material on a lower energy side than the peak P2 (in a region lower than 284.5 eV) were obtained. It was confirmed from the result that carbon included in the SnCoC-containing material was bonded to another element.

After the SnCoC-containing material was obtained, 80 parts by mass of the SnCoC-containing material as the anode active material, 8 parts by mass of polyvinylidene fluoride as the anode binder, and 11 parts by mass of graphite and 1 part by mass of acetylene black as anode conductors were mixed to form an anode mixture, and the anode mixture was dispersed in N-methyl-2-pyrrolidone to form paste-form anode mixture slurry. Next, the anode mixture slurry was uniformly applied to both surfaces of the anode current collector 34A made of strip-shaped aluminum foil (with a thickness of 15 μm) by a bar coater, and was dried, and then the cathode mixture slurry was compression molded by a roller press to form the anode active material layer 34B. At that time, the thickness of the anode active material layer 34B on one surface of the anode current collector 34A was 50 μm.

### Example 14-2

A secondary battery was formed by the same steps as those in Example 14-1, except that FEC was added as the solvent. At that time, the content of FEC in the solvent was 5 wt %.

### Comparative Examples 10-1 and 10-2

Secondary batteries were formed by the same steps as those in Examples 14-1 and 14-2, except that the compound represented by Chemical Formula 44(1) was not included.

When the cycle characteristics and the storage characteristics of the secondary batteries of Examples 14-1 and 14-2 and Comparative Examples 10-1 and 10-2 were determined, results illustrated in Table 15 were obtained.

TABLE 15
Anode active material: SnCoC-containing material

| | | | | | | ROOM- | HIGH- |
|---|---|---|---|---|---|---|---|
| | | | | | | TEMPERATURE | TEMPERATURE |
| | | | | | | CYCLE | STORAGE |
| | | SOLVENT | | | | DISCHARGE | DISCHARGE |
| | | | | ISOCYANATE | | CAPACITY | CAPACITY |
| | ELECTROLYTE | | | COMPOUND | | RETENTION | RETENTION |
| | SALT | KIND | | KIND | WT % | RATIO (%) | RATIO (%) |
| EXAMPLE 14-1 | LiPF₆ | EC + DEC | | CHEMICAL | 3 | 82 | 85 |
| EXAMPLE 14-2 | 1 mol/kg | EC + | FEC | FORMULA | | 85 | 92 |
| | | DEC | | 44(1) | | | |

| | | | | | | |
|---|---|---|---|---|---|---|
| COMPARATIVE | LiPF₆ | EC + DEC | — | — | 76 | 70 |
| EXAMPLE 10-1 | 1 mol/kg | | | | | |

| | | | | |
|---|---|---|---|---|
| COMPARATIVE | EC + | FEC | 84 | 90 |
| EXAMPLE 10-2 | DEC | | | |

As illustrated in Table 15, even in the case where the SnCoC-containing material was used as the anode active material, the same results as those illustrated in Tables 9 and 10 were obtained. More specifically, in Examples 14-1 and 14-2 in which the solvent of the electrolytic solution included the compound represented by Chemical Formula 44(1), compared to Comparative Examples 10-1 and 10-2 in which the compound represented by Chemical Formula 44(1) was not included, a higher room-temperature cycle discharge capacity retention ratio and a higher high-temperature storage discharge capacity retention ratio were obtained. Moreover, in Example 14-2 in which the solvent included FEC, the room-temperature cycle discharge capacity retention ratio and the high-temperature storage discharge capacity retention ratio were higher than those in Example 14-1 in which the FEC was not included.

Therefore, it was confirmed that in the secondary battery according to the embodiments, in the case where the anode 34 included the SnCoC-containing material as the anode active material, when the solvent of the electrolytic solution included the isocyanate compound represented by Chemical Formula 36, the cycle characteristics and the storage characteristics were improved.

### Example 15

A secondary battery was formed by the same steps as those in Example 8-4, except that in the case where the anode active material layer 34B was formed, after a plurality of anode active material particles were formed, an oxide of silicon (SiO₂) was deposited as the oxide-containing film on the anode active material particles by the liquid-phase deposition method. In the case where the oxide-containing film was formed, the anode current collector 34A on which the anode active material particles were formed was immersed for 3 hours in a solution formed by dissolving boron as an anion trapping agent in a hexafluorosilicic acid to deposit the oxide of silicon on the surfaces of the anode active material particles, and then the anode current collector 34A was cleaned, and dried under reduced pressure.

### Comparative Example 11

A secondary battery was formed by the same steps as those in Example 15, except that the compound represented by Chemical Formula 44(1) was not included.

When the cycle characteristics and the storage characteristics of the secondary batteries of Example 15 and Comparative Example 11 were determined, results illustrated in Table 16 were obtained.

TABLE 16
Anode active material: silicon

| | | | | | | ROOM- | HIGH- |
|---|---|---|---|---|---|---|---|
| | | | | | | TEMPERATURE | TEMPERATURE |
| | | ELECTROLYTIC SOLUTION | | | | CYCLE | STORAGE |
| | | | SOLVENT | | | DISCHARGE | DISCHARGE |
| | ANODE | | | ISOCYANATE | | CAPACITY | CAPACITY |
| | OXIDE-CONTAINING | ELECTROLYTE | | COMPOUND | | RETENTION | RETENTION |
| | FILM | SALT | KIND | KIND | WT % | RATIO (%) | RATIO (%) |
| EXAMPLE 8-4 | — | LiPF₆ | EC + | CHEMICAL | 3 | 72 | 86 |
| EXAMPLE 15 | SiO₂ | 1 mol/kg | DEC | FORMULA | | 78 | 88 |
| | | | | 44(1) | | | |
| COMPARATIVE | — | LiPF₆ | EC + | — | — | 40 | 80 |
| EXAMPLE 6-1 | | 1 mol/kg | DEC | | | | |
| COMPARATIVE | SiO₂ | | | | | 70 | 86 |
| EXAMPLE 11 | | | | | | | |

As illustrated in Table 16, even in the case where the oxide-containing film was formed, the same results as those illustrated in Table 9 were obtained. More specifically, in Example 15 in which the solvent included the compound represented by Chemical Formula 44(1), compared to Comparative Examples 6-1 and 11 in which the compound represented by Chemical Formula 44(1) was not included, a higher room-temperature cycle discharge capacity retention ratio and a higher high-temperature storage discharge capacity retention ratio were obtained.

In particular, in Example 15 in which the oxide-containing film was formed, compared to Example 8-4 in which the oxide-containing film was not formed, the room-temperature cycle discharge capacity retention ratio and the high-temperature storage discharge capacity retention ratio were higher.

Only the results in the case where the oxide of silicon was formed as the oxide-containing film were illustrated herein, and a result in the case where an oxide of germanium or tin was formed was not illustrated. However, the oxide of germanium or the like serves the function of increasing the room-temperature cycle discharge capacity retention ratio and the high-temperature storage discharge capacity retention ratio as that of the oxide of silicon, so it is obvious that in the case where the former is used, the same result as that in the case where the latter is used is obtained.

Therefore, it was confirmed that in the secondary battery according to the embodiments, when the solvent of the electrolytic solution included the isocyanate compound represented by Chemical Formula 36, even in the case where the oxide-containing film was formed, the cycle characteristics and the storage characteristics were improved. In this case, it was confirmed that when the oxide-containing film was formed, the characteristics were further improved.

### Example 16

A secondary battery was formed by the same steps as those in Example 8-4, except that in the case where the anode active material layer 34B was formed, after a plurality of anode active material particles were formed, a cobalt (Co)-plating film was grown as the metal material by the electrolytic plating method. To form the metal material, cobalt was deposited on both surfaces of the anode current collector 34B by conduction while air is supplied to a plating bath. At that time, a cobalt plating solution available from Japan Pure Chemical Co., Ltd. was used as a plating solution, and the current density was 2 A/dm² to 5 A/dm², and the plating rate was 10 nm/s.

### Comparative Example 12

A secondary battery was formed by the same steps as those in Example 16, except that the compound represented by Chemical Formula 44(1) was not formed.

When the cycle characteristics and the storage characteristics of the secondary batteries of Example 16 and Comparative Example 12 were determined, results illustrated in Table 17 were formed.

TABLE 17
Anode active material: silicon

| | | | | | | | HIGH- |
|---|---|---|---|---|---|---|---|
| | | | | | | ROOM- | TEMPERATURE |
| | | ELECTROLYTIC SOLUTION | | | | TEMPERATURE | STORAGE |
| | | | SOLVENT | | | DISCHARGE | DISCHARGE |
| | | | | ISOCYANATE | | CAPACITY | CAPACITY |
| | ANODE | ELECTROLYTE | | COMPOUND | | RETENTION | RETENTION |
| | METAL MATERIAL | SALT | KIND | KIND | WT % | RATIO (%) | RATIO (%) |
| EXAMPLE 8-4 | — | LiPF₆ | EC + | CHEMICAL | 3 | 72 | 86 |
| EXAMPLE 16 | Co | 1 mol/kg | DEC | FORMULA | | 76 | 88 |
| | | | | 44(1) | | | |
| COMPARATIVE | — | LiPF₆ | EC + | — | — | 40 | 80 |
| EXAMPLE 6-1 | | 1 mol/kg | DEC | | | | |
| COMPARATIVE | Co | | | | | 65 | 86 |
| EXAMPLE 12 | | | | | | | |

As illustrated in Table 17, even in the case where the metal material was formed, the same results as those illustrated in Table 9 were obtained. More specifically, in Example 16 in which the solvent included the compound represented by Chemical Formula 44(1), compared to Comparative Examples 6-1 and 12 in which the compound represented by Chemical Formula 44(1) was not included, a higher room-temperature cycle discharge capacity retention ratio and a higher high-temperature storage discharge capacity retention ratio were obtained.

In particular, in Example 16 in which the metal material was formed, compared to Comparative Example 8-4 in which the metal material was not formed, the room-temperature cycle discharge capacity retention ratio and the high-temperature storage discharge capacity retention ratio were higher.

Only the results in the case where the cobalt-plating film was formed as the metal material were illustrated herein, and a result in the case where a plating film of iron, nickel, zinc or copper was formed was not illustrated. However, the plating film of iron or the like serves the same function of increasing the room-temperature cycle discharge capacity retention ratio and the high-temperature storage discharge capacity retention ratio as that of the cobalt-plating film, so it is obvious that in the case where the former is used, the same result as those in the latter is used is obtained.

Therefore, it was confirmed that in the secondary battery according to the embodiments, when the solvent of the electrolytic solution included the isocyanate compound represented by Chemical Formula 36, even in the case where the metal material was formed, the cycle characteristics and the storage characteristics were improved. In this case, it was confirmed that when the metal material was formed, the characteristics were further improved.

### Examples 17-1 to 17-3

Secondary batteries were formed by the same steps as those in Examples 8-4, 10-5 and 10-6, except that in the case where the anode active material layer 34B was formed, after a plurality of anode active material particles were formed, the oxide-containing film and the metal material were formed by the same steps as those in Examples 15 and 16.

### Comparative Examples 13-1 to 13-3

Secondary batteries were formed by the same steps as those in Examples 17-1 to 17-3, except that the compound represented by Chemical Formula 44(1) was not included.

When the cycle characteristics and the storage characteristics of the secondary batteries of Examples 17-1 to 17-3 and Comparative Examples 13-1 to 13-3 were determined, results illustrated in Table 18 were obtained.

TABLE 18
Anode active material: silicon

| | | | | | | | | HIGH- |
|---|---|---|---|---|---|---|---|---|
| | | | | | | | ROOM- | TEMPERATURE |
| | | | ELECTROLYTIC SOLUTION | | | | TEMPERATURE | STORAGE |
| | ANODE | | | SOLVENT | | | DISCHARGE | DISCHARGE |
| | OXIDE- | | | | ISOCYANATE | | CAPACITY | CAPACITY |
| | CONTAINING | METAL | ELECTROLYTE | | COMPOUND | | RETENTION | RETENTION |
| | FILM | MATERIAL | SALT | KIND | KIND | WT % | RATIO (%) | RATIO (%) |
| EXAMPLE 8-4 | — | — | LiPF₆ | EC + DEC | CHEMICAL | 3 | 72 | 86 |
| EXAMPLE 17-1 | SiO₂ | Co | 1 mol/kg | | FORMULA | | 80 | 88 |

| | | | | | |
|---|---|---|---|---|---|
| EXAMPLE 17-2 | EC + | FEC | 44(1) | 88 | 91 |
| EXAMPLE 17-3 | DEC | t-DFEC | | 92 | 92 |

| | | | | | | | | |
|---|---|---|---|---|---|---|---|---|
| COMPARATIVE | — | — | LiPF₆ | EC + DEC | — | — | 40 | 80 |
| EXAMPLE 6-1 | | | 1 mol/kg | | | | | |
| COMPARATIVE | SiO₂ | Co | | | | | 75 | 86 |
| EXAMPLE 13-1 | | | | | | | | |

| | | | | |
|---|---|---|---|---|
| COMPARATIVE | EC + | FEC | 84 | 89 |
| EXAMPLE 13-2 | DEC | | | |
| COMPARATIVE | | t-DFEC | 90 | 88 |
| EXAMPLE 13-3 | | | | |

As illustrated in Table 18, even in the case where both of the oxide-containing film and the metal material were formed, the same results as those illustrated in Tables 9 and 10 were obtained. More specifically, in Example 17-1 to 17-3 in which the solvent included the compound represented by Chemical Formula 44(1), as in the case of Example 8-4, compared to Comparative Examples 6-1 and 13-1 to 13-3, a higher room-temperature cycle discharge capacity retention ratio and a higher high-temperature storage discharge capacity retention ratio were obtained. Moreover, in Examples 17-2 and 17-3 in which the solvent included FEC and DFEC, compared to Examples 8-4 and 17-1 in which they were not included, a higher room-temperature cycle discharge capacity retention ratio and a higher high-temperature storage discharge capacity retention ratio were obtained.

In particular, in Example 17-1 in which both of the oxide-containing film and the metal material were formed, compared to Example 15 in which only the oxide-containing film was formed or Example 16 in which only the metal material was formed, the room-temperature cycle discharge capacity retention ratio and the high-temperature storage discharge capacity retention ratio were higher.

Therefore, it was confirmed that in the secondary battery according to the embodiments, when the solvent of the electrolytic solution included the isocyanate compound represented by Chemical Formula 36, even in the case where both of the oxide-containing film and the metal material were formed, the cycle characteristics and the storage characteristics were improved. In this case, it was confirmed that when both of the oxide-containing film and the metal material were formed, the characteristics were further improved.

It was confirmed from the above-described results in Tables 9 to 18 that in the secondary battery according to the embodiments, when the solvent of the electrolytic solution included the compound represented by Chemical Formula 36, independent of the kind of the anode active material, the composition of the solvent or the like, the cycle characteristics and the storage characteristics were improved.

In this case, it was confirmed that in the case where the material (silicon or the SnCoC-containing material) capable of inserting and extracting lithium ions and including at least one kind selected from the group consisting of metal elements and metalloid elements was used as the anode active material, the increase rate of the discharge capacity retention ratio was higher than that in the case where the carbon material (artificial graphite) was used; therefore in the former case, a higher effect than that in the latter case was obtained. It was considered from this result that when silicon having an advantage in obtaining a higher capacity was used as the anode active material, the electrolytic solution was decomposed more easily than in the case where the carbon material was used, so an effect of preventing the decomposition of the electrolytic solution was remarkably exerted.

Although the present disclosure describes the embodiments and the examples, the present application is not limited to the embodiments and the examples, and may be variously modified. For example, the application of the electrolytic solution of the present application is not limited to secondary batteries, and the electrolytic solution may be applied to any other electrochemical devices in addition to the secondary batteries. Examples of the other application include a capacitor and the like.

Moreover, in the above-described embodiments and the above-described examples, as the kind of the secondary battery, the lithium-ion secondary battery in which the capacity of the anode is represented on the basis of insertion and extraction of lithium is described. However, the present application is not limited thereto. The secondary battery is applicable in the same manner to a secondary battery in which a material capable of inserting and extracting lithium ions is used as an anode active material, and a chargeable capacity in the anode material capable of inserting and extracting lithium is smaller than the discharge capacity of a cathode, thereby the capacity of an anode includes a capacity on the basis of insertion and extraction of lithium and a capacity on the basis of deposition and dissolution of lithium, and is represented by the sum of them.

Further, in the above-described embodiments and the above-described examples, the case where the electrolytic solution or the gel electrolyte in which the polymer compound holds the electrolytic solution is used as the electrolyte of the secondary battery is described. However, any other kind of electrolyte may be used. Examples of the electrolyte include a mixture of an ion-conducting inorganic compound such as ion-conducting ceramic, ion-conducting glass or ionic crystal and an electrolytic solution, a mixture of another inorganic compound and an electrolytic solution, a mixture of the inorganic compound and a gel electrolyte, and the like.

In the above-described embodiments and the above-described examples, the case where the secondary battery is of a cylindrical type or a laminate film type, and the case where the battery element has a spirally wound configuration are described as examples. However, the secondary battery is applicable in the same manner to the case where a secondary battery has any other shape such as a prismatic type, a coin type or a button type or the case where the battery element has any other configuration such as a laminate configuration.

In the above-described embodiments and the above-described examples, the case where lithium is used as an electrode reactant is described. However, any other Group 1 element such as sodium (Na) or potassium (K), a Group 2 element such as magnesium (Mg) or calcium (Ca), or any other light metal such as aluminum may be used. Also in this case, as the anode active material, the anode material described in the above-described embodiment may be used.

In the above-described embodiments and the above-described examples, an appropriate range, which is derived from the results of the examples, of the content of the isocyanate compounds represented by Chemical formulas 5 and 6 in the secondary battery is described. However, the description does not exclude the possibility that the contents is out of the above-described range. More specifically, the above-described appropriate range is a specifically preferable range to obtain the effects of the present application, and as long as the effects of the present application are obtained, the content may be deviated from the above-described range to some extent. The same holds for the isocyanate compound represented by Chemical Formula 36.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising a cathode, an anode and an electrolytic solution,
wherein the anode includes an anode active material layer including a plurality of anode active material particles, the plurality of anode active material particles including silicon as a constituent element,
the anode active material layer includes at least one of an oxide-containing film and a metal material as a constituent element, the oxide-containing film with which surfaces of the anode active material particles are covered, the metal material including a metal element which is not alloyed with an electrode reactant, and being arranged in a gap in the anode active material layer, and
the electrolytic solution includes a solvent including at least one kind selected from the group consisting of isocyanate compounds represented by Chemical Formula 1 and Chemical Formula 2: 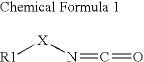
where R1 is a univalent organic group, X is —C(═O)—, —O—C(═O)—, —S(═O)—, —O—S(═O)—, —S(═O)₂— or —O—S(═O)₂—, and X is bonded to a carbon atom in R1; 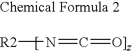
where R2 is a z-valent organic group, z is an integer of 2 or more, and a nitrogen atom in an isocyanate group is bonded to a carbon atom in R2.

2. The secondary battery according to claim 1, wherein
R1 in Chemical Formula 1 is an alkyl group having 1 to 10 carbon atoms, an aryl group, a halogenated alkyl group having 1 to 10 carbon atoms, a halogenated aryl group, or a derivative thereof.

3. The secondary battery according to claim 1, wherein
R2 in Chemical Formula 2 is an alkylene group having 1 to 10 carbon atoms, or an arylene group.

4. The secondary battery according to claim 1, wherein
z in Chemical Formula 2 is 2 or 3.

5. The secondary battery according to claim 1, wherein
the oxide-containing film includes at least one kind of oxide selected from the group consisting of oxides of silicon, oxide of germanium and oxides of tin.

6. The secondary battery according to claim 1, wherein
the oxide-containing film includes a fluorine anion, or a compound of fluorine and one kind selected from the group consisting of Group 13 elements, Group 14 elements and Group 15 elements in the long form of the periodic table of the elements.

7. The secondary battery according to claim 1, wherein
the oxide-containing film is formed by a liquid-phase method.

8. The secondary battery according to claim 1, wherein
the oxide-containing film is formed by at least one kind selected from the group consisting of a liquid-phase deposition method, a sol-gel method and a dip coating method.

9. The secondary battery according to claim 1, wherein
the metal material is arranged in a gap between the anode active material particles.

10. The secondary battery according to claim 1, wherein
the anode active material particles each have a multilayer configuration, and the metal material is arranged in gaps in the anode active material particles.

11. The secondary battery according to claim 1, wherein
the metal element is at least one kind selected from the group consisting of iron, cobalt, nickel, zinc and copper.

12. The secondary battery according to claim 1, wherein
the metal material is formed by a liquid-phase method.

13. The secondary battery according to claim 1, wherein
the metal material is formed by an electrolytic plating method or an electroless plating method.

14. The secondary battery according to claim 1, wherein
the content of the isocyanate compounds represented by Chemical Formula 1 and Chemical Formula 2 in the solvent is within a range of 0.01 wt % to 10 wt % both inclusive.

15. The secondary battery according to claim 1, wherein
the solvent includes at least one kind selected from the group consisting of a chain carbonate represented by Chemical Formula 3 which includes a halogen and a cyclic carbonate represented by Chemical Formula 4 which includes a halogen: 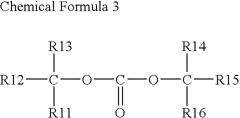
where R1, R12, R13, R14, R15 and R16 each represent a hydrogen group, a halogen group, an alkyl group or a halogenated alkyl group, and at least one of them is a halogen group or a halogenated alkyl group; 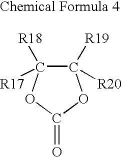
where R17, R18, R19 and R20 each represent a hydrogen group, a halogen group, an alkyl group or a halogenated alkyl group, and at least one of them is a halogen group or a halogenated alkyl group.

16. The secondary battery according to claim 15, wherein
the chain carbonate represented by Chemical Formula 3 which includes a halogen is fluoromethyl methyl carbonate, difluoromethyl methyl carbonate or bis(fluoromethyl) carbonate, and
the cyclic carbonate represented by Chemical Formula 4 which includes a halogen is 4-fluoro-1,3-dioxolane-2-one or 4,5-difluoro-1,3-dioxolane-2-one.

17. The secondary battery according to claim 1, wherein
the solvent includes cyclic carbonates represented by Chemical Formula 5, Chemical Formula 6 and Chemical Formula 7 which have an unsaturated carbon bond: 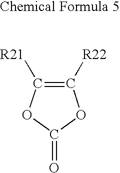
where R21 and R22 each are a hydrogen group or an alkyl group; 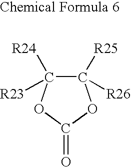
where R23, R24, R25 and R26 each are a hydrogen group, an alkyl group, a vinyl group or an allyl group, and at least one of them is a vinyl group or an allyl group; 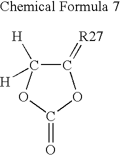
where R27 is an alkylene group.

18. The secondary battery according to claim 17, wherein
the cyclic carbonate represented by Chemical Formula 5 which has an unsaturated carbon bond is vinylene carbonate, the cyclic carbonate represented by Chemical Formula 6 which has an unsaturated carbon bond is vinyl ethylene carbonate, and the cyclic carbonate represented by Chemical Formula 7 which has an unsaturated carbon bond is methylene ethylene carbonate.

19. The secondary battery according to claim 1, wherein
the electrolytic solution includes an electrolyte salt including at least one kind selected from the group consisting of lithium hexafluorophosphate (LiPF₆), lithium tetrafluoroborate (LiBF₄), lithium perchlorate (LiClO₄) and lithium hexafluoroarsenate (LiAsF₆).

20. The secondary battery according to claim 1, wherein
the electrolytic solution includes an electrolyte salt including at least one kind selected from the group consisting of compounds represented by Chemical Formula 8, Chemical Formula 9 and Chemical Formula 10: 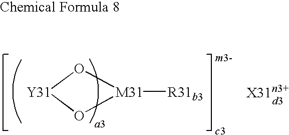
where X31 represents a Group 1 element or a Group 2 element in the long form of the periodic table of the elements, or aluminum (Al), M31 represents a transition metal element, or a Group 13 element, a Group 14 element or a Group 15 element in the long form of the periodic table of the elements, R31 represents a halogen group, Y31 represents —(O═)C—R32-C(═O)—, —(O═)C—C(R33)₂— or —(O═)C—C(═O)—, in which R32 represents an alkylene group, a halogenated alkylene group, an arylene group or a halogenated arylene group, R33 represents an alkyl group, a halogenated alkyl group, an aryl group or a halogenated aryl group, a3 is an integer of 1 to 4 both inclusive, and b3 is 0, 2 or 4, and c3, d3, m3 and n3 each are an integer of 1 to 3 both inclusive; 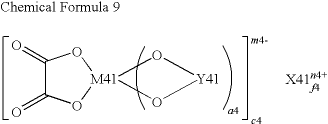
where X41 represents a Group 1 element or a Group 2 element in the long form of the periodic table of the elements, M41 represents a transition metal element, or a Group 13 element, a Group 14 element or a Group 15 element in the long form of the periodic table of the elements, Y41 represents —(O═)C—(C(R41)₂)_{b4}—C(═O)—, —(R43)₂C—(C(R42)₂)_{c4}—C(═O)—, —(R43)₂C—(C(R42)₂)_{c4}—C(R43)₂—, —(R43)₂C—(C(R42)₂)_{c4}—S(═O)₂—, -(O═)₂S—(C(R42)₂)_{d4}—S(═O)₂— or —(O═)C—(C(R42)₂)_{d4}—S(═O)₂—, in which R41 and R43 each represents a hydrogen group, an alkyl group, a halogen group or a halogenated alkyl group, and at least one of them is a halogen group or a halogenated alkyl group, R42 represents a hydrogen group, an alkyl group, a halogen group or a halogenated alkyl group, and a4, e4 and n4 each are 1 or 2, b4 and d4 each are an integer of 1 to 4 both inclusive, c4 is 0 or an integer of 1 to 4 both inclusive, and f4 and m4 each are an integer of 1 to 3 both inclusive; 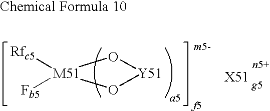
where X51 represents a Group 1 element or a Group 2 element in the long form of the periodic table of the elements, M51 represents a transition metal element, or a Group 13 element, a Group 14 element or a Group 15 element in the long form of the periodic table of the elements, Rf represents a fluorinated alkyl group having 1 to 10 carbon atoms or a fluorinated aryl group having 1 to 10 carbon atoms, Y51 represents —(O═)C—(C(R51)₂)_{d5}—C(═O)—, —(R52)₂C—(C(R51)₂)_{d5}—C(═O)—, —(R52)₂C—(C(R51)₂)_{d5}—C(R52)₂—, —(R52)₂C—(C(R51)₂)_{d5}—S(═O)₂—, —(O═)₂S—(C(R51)₂)ₑ₅—S(═O)₂— or —(O═)C—(C(R51)₂)ₑ₅—S(═O)₂—, in which R51 represents a hydrogen group, an alkyl group, a halogen group or a halogenated alkyl group, R52 represents a hydrogen group, an alkyl group, a halogen group or a halogenated alkyl group, and at least one of them is a halogen group or a halogenated alkyl group, and a5, f5 and n5 each are 1 or 2, b5, c5 and e5 each are an integer of 1 to 4 both inclusive, d5 is 0 or an integer of 1 to 4 both inclusive, and g5 and m5 each are an integer of 1 to 3 both inclusive.

21. The secondary battery according to claim 20, wherein
the compound represented by Chemical Formula 8 is any one of compounds represented by Chemical Formulas 11(1) to 11(6),
the compound represented by Chemical Formula 9 is any one of compounds represented by Chemical Formulas 12(1) to 12(8), and
the compound represented by Chemical Formula 10 is a compound represented by Chemical Formula 13:

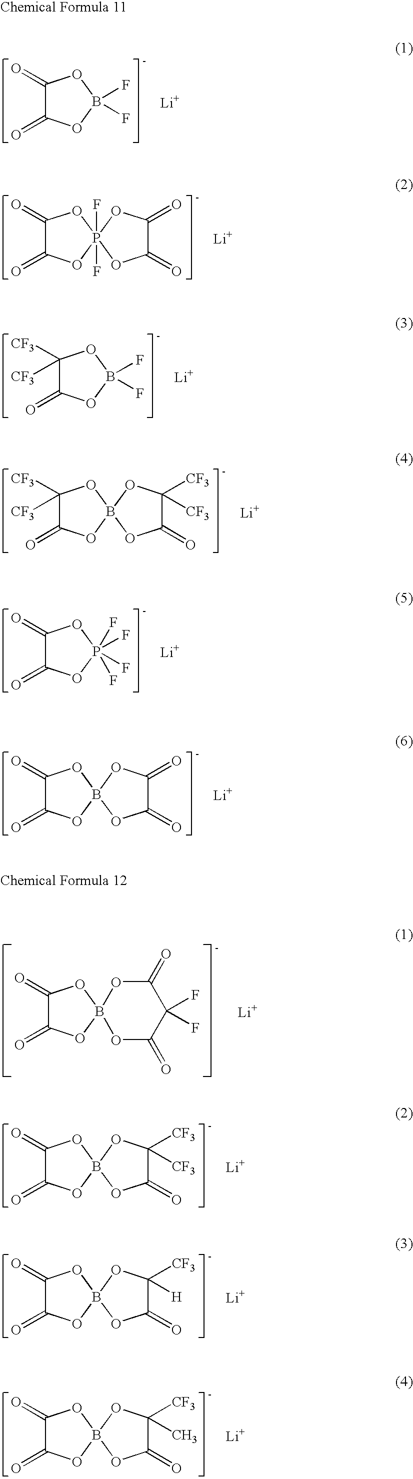

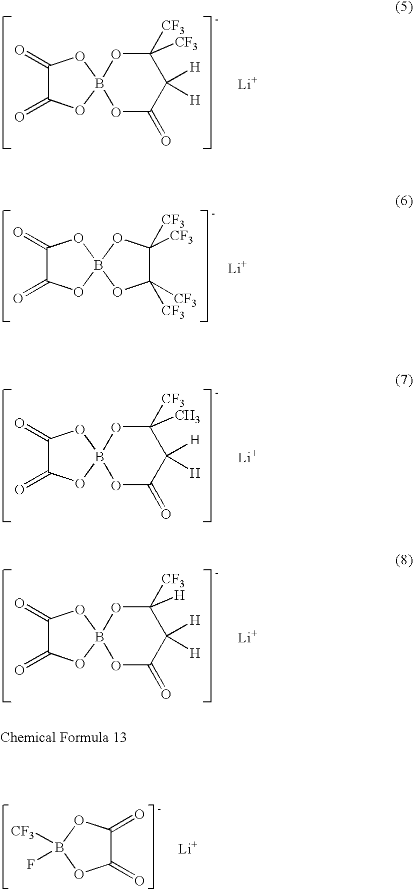

22. The secondary battery according to claim 1, wherein
the electrolytic solution includes an electrolyte salt including at least one kind selected from the group consisting of compounds represented by Chemical Formula 14, Chemical Formula 15 and Chemical Formula 16:
Chemical Formula 14
LiN(CₘF₂ₘ₊₁SO₂)(CₙF₂ₙ₊₁SO₂)
where m and n each are an integer of 1 or more; 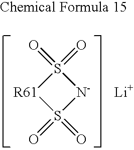
where R61 represents a straight-chain or branched perfluoroalkylene group having 2 to 4 carbon atoms;
Chemical Formula 16
LiC(CₚF₂ₚ₊₁SO₂)(C_{q}F_{2q+1}SO₂)(CᵣF₂ᵣ₊₁SO₂)
where p, q and r each are an integer of 1 or more.

23. The secondary battery according to claim 1, wherein
the electrolytic solution includes a sultone.

24. The secondary battery according to claim 1, wherein
the electrolytic solution includes an acid anhydride.

25. The secondary battery according to claim 1, wherein
the anode active material particles are made of at least one kind selected from the group consisting of the simple substance, alloys and compounds of silicon.

26. A secondary battery comprising a cathode, an anode and an electrolytic solution,
wherein the electrolytic solution includes a solvent including an isocyanate compound represented by Chemical Formula 17: 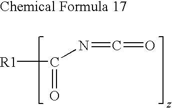
where R1 is a z-valent organic group, and z is an integer of 2 or more, and a carbon atom in a carbonyl group is bonded to a carbon atom in R1.

27. The secondary battery according to claim 26, wherein
the isocyanate compound represented by Chemical Formula 17 is a compound represented by Chemical Formula 18: 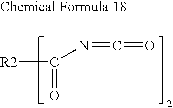
where R2 is a divalent organic group, and a carbon atom in a carbonyl group is bonded to a carbon atom in R2.

28. The secondary battery according to claim 27, wherein
R2 in Chemical Formula 18 is a straight-chain alkylene group.

29. The secondary battery according to claim 27, wherein
R2 in Chemical Formula 18 is an ethylene group (—C₂H₄—) or a propylene group (—C₃H₆—).

30. The secondary battery according to claim 26, wherein
the content of the isocyanate compound represented by Chemical Formula 17 in the solvent is within a range of 0.01 wt % to 5 wt % both inclusive.

31. The secondary battery according to claim 26, wherein
the solvent includes at least one kind selected from the group consisting of a chain carbonate represented by Chemical Formula 19 which includes a halogen and a cyclic carbonate represented by Chemical Formula 20 which includes a halogen: 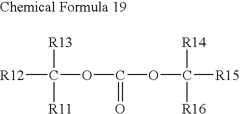
where R11, R12, R13, R14, R15 and R16 each represent a hydrogen group, a halogen group, an alkyl group or a halogenated alkyl group, and at least one of them is a halogen group or a halogenated alkyl group; 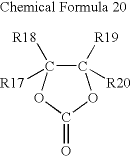
where R17, R18, R19 and R20 each represent a hydrogen group, a halogen group, an alkyl group or a halogenated alkyl group, and at least one of them is a halogen group or a halogenated alkyl group.

32. The secondary battery according to claim 31, wherein
the chain carbonate represented by Chemical Formula 19 which includes a halogen is fluoromethyl methyl carbonate, difluoromethyl methyl carbonate or bis(fluoromethyl) carbonate, and
the cyclic carbonate represented by Chemical Formula 20 which includes a halogen is 4-fluoro-1,3-dioxolane-2-one or 4,5-difluoro-1,3-dioxolane-2-one.

33. The secondary battery according to claim 26, wherein
the solvent includes cyclic carbonates represented by Chemical Formula 21, Chemical Formula 22 and Chemical Formula 23 which have an unsaturated carbon bond: 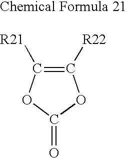
where R21 and R22 each are a hydrogen group or an alkyl group; 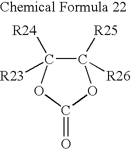
where R23, R24, R25 and R26 each are a hydrogen group, an alkyl group, a vinyl group or an allyl group, and at least one of them is a vinyl group or an allyl group; 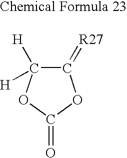
where R27 is an alkylene group.

34. The secondary battery according to claim 33, Wherein the cyclic carbonate represented by Chemical Formula 21 which has an unsaturated carbon bond is vinylene carbonate, the cyclic carbonate represented by Chemical Formula 22 which has an unsaturated carbon bond is vinyl ethylene carbonate, and the cyclic carbonate represented by Chemical Formula 23 which has an unsaturated carbon bond is methylene ethylene carbonate.

35. The secondary battery according to claim 26, wherein
the electrolytic solution includes an electrolyte salt including at least one kind selected from the group consisting of lithium hexafluorophosphate, lithium tetrafluoroborate, lithium perchlorate and lithium hexafluoroarsenate.

36. The secondary battery according to claim 26, wherein
the electrolytic solution includes an electrolyte salt including at least one kind selected from the group consisting of compounds represented by Chemical Formula 24, Chemical Formula 25 and Chemical Formula 26: 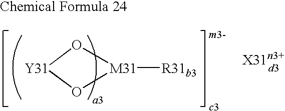
where X31 represents a Group 1 element or a Group 2 element in the long form of the periodic table of the elements, or aluminum, M31 represents a transition metal element, or a Group 13 element, a Group 14 element or a Group 15 element in the long form of the periodic table of the elements, R31 represents a halogen group, Y31 represents —(O═)C—R32-C(═O)—, —(O═)C—C(R33)₂— or —(O═)C—C(═O)—, in which R32 represents an alkylene group, a halogenated alkylene group, an arylene group or a halogenated arylene group, R33 represents an alkyl group, a halogenated alkyl group, an aryl group or a halogenated aryl group, a3 is an integer of 1 to 4 both inclusive, and b3 is 0, 2 or 4, and c3, d3, m3 and n3 each are an integer of 1 to 3 both inclusive; 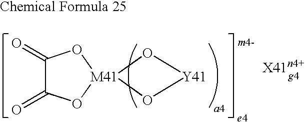
where X41 represents a Group 1 element or a Group 2 element in the long form of the periodic table of the elements, M41 represents a transition metal element, or a Group 13 element, a Group 14 element or a Group 15 element in the long form of the periodic table of the elements, Y41 represents —(O═)C—(C(R41)₂)_{b4}—C(═O)—, —(R43)₂C—(C(R42)₂)_{c4}—C(═O)—, —(R43)₂C—(C(R42)₂)_{c4}—C(R43)₂—, —(R43)₂C—(C(R42)₂)_{c4}—S(═O)₂—, —(O═)₂S—(C(R42)₂)_{d4}—S(═O)₂— or —(O═)C—(C(R42)₂)_{d4}—S(═O)₂—, in which R41 and R43 each represents a hydrogen group, an alkyl group, a halogen group or a halogenated alkyl group, and at least one of them is a halogen group or a halogenated alkyl group, R42 represents a hydrogen group, an alkyl group, a halogen group or a halogenated alkyl group, and a4, e4 and n4 each are 1 or 2, b4 and d4 each are an integer of 1 to 4 both inclusive, c4 is 0 or an integer of 1 to 4 both inclusive, and f4 and m4 each are an integer of 1 to 3 both inclusive; 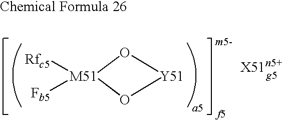
where X51 represents a Group 1 element or a Group 2 element in the long form of the periodic table of the elements, M51 represents a transition metal element, or a Group 13 element, a Group 14 element or a Group 15 element in the long form of the periodic table of the elements, Rf represents a fluorinated alkyl group having 1 to 10 carbon atoms or a fluorinated aryl group having 1 to 10 carbon atoms, Y51 represents —(O═)C—(C(R51)₂)_{d5}—C(═O)—, —(R52)₂C—(C(R51)₂)_{d5}—C(═O)—, —(R52)₂C—(C(R51)₂)_{d5}—C(R52)₂—, —(R52)₂C—(C(R51)₂)_{d5}—S(═O)₂—, —(O═)₂S—(C(R51)₂)ₑ₅—S(═O)₂— or —(O═)C—(C(R51)₂)ₑ₅—S(═O)₂—, in which R51 represents a hydrogen group, an alkyl group, a halogen group or a halogenated alkyl group, R52 represents a hydrogen group, an alkyl group, a halogen group or a halogenated alkyl group, and at least one of them is a halogen group or a halogenated alkyl group, and a5, f5 and n5 each are 1 or 2, b5, c5 and e5 each are an integer of 1 to 4 both inclusive, d5 is 0 or an integer of 1 to 4 both inclusive, and g5 and m5 each are an integer of 1 to 3 both inclusive.

37. The secondary battery according to claim 36, wherein
the compound represented by Chemical Formula 24 is any one of compounds represented by Chemical Formulas 27(1) to 27(6),
the compound represented by Chemical Formula 25 is any one of compounds represented by Chemical Formulas 28(1) to 28(8), and
the compound represented by Chemical Formula 26 is a compound represented by Chemical Formula 29:

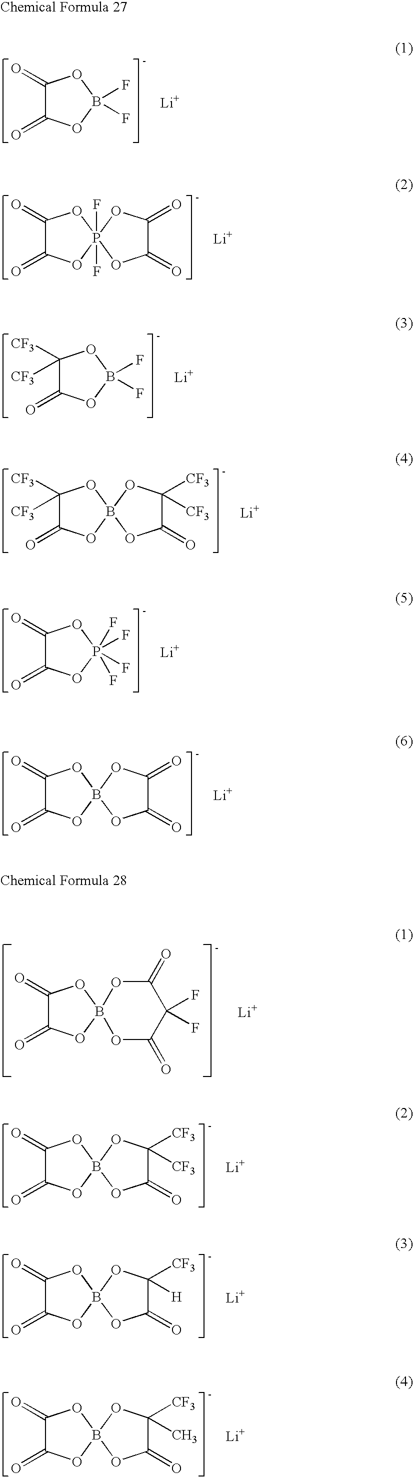

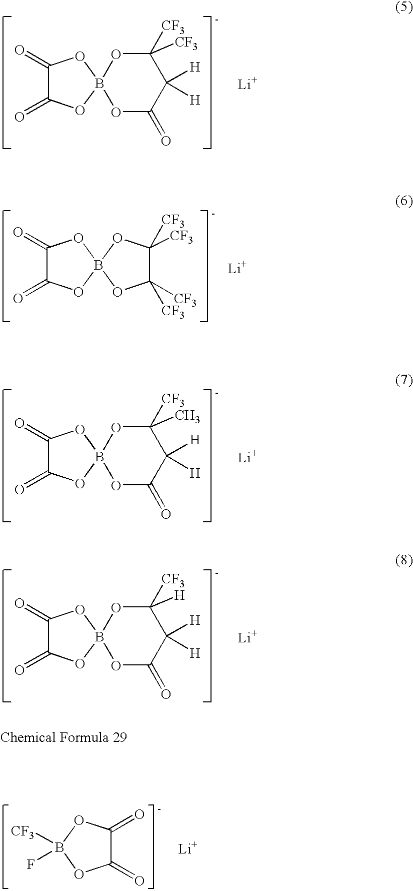

38. The secondary battery according to claim 26, wherein
the electrolytic solution includes an electrolyte salt including at least one kind selected from the group consisting of compounds represented by Chemical Formula 30, Chemical Formula 31 and Chemical Formula 32:
Chemical Formula 30
LiN(CₘF₂ₘ₊₁SO₂)(CₙF₂ₙ₊₁SO₂)
where m and n each are an integer of 1 or more; 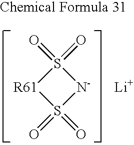
where R61 represents a straight-chain or branched perfluoroalkylene group having 2 to 4 carbon atoms;
Chemical Formula 32
LiC(CₚF₂ₚ₊₁SO₂)(C_{q}F_{2q+1}SO₂)(CᵣF₂ᵣ₊₁SO₂)
where p, q and r each are an integer of 1 or more.

39. The secondary battery according to claim 26, wherein
the electrolytic solution includes a sultone.

40. The secondary battery according to claim 26, wherein
the electrolytic solution includes an acid anhydride.

41. The secondary battery according to claim 26, wherein
the anode includes an anode active material including a carbon material, lithium metal or a material which is capable of inserting and extracting lithium ions and includes at least one kind selected from the group consisting of metal elements and metalloid elements.

42. The secondary battery according to claim 26, wherein
the anode includes an anode active material including at least one kind selected from the group consisting of the simple substance, alloys and compounds of silicon and the simple substance, alloys and compounds of tin.

43. The secondary battery according to claim 26, wherein
the anode includes an anode active material layer on an anode current collector, and the anode active material layer is formed by at least one kind of method selected from the group consisting of a vapor-phase method, a liquid-phase method and a firing method.

44. The secondary battery according to claim 26, wherein
the anode includes an anode active material layer including a plurality of anode active material particles, and the anode active material layer includes an oxide-containing film with which surfaces of the anode active material particles are covered.

45. The secondary battery according to claim 44, wherein
the oxide-containing film includes at least one kind selected from the group consisting of oxides of silicon, oxides of germanium and oxides of tin.

46. The secondary battery according to claim 26, wherein
the anode includes an anode active material layer including a plurality of anode active material particles, and the anode active material layer includes a metal material in a gap in the anode active material layer, the metal material including, as a constituent element, a metal element which is not alloyed with an electrode reactant.

47. The secondary battery according to claim 46, wherein
the metal material is arranged in a gap between anode active material particles.

48. The secondary battery according to claim 46, wherein
the anode active material particles each have a multilayer configuration, and the metal material is arranged in gaps in the anode active material particles.

49. The secondary battery according to claim 46, wherein
the metal element is at least one kind selected from the group consisting of iron, cobalt, nickel, zinc and copper.

50. An electrolytic solution comprising:
a solvent including an isocyanate compound represented by Chemical Formula 33: 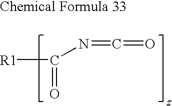
where R1 is a z-valent organic group, and z is an integer of 2 or more, and a carbon atom in a carbonyl group (—CO—) is bonded to a carbon atom in R1.

51. The electrolytic solution according to claim 50, wherein
the electrolytic solution is used in a secondary battery.
